(19) United States
(12) Patent Application Publication
(10) Pub. No.: US 2011/0277670 A1
(43) Pub. Date: Nov. 17, 2011

(54) SYSTEMS AND METHODS FOR PROCESSING CO2

(76) Inventors: Kyle Self, San Jose, CA (US); Kasra Farsad, San Jose, CA (US); Robert W. Elliott, Salinas, CA (US); Brian Curtis, Los Gatos, CA (US); Srikanth Bellur, San Jose, CA (US)

(21) Appl. No.: 12/780,862

(22) Filed: May 14, 2010

(51) Int. Cl. C04B 7/00; B01D 53/75; B01J 19/00; B01D 37/00; B01D 61/00; B01D 53/14; B01D 53/92

(52) U.S. Cl. 106/638; 210/768; 210/652; 210/640; 210/749; 210/202; 210/259; 210/177; 96/242; 422/169; 422/187; 210/747.9

(57) ABSTRACT

Systems and methods for lowering levels of carbon dioxide and other atmospheric pollutants are provided. Economically viable systems and processes capable of removing vast quantities of carbon dioxide and other atmospheric pollutants from gaseous waste streams and sequestering them in storage-stable forms are also discussed.

### CROSS-REFERENCE

This application claims the benefit of the following applications, each of which is incorporated herein by reference in its entirety:
U.S. Provisional Patent Application No. 61/178,475, filed 14 May 2009, titled “Apparatus, Systems, and Methods for Treating Industrial Waste Gases”;
U.S. Provisional Patent Application No. 61/228,210, filed 24 Jul. 2009, titled “Apparatus, Systems, and Methods for Treating Industrial Waste Gases”;
U.S. Provisional Patent Application No. 61/230,042, filed 30 Jul. 2009, titled “Apparatus, Systems, and Methods for Treating Industrial Waste Gases”;
U.S. Provisional Patent Application No. 61/239,429, filed 2 Sep. 2009, titled, “Apparatus, Systems, and Methods for Treating Industrial Waste Gases”;
U.S. Provisional Patent Application No. 61/254,640, filed 23 Oct. 2009, titled, “Apparatus, Systems, and Methods for Treating Industrial Waste Gases”;
U.S. Provisional Patent Application No. 61/178,899, filed 15 May 2009, titled “Carbon Sequestration Material: Composition And Testing Methods And Apparatus”;
U.S. Provisional Patent Application No. 61/184,726, filed 5 Jun. 2009, titled “Carbon Sequestration Material: Composition and Testing: Methods and Apparatus”;
U.S. Provisional Patent Application No. 61/306,412, filed 19 Feb. 2010, titled “Apparatus, Systems, And Methods For Treating Industrial Waste Gases”; and
U.S. Provisional Patent Application No. 61/311,275, filed 5 Mar. 2010, titled “Apparatus, Systems, And Methods For Treating Industrial Waste Gases.”

### BACKGROUND

The most concentrated point sources of carbon dioxide and many other atmospheric pollutants (e.g., NOx, SOx, volatile organic compounds (“VOCs”), and particulates) are energy-producing power plants, particularly power plants that produce their power by combusting carbon-based fuels (e.g., coal-fired power plants): Considering that world energy demand is expected to increase, and despite continuing growth in non-carbon-based sources of energy, atmospheric levels of carbon dioxide and other combustion products of carbon-based fuels are expected to increase as well. As such, power plants utilizing carbon-based fuels are particularly attractive sites for technologies aimed at lowering emissions of carbon dioxide and other atmospheric pollutants.

Attempts at lowering emissions of carbon dioxide and other atmospheric pollutants from power plant waste streams have produced many varied technologies, most of which require very large energy inputs to overcome the energy associated with isolating and concentrating diffuse gaseous species. In addition, current technologies and related equipment are inefficient and cost prohibitive. As such, it is important to develop an economically viable technology capable of removing vast quantities of carbon dioxide and other atmospheric pollutants from gaseous waste streams by sequestering carbon dioxide and other atmospheric pollutants in a stable form or by converting it to valuable commodity products.

In consideration of the foregoing, a significant need exists for systems and methods that efficiently and economically sequester carbon dioxide and other atmospheric pollutants.

### SUMMARY

In some embodiments, the invention provides a method that includes obtaining a slurry that includes precipitated CO₂-sequestering carbonate and/or bicarbonate compound composition and a supernatant solution from which the carbonate compound composition was precipitated, wherein the carbonate and/or bicarbonate compound composition has a δ13C value less than −10‰ and comprises aragonite, vaterite, amorphous calcium carbonate, or a combination thereof; separating the CO₂-sequestering carbonate compound composition from the supernatant solution utilizing at least one of the following techniques: a) gravity separation; b) mechanical separation; or c) thermal evaporation to provide a dewatered slurry comprising the CO₂-sequestering carbonate compound composition at a concentration of solids of at least 20 wt % and a first portion of the supernatant solution, and an effluent solution comprising a second portion of the supernatant solution; and processing the effluent solution in a first process and the CO₂-sequestering carbonate compound composition in a second process. In some embodiments, the invention provides a method in which processing the CO₂-sequestering carbonate compound composition includes particle size refining. In some embodiments, the invention provides a method in which processing the CO₂-sequestering carbonate compound composition includes making at least one of: a hydraulic cement, aggregate, supplementary cementitious material, or concrete that includes the CO₂-sequestering carbonate compound composition. In some embodiments, the invention provides a method in which processing the CO₂-sequestering carbonate compound composition includes making at least one of: a hydraulic cement, aggregate, supplementary cementitious material, or concrete that includes the CO₂-sequestering carbonate compound composition in an amount of at least 25 wt %. In some embodiments, the invention provides a method in which processing the effluent solution includes adjusting the pH and/or chemical composition of the effluent solution so that it is suitable for release into an ocean, sea, river, other body of surface water, or a subterranean repository. In some embodiments, the invention provides a method in which processing the effluent solution includes subjecting the effluent solution to a process that includes at least one type of the following protocols: a reverse osmosis protocol; a forward osmosis protocol; a nano-filtration protocol; a micro-filtration protocol; a pH adjusting protocol; a salt recovery protocol; a cation recovery protocol; or a membrane distillation protocol.

In some embodiments, the invention provides an apparatus for dewatering a mixture that includes a carbonate and/or bicarbonate compound composition, in which the apparatus includes:

a) an inlet for a mixture that includes a carbonate and/or bicarbonate compound composition that conveys the solution into a gravity separation compartment, said compartment includes at least one of: i) a decanting baffle; ii) a Lamella clarifier/thickener; iii) a filter; iv) a clarifier; v) a sludge bed clarifier; vi) a centrifuge; vii) a hydrocyclone; iix) a flocculant introduction system; ix) a filtering aid introduction system; x) a coagulant introduction system; or xi) a crystallization accelerant introduction system; and
b) a mechanical separation section, said section operably connected to said gravity separation compartment by a conduit, conveyor belt, or other convenient means, in which the mechanical separation section includes at least one of: i) a filter press; ii) a belt press; iii) a vacuum drum; iv) a separating conveyor belt; v) a vertical press; vi) a spray drying apparatus; or vii) a spraying system; in which the apparatus is constructed of corrosion and abrasion resistant materials such that the apparatus may be used continuously for at least 2 months at a pH of 8 or higher with carbonate and/or bicarbonate compound compositions. In some embodiments, the invention provides an apparatus that includes a rinsing system that includes a slurrying tank that combines an aqueous solution lacking chlorides with the mixture that includes a carbonate and/or bicarbonate compound composition, a freshwater spray system, or a combination of the two in any order, including multiple slurring tanks or freshwater spray systems. In some embodiments, the invention provides an apparatus for dewatering a mixture comprising a carbonate and/or bicarbonate compound composition in which the centrifuge is a continuous type centrifuge. In some embodiments, the invention provides an apparatus for dewatering a mixture comprising a carbonate and/or bicarbonate compound composition in which the centrifuge is a continuous, nozzle disk type centrifuge. In some embodiments, the invention provides an apparatus for dewatering a mixture comprising a carbonate and/or bicarbonate compound composition in which the centrifuge is a continuous, scroll type centrifuge. In some embodiments, the invention provides an apparatus for dewatering a mixture comprising a carbonate and/or bicarbonate compound composition in which the coagulant introduction system includes inorganic chemicals. In some embodiments, the invention provides an apparatus for dewatering a mixture comprising a carbonate and/or bicarbonate compound composition in which the spraying system includes nozzles. In some embodiments, the invention provides an apparatus that includes a spraying system that is configured to operate at ambient temperature and relative humidity of the surrounding atmosphere. In some embodiments, the invention provides an apparatus that includes a spraying system that is configured to remove unwanted minerals from the carbonate and/or bicarbonate compound composition without the need of rinsing the carbonate and/or bicarbonate compound composition. In some embodiments, the invention provides an apparatus that includes a spraying system that is configured to remove unwanted minerals from the carbonate and/or bicarbonate compound composition without the need of rinsing the carbonate and/or bicarbonate compound composition in which the unwanted minerals include, but are not limited to: sodium chloride, potassium chloride, calcium chloride, ammonia chloride, or any combination thereof. In some embodiments, the invention provides an apparatus for dewatering a mixture that includes a carbonate and/or bicarbonate compound composition that includes a spray drying apparatus that includes an inlet for gas at a temperature above ambient temperature. In some embodiments, the invention provides an apparatus for dewatering a mixture that includes a carbonate and/or bicarbonate compound composition that includes a spray drying apparatus that includes an inlet for industrial waste gas at a temperature above ambient temperature. In some embodiments, the invention provides an apparatus for dewatering a mixture that includes a mechanical separation system that includes additional energy input that includes vibration, sound waves, radio waves, or a combination thereof. In some embodiments, the invention provides an apparatus for dewatering a mixture that includes a carbonate and/or bicarbonate compound composition in which the hydrocyclone is a filter hydrocyclone. In some embodiments, the invention provides an apparatus for dewatering a mixture that includes a carbonate and/or bicarbonate compound composition in which the gravity separation compartment includes temperature controls, mixing controls, or both types of controls.

In some embodiments, the invention provides an apparatus for dewatering a mixture that includes a solid particulate composition and a supernatant solution, said apparatus includes: a first connection from a flue gas source that provides hot flue gas comprising CO₂ to a contacting conduit comprising a screw conveyor within the contacting conduit that is configured to move the mixture within the apparatus, wherein the connection is configured to contact the flue gas with the mixture to produce a dewatered mixture and a cooled flue gas comprising CO₂; and a second connection from the contacting conduit that provides the cooled flue gas comprising CO₂ to an apparatus for further processing of the flue gas. In some embodiments, the invention provides an apparatus for dewatering a mixture that includes a solid particulate composition and a supernatant solution that includes an apparatus for further processing of the flue gas, in which the apparatus for further processing of the flue gas includes a CO₂-sequestering apparatus that reduces the amount of CO₂ in the flue gas. In some embodiments, the invention provides an apparatus for dewatering a mixture that includes a solid particulate composition and a supernatant solution that includes an apparatus for further processing of the flue gas, in which wherein the apparatus for further processing of the flue gas provides the mixture comprising a solid particulate composition and a supernatant solution. In some embodiments, the invention provides an apparatus for dewatering a mixture that includes a solid particulate composition and a supernatant solution that further includes a solids removal conduit that transports the dewatered mixture comprising the solid particulate composition to a refining station. In some embodiments, the invention provides an apparatus for dewatering a mixture that includes a solid particulate composition and a supernatant solution that includes a refining station, in which the refining station includes a particulate grinding system, a particulate compaction system, a washing station, or any combination thereof. In some embodiments, the invention provides an apparatus for dewatering a mixture that includes a solid particulate composition and a supernatant solution in which the flue gas source is the flue gas stack of a power plant. In some embodiments, the invention provides an apparatus for dewatering a mixture that includes a solid particulate composition and a supernatant solution in which the flue gas source is the flue gas stack of a power plant and in which the flue gas enters the first connection at a temperature greater than 100° F. In some embodiments, the invention provides an apparatus for dewatering a mixture that includes a solid particulate composition and a supernatant solution in which the flue gas source is the flue gas stack of a power plant and in which the flue gas enters the second connection at a temperature at least 10° F. less than the temperature at which the glue gas entered the first connection. In some embodiments, the invention provides an apparatus for dewatering a mixture that includes a solid particulate composition and a supernatant solution in which the flue gas source is the flue gas stack of a power plant and in which the flue gas enters the second connection at a temperature at least 20° F. less than the temperature at which the glue gas entered the first connection. In some embodiments, the invention provides an apparatus for dewatering a mixture that includes a solid particulate composition and a supernatant solution in which the dewatered mixture is at least 35% (by weight) solids. In some embodiments, the invention provides an apparatus for dewatering a mixture that includes a solid particulate composition and a supernatant solution in which the dewatered mixture is at least 45% solids. In some embodiments, the invention provides an apparatus for dewatering a mixture that includes a solid particulate composition and a supernatant solution in which the dewatered mixture is greater than 90% solids. In some embodiments, the invention provides an apparatus for dewatering a mixture that includes a solid particulate composition and a supernatant solution in which the dewatered mixture is at least 5% (by weight) more solids than the mixture before entering the apparatus. In some embodiments, the invention provides an apparatus for dewatering a mixture that includes a solid particulate composition and a supernatant solution in which the dewatered mixture is at least 10% more solids than the mixture before entering the apparatus.

In some embodiments, the invention provides a system that includes a carbonate precipitation apparatus that includes an inlet for a source of at least one of carbonate, bicarbonate, carbon dioxide, or a mixture thereof, in which the carbonate precipitation apparatus produces mixture that includes a carbonate and/or bicarbonate compound composition and a supernatant solution; and at least one of: i) a primary dewatering station; ii) a secondary dewatering station; and iii) a final dewatering station, in which the primary dewatering station separates the carbonate compound composition from the supernatant solution to form a first slurry that includes up to 30 wt % solids; in which the secondary dewatering station separates the carbonate compound composition from the supernatant solution to from a second slurry that includes greater than 30 wt % solids but less than 90 wt % solids; in which the final dewatering station further separates the carbonate compound composition from the supernatant solution to obtain a dewatered composition comprising greater than 90 wt % solids in which the solids include the carbonate compound composition; in which the mixture of the carbonate compound composition and the supernatant solution is provided from the carbonate precipitation apparatus to at least one of the primary, secondary, and final dewatering stations by a conduit, conveyor belt, or other convenient apparatus; and in which the dewatering stations in the systems comprise a conduit, conveyor belt, or other convenient apparatus to remove slurry or dewatered compositions from the stations. In some embodiments, the invention provides a system that includes a carbonate precipitation apparatus and at least one of a primary, secondary, and final dewatering station in which the carbonate precipitation apparatus includes an inlet for a gaseous source of carbon dioxide. In some embodiments, the invention provides a system that includes a carbonate precipitation apparatus and at least one of a primary, secondary, and final dewatering station in which the carbonate precipitation apparatus includes an inlet for a gaseous source of carbon dioxide, in which the gaseous source of carbon dioxide includes an industrial waste gas. In some embodiments, the invention provides a system that includes a carbonate precipitation apparatus and at least one of a primary, secondary, and final dewatering station in which the carbonate precipitation apparatus includes an inlet for a gaseous source of carbon dioxide in which the gaseous source of carbon dioxide includes an industrial waste gas that includes gas from a fossil fuel burning power plant. In some embodiments, the invention provides a system that includes a carbonate precipitation apparatus and at least one of a primary, secondary, and final dewatering station in which the carbonate precipitation apparatus includes an inlet for a gaseous source of carbon dioxide in which the gaseous source of carbon dioxide includes an industrial waste gas that includes gas from a coal burning power plant. In some embodiments, the invention provides a system that includes a carbonate precipitation apparatus and at least one of a primary, secondary, and final dewatering station in which the carbonate precipitation apparatus includes an inlet for a solution that includes carbonate ions, bicarbonate ions, or a combination of carbonate and bicarbonate ions. In some embodiments, the invention provides a system that includes a carbonate precipitation apparatus and at least one of a primary, secondary, and final dewatering station in which the carbonate precipitation apparatus includes an inlet for a solution that includes carbonate ions, bicarbonate ions, or a combination of carbonate and bicarbonate ions in which the solution includes an alkaline brine. In some embodiments, the invention provides a system that includes a carbonate precipitation apparatus and at least one of a primary, secondary, and final dewatering station in which precipitation apparatus also includes a pH adjusting system that includes an inlet for pH adjusting agents. In some embodiments, the invention provides a system that includes a carbonate precipitation apparatus and at least one of a primary, secondary, and final dewatering station in which precipitation apparatus also includes a pH adjusting system that includes an inlet for pH adjusting agents in which the pH adjusting system is operably connected to an electrochemical system for proton removal, an electrochemical system that produces a pH adjusting agent, or both. In some embodiments, the invention provides a system that includes a carbonate precipitation apparatus and at least one of a primary, secondary, and final dewatering station that further includes a refining station operably connected to the primary dewatering station, the secondary dewatering station, the final dewatering station, or any combination of the dewatering stations. In some embodiments, the invention provides a system that includes a carbonate precipitation apparatus and at least one of a primary, secondary, and final dewatering station that further includes a refining station that includes a carbonate and/or bicarbonate compound composition refining station, a supernatant solution treatment system, or both a composition refining station and a solution treatment system. In some embodiments, the invention provides a system that includes a carbonate precipitation apparatus and at least one of a primary, secondary, and final dewatering station that further includes a refining station that includes a carbonate and/or bicarbonate compound composition refining station that further includes a building materials fabrication system. In some embodiments, the invention provides a system that includes a carbonate precipitation apparatus and at least one of a primary, secondary, and final dewatering station that further includes a refining station that includes a supernatant solution treatment system that includes at least one of: a pH adjustment system, a reverse osmosis apparatus, a nano-filtration apparatus, a forward osmosis apparatus, a micro-filtration apparatus, a membrane distillation apparatus, or a salt-recovery apparatus. In some embodiments, the invention provides a system that includes a carbonate precipitation apparatus and at least one of a primary, secondary, and final dewatering station in which the primary dewatering station includes at least one of: i) a decanting baffle; ii) a Lamella clarifier/thickener; iii) a filter; iv) a clarifier; v) a sludge bed clarifier; vi) a centrifuge; vii) a hydrocyclone; iix) a flocculation system; ix) a filtering aid introduction system; x) a coagulation system; or xi) a crystallization acceleration system; and in which the secondary dewatering station includes at least one of: i) a filter press; ii) a belt press; iii) a vacuum drum; iv) a separating conveyor belt; v) a vertical press; vi) a spray drying apparatus; vii) a vacuum filter; or iix) a gas-pressure filter; and in which the final dewatering station includes at least one of: i) one or more evaporation ponds; ii) a spray drying apparatus; iii) an oven; iv) a furnace; v) a solar concentrator; vi) a heat exchanger in contact with industrial waste gas at a temperature above ambient atmospheric temperature; vii) a heat exchanger in contact with a geological brine at a temperature above ambient atmospheric temperature; or iix) a conveyance apparatus that allows direct exposure of the carbonate compound composition and supernatant solution mixture to industrial waste gas at a temperature above ambient atmospheric temperature.

Provided herein are systems comprising a precipitation reactor for producing an effluent comprising a precipitation product comprising carbonate; bicarbonate, or a combination thereof, operably connected to a liquid-solid separation apparatus for concentrating the precipitation product from the precipitation reactor effluent.

In one version of the liquid-solid separation apparatus, the liquid-solid separation apparatus comprises a baffle situated such that in operation the baffle deflects the precipitation reactor effluent such that precipitation product descends to a lower region of the liquid-solid separation apparatus and supernatant ascends and exits the liquid-solid separation apparatus. In another version of the liquid-solid apparatus, the liquid-solid separation apparatus comprises a spiral channel configured to direct effluent from the precipitation reactor to flow in the spiral channel resulting in concentration of the precipitation product based on size and mass and production of a supernatant. Liquid-solid separation apparatus of the systems described herein comprise a precipitation product collector capable of collecting 50% to 100%, 75% to 100%, or 95% to 100% of the precipitation product from the precipitation station. Additionally, liquid-solid separation apparatus are capable of processing 100 L/min to 20,000 L/min, 5000 L/min to 20,000 L/min, or 10,000 L/min to 20,000 L/min of effluent from the precipitation station.

Precipitation reactors of the systems described herein may comprise a charging reactor and precipitation station. The charging reactor is capable of removing CO₂ from an industrial waste gas stream. Furthermore, the charging reactor may be capable of removing one or more of SOx, NOx, heavy metals, particulates, VOCs, or a combination thereof, from the industrial waste gas steam. The charging reactor comprises a flat jet nozzle coupled to a source of water, wherein the flat jet nozzle is adapted to form a flat jet stream for contacting a gaseous waste stream comprising CO₂ with water from the source of water. The gaseous waste stream comprising CO₂ is a waste stream from an industrial plant that burns carbon-based fuels, calcined materials, or a combination thereof. The water provided by the source of water may contain alkaline earth metal ions; in such cases the source of water may be selected from the group selected from fresh water brackish water, seawater, and brine. The precipitation station is operably connected to a source of a pH-raising agent. The pH-raising agent may comprises ash, oxides, hydroxides, or carbonates. The precipitation station is adapted to produce precipitation product comprising carbonate, bicarbonate, or a combination thereof.

The systems described herein may further comprise an electrochemical cell. The electrochemical cell may be configured to remove protons from the charging station, the precipitation station, or both the charging and the precipitation station.

Also provided are integrated systems comprising a power plant that combusts carbon-based fuel to produce a waste gas stream comprising carbon dioxide, operably connected to a waste gas-processing system. The waste gas-processing system comprises a precipitation reactor for producing an effluent comprising a precipitation product comprising carbonate, bicarbonate, or a combination thereof, operably connected to a liquid-solid separation apparatus for concentrating the precipitation product from the precipitation reactor effluent. In one version of the liquid-solid separation apparatus, the liquid-solid separation apparatus comprises a baffle situated such that in operation the baffle deflects the precipitation reactor effluent such that precipitation product descends to a lower region of the liquid-solid separation apparatus and supernatant ascends and exits the liquid-solid separation apparatus. In another version of the liquid-solid separation apparatus, the liquid-solid separation apparatus comprises a spiral channel configured to direct effluent from the precipitation reactor to flow in the spiral channel resulting in concentration of the precipitation product based on size and mass and production of a supernatant. The waste gas stream further comprises SOx, NOx, heavy metals, VOCs, particulates, or a combination thereof.

Also provided are methods comprising transferring part or all of a gaseous waste stream from an industrial plant comprising carbon dioxide to a precipitation reactor for producing an effluent comprising a precipitation product comprising carbonate, bicarbonate, or a combination thereof; and concentrating the precipitation product from precipitation reactor effluent in a liquid-solid separation apparatus. In one version of the liquid-solid separation apparatus, the effluent is deflected against a baffle within the liquid-solid separation apparatus such that precipitation product descends to a lower region of the liquid-solid separation apparatus and supernatant ascends and exits the liquid-solid separation apparatus. In another version of the liquid-solid separation apparatus, the effluent is made to flow in a spiral channel resulting in concentration of the precipitation product based on size and mass, and production of a supernatant.

Methods for sequestering carbon dioxide may be done with any system according to any one of the preceding claims.

### DRAWINGS

The novel features of the invention are set forth with particularity in the appended claims. A better understanding of the features and advantages of the invention will be obtained by reference to the following detailed description that sets forth illustrative embodiments, in which the principles of the invention are utilized, and the accompanying drawings of which:

FIG. 1A provides a system of the invention comprising a processor, wherein the processor is configured to process a variety of gases comprising carbon dioxide.

FIG. 1B provides a system of the invention comprising a processor and a treatment system, wherein the treatment system is configured to treat compositions from the processor.

FIG. 1C provides a system of the invention comprising a processor and an optional treatment system, wherein the processor comprises a contactor and a reactor.

FIG. 1D provides a system of the invention comprising a processor and a treatment system, wherein supernatant from the treatment system may optionally be recirculated to the processor.

FIG. 1E provides a system of the invention comprising a processor, a treatment system, and an electrochemical system, wherein supernatant from the treatment system may optionally be recirculated to the processor, the electrochemical system, or a combination thereof.

FIG. 2 provides a diagram of one embodiment of a low-voltage apparatus for producing hydroxide electrochemically.

FIG. 3 provides a diagram of another embodiment of a low-voltage apparatus for producing hydroxide electrochemically.

FIG. 4 provides a diagram of another embodiment of a low-voltage apparatus for producing hydroxide electrochemically.

FIG. 5 provides a schematic diagram of a CO₂ sequestration system or method according to some embodiments of the invention.

FIG. 6 provides a diagram of the inputs and outputs of one embodiment of the invention.

FIG. 7 provides a top-view schematic of an apparatus of one embodiment of the invention.

FIG. 8 provides a cross-sectional view schematic of the apparatus of FIG. 7.

FIG. 9 provides a cross-sectional view schematic of an embodiment of the invention that employs multiple apparatus of the invention in series.

FIG. 10 provides a schematic diagram of a CO₂ sequestration system with an industrial plant according to some embodiments of the invention.

FIG. W1 provides a UQV/se weathering chamber.

FIG. W2 provides a provides a TG/DTG for a carbonated sample of mortar.

FIG. W3 provides a material exposure and testing schedule.

FIG. W4 provides carbonation profiles of two paste mixes.

FIG. W5 provides a TGA scan for 80% OPC/20% precipitation material.

FIG. W6 provides an overlay of XRD scans for 100% OPC.

FIG. W7 provides an overlay of XRD scans for 80% OPC/20% precipitation material.

### DESCRIPTION

Before the invention is described in greater detail, it is to be understood that the invention is not limited to particular embodiments described herein as such embodiments may vary. It is also to be understood that the terminology used herein is for the purpose of describing particular embodiments only, and is not intended to be limiting, since the scope of the invention will be limited only by the appended claims. Unless defined otherwise, all technical and scientific terms used herein have the same meaning as commonly understood by one of ordinary skill in the art to which this invention belongs.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number.

All publications, patents, and patent applications cited in this specification are incorporated herein by reference to the same extent as if each individual publication, patent, or patent application were specifically and individually indicated to be incorporated by reference. Furthermore, each cited publication, patent, or patent application is incorporated herein by reference to disclose and describe the subject matter in connection with which the publications are cited. The citation of any publication is for its disclosure prior to the filing date and should not be construed as an admission that the invention described herein is not entitled to antedate such publication by virtue of prior invention. Further, the dates of publication provided may be different from the actual publication dates, which may need to be independently confirmed.

It is noted that, as used herein and in the appended claims, the singular forms “a”, “an”, and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method can be carried out in the order of events recited or in any other order, which is logically possible. Although any methods and materials similar or equivalent to those described herein may also be used in the practice or testing of the invention, representative illustrative methods and materials are now described.

The methods and systems of the invention utilize processes summarized by the following chemical reactions:

(1) Combustion of a carbon-containing fuel source in liquid, gas, or solid phase forms gaseous carbon dioxide:

C+O₂(g)→CO₂(g)

(2) Contacting the source of carbon dioxide with a water source solvates the carbon dioxide to give an aqueous solution of carbon dioxide:

CO₂(g)⇄CO₂(aq)

(3) Carbon dioxide dissolved in water establishes equilibrium with aqueous carbonic acid:

CO₂(aq)+H₂O⇄H₂CO₃(aq)

(4) Carbonic acid is a weak acid which dissociates in two steps, where the equilibrium balance is determined in part by the pH of the solution, with, generally, pHs below 8-9 favoring bicarbonate formation and pHs above 9-10 favoring carbonate formation. In the second step, a hydroxide source may be added to increase alkalinity:

H₂CO₃+2H₂O⇄H₃O⁺(aq)+HCO₃⁻(aq)

HCO₃⁻(aq)+OH⁻(aq)⇄H₂O+CO₃²⁻(aq)

Reaction of elemental metal cations from Group IIA with the carbonate anion forms a metal carbonate precipitate:

mX(aq)+nCO₃²⁻⇄Xₘ(CO₃)ₙ(s)

wherein X is any element or combination of elements that can chemically bond with a carbonate group or its multiple and m and n are stoichiometric positive integers.

In further describing the subject invention, the methods of CO₂ sequestration according to embodiments of the invention are described first in greater detail. Systems that find use in practicing various embodiments of the methods of the invention are then described, followed by compositions that may be produced using methods and systems of the invention.

### Methods of CO₂ Sequestration

In some embodiments, the invention provides a method of CO₂ sequestration. In such embodiments, an amount of CO₂ may be removed or segregated from an environment, such as the Earth's atmosphere or a gaseous waste stream produced by an industrial plant, so that some or all of the CO₂ is no longer present in the environment from which the CO₂ was removed. For example, CO₂ sequestration removes CO₂ or prevents the release of CO₂ into the atmosphere from the combustion of fuel. In some embodiments, the CO₂ sequestered is in the form of a composition comprising carbonates, bicarbonates, or carbonates and bicarbonates. Such compositions may comprise a solution, a slurry comprising precipitation material, or precipitation material alone or in combination with one or more additional materials for use in or as a building material. For example, a composition of the invention may comprise precipitation material comprising a carbonate compound (e.g., amorphous calcium carbonate, calcite, aragonite, vaterite, etc.). Therefore, in some embodiments, CO₂ sequestration according to aspects of the invention produces compositions (e.g., precipitation material comprising a carbonate compound), wherein at least part of the carbon in the compositions is derived from a fuel used by humans (e.g., a fossil fuel). CO₂-sequestering methods of the invention produce storage-stable products from an amount of CO₂, such that the CO₂ from which the product is produced is then sequestered in that product. A storage-stable CO₂-sequestering product is a storage-stable composition that incorporates an amount of CO₂ into a storage-stable form, such as an above-ground, underwater, or underground storage-stable form, so that the CO₂ is no longer present as, or available to be, a gas in the atmosphere. As such, sequestering of CO₂ according to methods of the invention results in prevention of CO₂ gas from entering the atmosphere and allows for long-term storage of CO₂ in a manner such that CO₂ does not become part of the atmosphere.

Embodiments of methods of the invention comprise small-, neutral- or negative-carbon footprint methods. Carbon neutral methods of the invention comprise methods having a negligible carbon footprint or no carbon footprint. In negative-carbon footprint methods, the amount by weight of CO₂ that is sequestered (e.g., through conversion of CO₂ to carbonate) by practice of the methods is greater that the amount of CO₂ that is generated (e.g., through power production, base production, etc) to practice the methods. In some instances, the amount by weight of CO₂ that is sequestered by practicing the methods exceeds the amount by weight of CO₂ that is generated in practicing the methods by 1 to 100%, such as 5 to 100%, including 10 to 95%, 10 to 90%, 10 to 80%, 10 to 70%, 10 to 60%, 10 to 50%, 10 to 40%, 10 to 30%, 10 to 20%, 20 to 95%, 20 to 90%, 20 to 80%, 20 to 70%, 20 to 60%, 20 to 50%, 20 to 40%, 20 to 30%, 30 to 95%, 30 to 90%, 30 to 80%, 30 to 70%, 30 to 60%, 30 to 50%, 30 to 40%, 40 to 95%, 40 to 90%, 40 to 80%, 40 to 70%, 40 to 60%, 40 to 50%, 50 to 95%, 50 to 90%, 50 to 80%, 50 to 70%, 50 to 60%, 60 to 95%, 60 to 90%, 60 to 80%, 60 to 70%, 70 to 95%, 70 to 90%, 70 to 80%, 80 to 95%, 80 to 90%, and 90 to 95%. In some instances, the amount by weight of CO₂ that is sequestered by practicing the methods exceeds the amount by weight of CO₂ that is generated in practicing the methods by 5% or more, by 10% or more, by 15% or more, by 20% or more, by 30% or more, by 40% or more, by 50% or more, by 60% or more, by 70% or more, by 80% or more, by 90% or more, or by 95% or more.

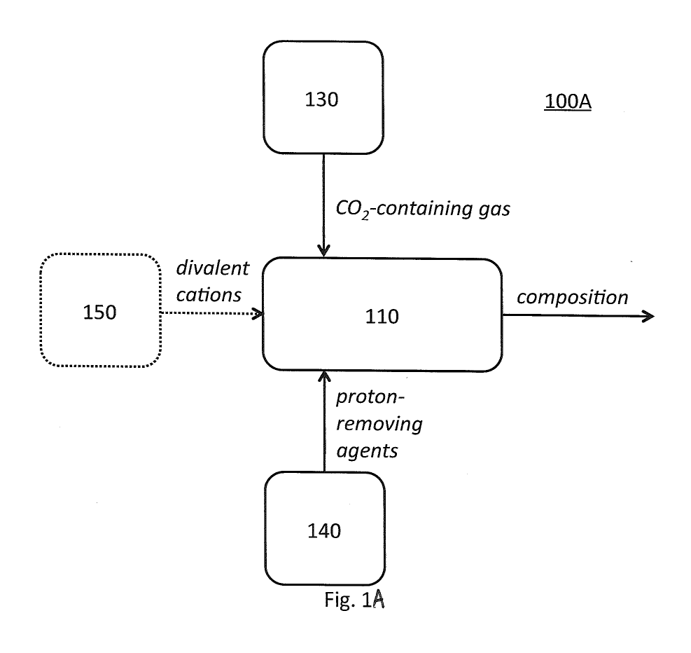

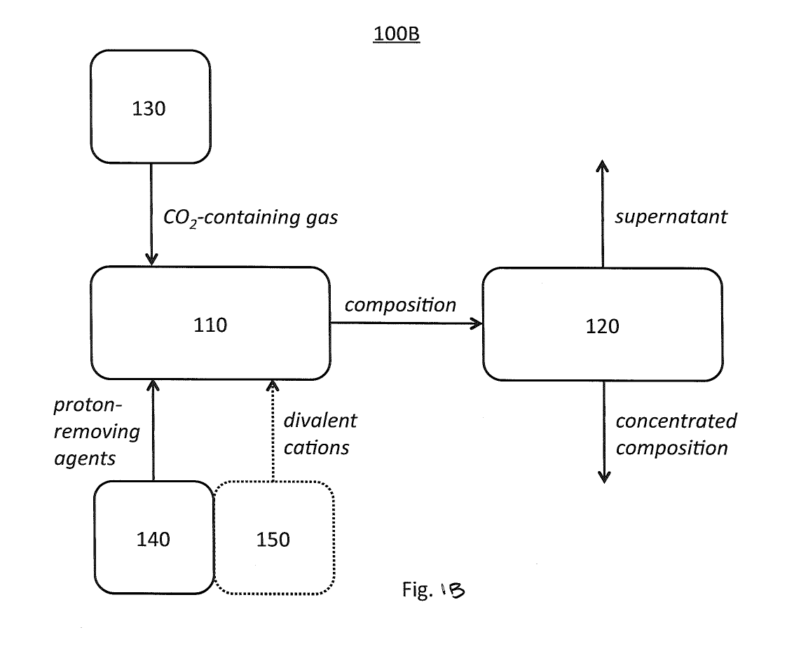

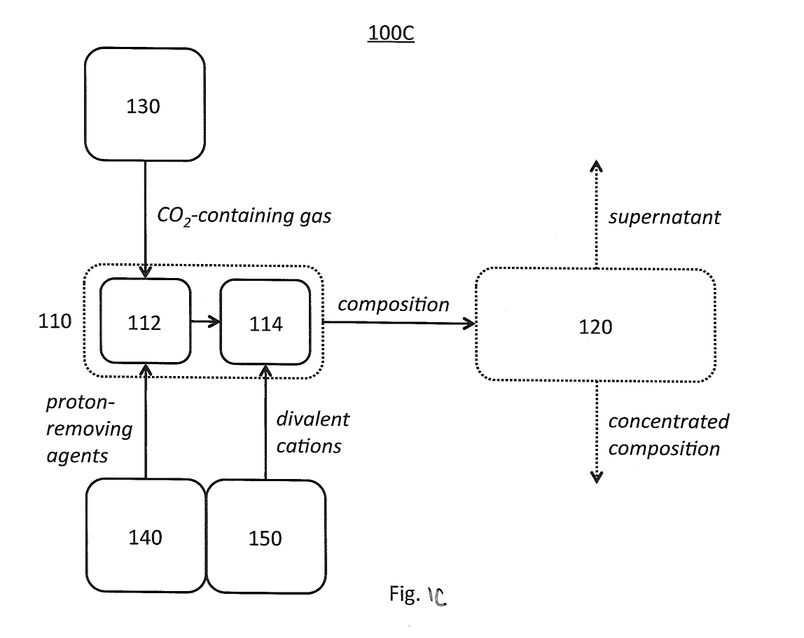

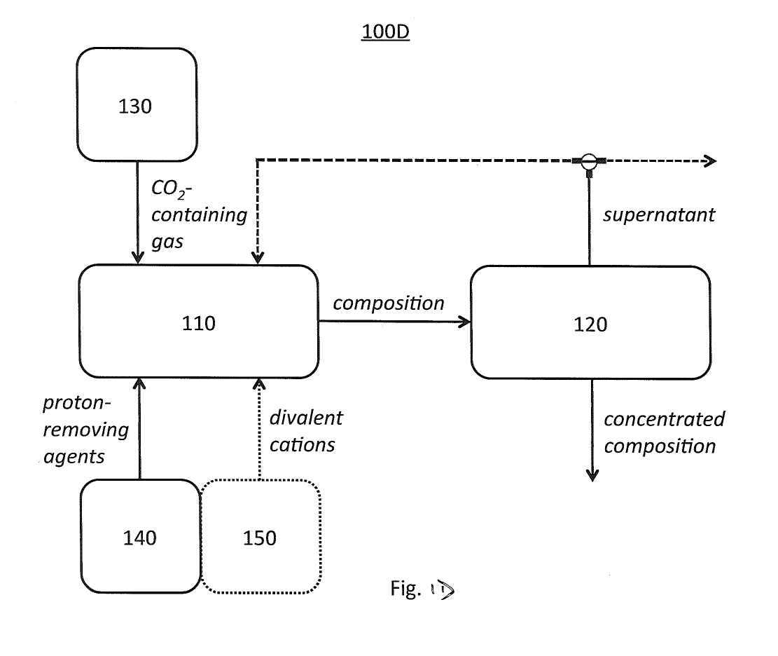

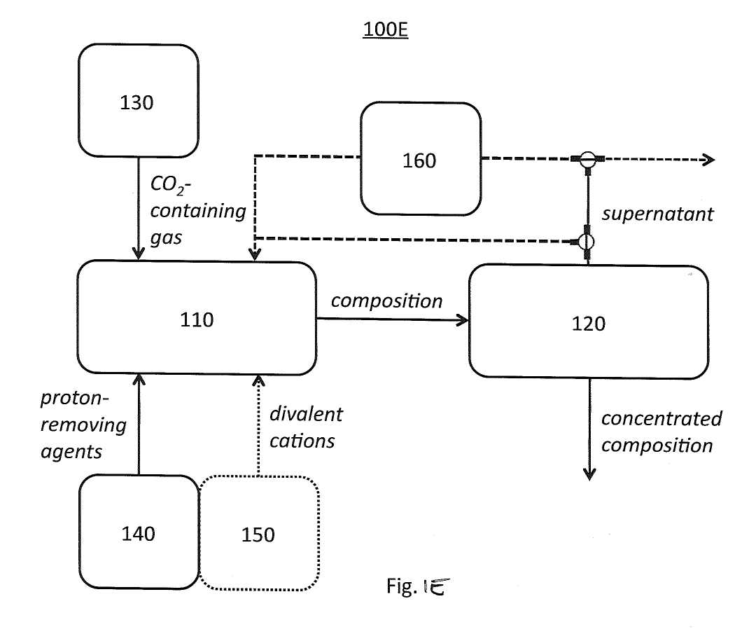

In reference to the system of FIG. 1A, the invention provides an aqueous-based method for processing a source of carbon dioxide (130) and producing a composition comprising carbonates, bicarbonates, or carbonates and bicarbonates, wherein the source of carbon dioxide comprises one or more additional components in addition to carbon dioxide. In such embodiments, the industrial source of carbon dioxide may be sourced, a source of proton-removing agents (140) may be sourced, and each may be provided to processor 110 to be processed (i.e., subjected to suitable conditions for production of the composition comprising carbonates, bicarbonates, or carbonates and bicarbonates). In some embodiments, processing the industrial source of carbon dioxide comprises contacting the source of proton-removing agents in a contactor such as, but not limited to, a gas-liquid contactor or a gas-liquid-solid contactor to produce a carbon dioxide-charged composition, which composition may be a solution or slurry, from an initial aqueous solution or slurry. In some embodiments, the composition comprising carbonates, bicarbonates, or carbonates and bicarbonates may be produced from the carbon dioxide-charged solution or slurry in the contactor. In some embodiments, the carbon dioxide-charged solution or slurry may be provided to a reactor, within which the composition comprising carbonates, bicarbonates, or carbonates and bicarbonates may be produced. In some embodiments, the composition is produced in both the contactor and the reactor. For example, in some embodiments, the contactor may produce an initial composition comprising bicarbonates and the reactor may produce the composition comprising carbonates, bicarbonates, or carbonates and bicarbonates from the initial composition. In some embodiments, methods of the invention may further comprise sourcing a source of divalent cations such as those of alkaline earth metals (e.g., Ca²⁺, Mg^{2÷}). In such embodiments, the source of divalent cations may be provided to the source of proton-removing agents or provided directly to the processor. Provided sufficient divalent cations are provided by the source of proton-removing agents, by the source of divalent cations, or by a combination of the foregoing sources, the composition comprising carbonates, bicarbonates, or carbonates and bicarbonates may comprise an isolable precipitation material (e.g., CaCO₃, MgCO₃, or a composition thereof). Whether the composition from the processor comprises an isolable precipitation material or not, the composition may be used directly from the processor (optionally with minimal post-processing) in the manufacture of building materials. In some embodiments, compositions comprising carbonates, bicarbonates, or carbonates and bicarbonates directly from the processor (optionally with minimal post-processing) may be injected into a subterranean site as described in U.S. Provisional Patent Application No. 61/232,401, filed 7 Aug. 2009, which application is incorporated herein by reference in its entirety.

In reference to the systems of FIGS. 1B-1E, the invention provides an aqueous-based method for processing a source of carbon dioxide (130) and producing a composition comprising carbonates, bicarbonates, or carbonates and bicarbonates, wherein the source of carbon dioxide comprises one or more additional components in addition to carbon dioxide. In addition to producing compositions as described in reference to FIG. 1A, the invention further provides methods for treating compositions comprising carbonates, bicarbonates, or carbonates and bicarbonates. As such, in some embodiments, the invention provides an aqueous-based method for processing a source of carbon dioxide (130) to produce a composition comprising carbonates, bicarbonates, or carbonates and bicarbonates and treating the composition produced. Whether a processor-produced composition of the invention comprises an isolable precipitation material or not, the composition may be directly provided to a treatment system of the invention for treatment (e.g., concentration, filtration, etc.). In some embodiments, the composition may be provided directly to the treatment system from a contactor, a reactor, or a settling tank of the processor. For example, a processor-produced composition that does not contain an isolable precipitation material may be provided directly to a treatment system for concentration of the composition and production of a supernatant. In another non-limiting example, a processor-produced composition comprising an isolable precipitation material may be provided directly to a treatment system for liquid-solid separation. The processor-produced composition may be provided to any of a number of treatment system sub-systems, which sub-systems include, but are not limited to, dewatering systems, filtration systems, or dewatering systems in combination with filtration systems, wherein treatment systems, or a sub-systems thereof, separate supernatant from the composition to produce a concentrated composition (e.g., the concentrated composition is more concentrated with to respect to carbonates, bicarbonates, or carbonates and carbonates).

With reference to the system of FIG. 1C, in some embodiments, the invention provides a method for charging a solution with CO₂ from an industrial waste gas stream to produce a composition comprising carbonates, bicarbonates, or carbonates and bicarbonates. In such embodiments, the solution may have a pH ranging from pH 6.5 to pH 14.0 prior to charging the solution with CO₂. In some embodiments, the solution may have a pH of at least pH 6.5, pH 7.0, pH 7.5, pH 8.0, pH 8.5, pH 9.0, pH 9.5, pH 10.0, pH 10.5, pH 11.0, pH 11.5, pH 12.0, pH 12.5, pH 13.0, pH 13.5, or pH 14.0 prior to charging the solution with CO₂. The pH of the solution may be increased using any convenient approach including, but not limited to, use of proton-removing agents and electrochemical methods for effecting proton removal. In some embodiments, proton-removing agents may be used to increase the pH of the solution prior to charging the solution with CO₂. Such proton-removing agents include, but are not limited to, hydroxides (e.g., NaOH, KOH) and carbonates (e.g., Na₂CO₃, K₂CO₃). In some embodiments, sodium hydroxide is used to increase the pH of the solution. As such, in some embodiments, the invention provides a method for charging an alkaline solution (e.g., pH>pH 7.0) with CO₂ from an industrial waste gas stream to produce a composition comprising carbonates, bicarbonates, or carbonates and bicarbonates.

In some embodiments, the composition resulting from charging the alkaline solution with CO₂ from an industrial waste source (i.e., the solution comprising carbonates, bicarbonates, or carbonates and bicarbonates) may be a slurry or a substantially clear solution (i.e., substantially free of precipitation material, such as at least 95% or more free) depending upon the cations available in the solution at the time the solution is charged with CO₂. As described herein, the solution may, in some embodiments, comprise divalent cations such as Ca²⁺, Mg²⁺, or a combination thereof at the time the solution is charged with CO₂. In such embodiments, the resultant composition may comprise carbonates, bicarbonates, or carbonates and bicarbonates of divalent cations (e.g. precipitation material) resulting in a slurry. Such slurries, for example, may comprise CaCO₃, MgCO₃, or a combination thereof. The solution may, in some embodiments, comprise insufficient divalent cations to form a slurry comprising carbonates, bicarbonates, or carbonates and bicarbonates of divalent cations at the time the solution is charged with CO₂. In such embodiments, the resultant composition may comprise carbonates, bicarbonates, or carbonates and bicarbonates in a substantially clear solution (i.e., substantially free of precipitation material, such as at least 95% or more free) at the time the solution is charged with CO₂. In some embodiments, for example, monovalent cations such as Na⁺, K⁺, or a combination thereof (optionally by addition of NaOH and/or KOH) may be present in the substantially clear solution at the time the solution is charged with CO₂. The composition resulting from charging such a solution with CO₂ may comprise, for example, carbonates, bicarbonates, or carbonates and bicarbonates of monovalent cations.

As such, in some embodiments, the invention provides a method for charging an alkaline solution (e.g., pH>pH 7.0) with CO₂ from an industrial waste gas stream to produce a composition comprising carbonates, bicarbonates, or carbonates and bicarbonates, wherein the composition is substantially clear (i.e., substantially free of precipitation material, such as at least 95% or more free). The substantially clear composition may subsequently be contacted with a source of divalent cations (e.g., Ca²⁺, Mg²⁺, or a combination thereof) to produce a composition comprising carbonates, bicarbonates, or carbonates and bicarbonates of divalent cations resulting in a slurry. As above, such slurries may comprise CaCO₃, MgCO₃, or a combination thereof that may be treated as described herein. In a non-limiting example, an alkaline solution comprising NaOH (e.g., NaOH dissolved in freshwater lacking significant divalent cations) may be contacted in a gas-liquid contactor with CO₂ from an industrial waste gas stream to produce a composition comprising carbonates, bicarbonates, or carbonates and bicarbonates, wherein the composition is substantially clear due to a lack of precipitation material, which, in turn, is due to the lack of significant divalent cations. Depending upon the amount of CO₂ added (and makeup NaOH, if any), the substantially clear composition may comprise NaOH, NaHCO₃, and/or Na₂CO₃. The substantially clear composition may subsequently be contacted in a reactor outside the gas-liquid contactor with a source of divalent cations (e.g., Ca²⁺, Mg²⁺, Sr²⁺, and the like) to produce a composition comprising carbonates, bicarbonates, or carbonates and bicarbonates of divalent cations (e.g., precipitation material) resulting in a slurry. As such, compositions may comprise CaCO₃ and/or MgCO₃, and the compositions may be treated as described herein. For example, the composition may be subjected to liquid-solid separation and the solids manufactured into cement, supplementary cementitious material, fine aggregate, mortar, coarse aggregate, concrete, pozzolan, or a combination thereof.

With reference to the systems of FIGS. 1D and 1E, the invention also provides aqueous-based methods of processing a source of carbon dioxide (130) and producing a composition comprising carbonates, bicarbonates, or carbonates and bicarbonates, wherein the source of carbon dioxide comprises one or more additional components in addition to carbon dioxide, and wherein at least a portion of treatment system supernatant is recirculated. For example, in some embodiments, the invention provides a method of treating a waste gas stream comprising CO₂ and, optionally, SOx, NOx, and/or Hg in a processer to produce a processed waste gas stream (e.g., a clean gas stream suitable for release into the environment), a composition comprising carbonates, bicarbonates, or carbonates and bicarbonates, and an effluent, wherein at least a portion of the effluent is recirculated to the processor. As shown in FIGS. 1D and 1E, supernatant from the treatment system, which may comprise a dewatering system and a filtration system, may be recirculated in a variety of ways. As such, in some embodiments, at least a portion of the supernatant from the dewatering system, the filtration system, or a combination of the dewatering system and the filtration system may be used to process carbon dioxide. The supernatant may be provided to a carbon dioxide-processing system processor. In such embodiments, the supernatant may be provided to a contactor (e.g., gas-liquid contactor, gas-liquid-solid contactor), to a reactor, to a combination of the contactor and the reactor, or to any other unit or combination of units for processing carbon dioxide. In addition, in some embodiments, at least a portion of the supernatant from the treatment system may be provided to a washing system. In such embodiments, the supernatant may be used to wash compositions (e.g., precipitation material comprising CaCO₃, MgCO₃, or a combination thereof) of the invention. For example, the supernatant may be used to wash chloride from carbonate-based precipitation material. With reference to FIG. 1E, at least a portion of the treatment system supernatant may be provided to an electrochemical system. As such, treatment system supernatant may be used to produce proton-removing agents or effect proton removal for processing carbon dioxide. In some embodiments, at least a portion of the supernatant from the treatment system may be provided to a different system or process. For example, at least a portion of the treatment system supernatant may be provided to a desalination plant or desalination process such that the treatment system supernatant, which is generally softer (i.e., lower concentration of Ca²⁺ and/or Mg²⁺) than other available feeds (e.g., seawater, brine, etc.) after being used to process carbon dioxide, may be desalinated for potable water.

Recirculation of treatment system supernatant is advantageous as recirculation provides efficient use of available resources; minimal disturbance of surrounding environments; and reduced energy requirements, which reduced energy requirements provide for lower carbon footprints for systems and methods of the invention. When a carbon dioxide-processing system of the invention is operably connected to an industrial plant (e.g., fossil fuel-fired power plant such as coal-fired power plant) and utilizes power generated at the industrial plant, reduced energy requirements provided by recirculation of treatment system supernatant provide for a reduced energy demand on the industrial plant. A carbon dioxide-processing system not configured for recirculation (i.e., a carbon-dioxide processing system configured for a once-through process) such as that shown in FIG. 1B, may have an energy demand on the industrial plant of at least 10% attributable to continuously pumping a fresh source of alkalinity (e.g., seawater, brine) into the system. In such an example, a 100 MW power plant (e.g., a coal-fired power plant) would need to devote 10 MW of power to the carbon dioxide-processing system for continuously pumping a fresh source of alkalinity into the system. In contrast, a system configured for recirculation such as that shown in FIG. 1D or FIG. 1E may have an energy demand on the industrial plant of less than 10%, such as less than 8%, including less than 6%, for example, less than 4% or less than 2%, which energy demand may be attributable to pumping make-up water and recirculating supernatant. Carbon dioxide-processing systems configured for recirculation, may, when compared to systems designed for a once-through process, exhibit a reduction in energy demand of at least 2%, such as at least 5%, including at least 10%, for example, at least 25% or at least 50%. For example, if a carbon dioxide-processing system configured for recirculation consumes 9 MW of power for pumping make-up water and recirculating supernatant and a carbon dioxide-processing system designed for a once-through process consumes 10 MW attributable to pumping, then the carbon dioxide-processing system configured for recirculation exhibits a 10% reduction in energy demand. For systems such as those shown in FIGS. 1D and 1E (i.e., carbon dioxide-processing systems configured for recirculation), the reduction in the energy demand attributable to pumping and recirculating may also provide a reduction in total energy demand, especially when compared to carbon dioxide-processing systems configured for once-through process. In some embodiments, recirculation provides a reduction in total energy demand of a carbon dioxide-processing system, wherein the reduction is at least 2%, such as at least 4%, including at least 6%, for example at least 8% or at least 10% when compared to total energy demand of a carbon dioxide-processing system configured for once-through process. For example, if a carbon dioxide-processing system configured for recirculation has a 15% energy demand and a carbon dioxide-processing system designed for a once-through process has a 20% energy demand, then the carbon dioxide-processing system configured for recirculation exhibits a 5% reduction in total energy demand. For example, a carbon dioxide-processing system configured for recirculation, wherein recirculation comprises filtration through a filtration unit such as a nanofiltration unit (e.g., to concentrate divalent cations in the retentate and reduce divalent cations in the permeate), may have a reduction in total energy demand of at least 2%, such as at least 4%, including at least 6%, for example at least 8% or at least 10% when compared to a carbon dioxide-processing system configured for once-through process.

The energy demand of carbon dioxide-processing systems and methods of the invention may be further reduced by efficient use of other resources. In some embodiments, the energy demand of carbon dioxide-processing systems of the invention may be further reduced by efficient use of heat from an industrial source. In some embodiments, for example, heat from the industrial source of carbon dioxide (e.g., flue gas heat from a coal-fired power plant) may be utilized for drying a composition comprising precipitation material comprising carbonates, bicarbonates, or carbonates and bicarbonates. In such embodiments, a spray dryer may be used for spray drying the composition. For example, low-grade (e.g., 150-200° C.) waste heat may be utilized by means of a heat exchanger to evaporatively spray dry the composition comprising the precipitation material. In addition, utilizing heat from the industrial source of carbon dioxide for drying compositions of the invention allows for simultaneous cooling of the industrial source of carbon dioxide (e.g., flue gas from a coal-fired power plant), which enhances dissolution of carbon dioxide, a process which is inversely related to temperature. In some embodiments, the energy demand of carbon dioxide-processing systems of the invention may be further reduced by efficient use of pressure. For example, in some embodiments, carbon dioxide-processing systems of the invention are configured with an energy recovery system. Such energy recovery systems are known, for example, in the art of desalination and operate by means of pressure exchange. In some embodiments, the overall energy demand of the carbon dioxide-processing system may be less than 99.9%, 90%, 80%, 70%, 60%, 50%, 40%, 30%, 20%, 15%, 10%, 5%, or 3% when capturing and processing 70-90% of the carbon dioxide emitted from an industrial plant (e.g., coal-fired power plant). For example, in some embodiments, the overall energy demand of the carbon dioxide-processing system may be less than 30%, such as less than 20%, including less than 15%, for example, less than 10%, less than 5%, or less than 3% when capturing and processing 70-90% of the carbon dioxide emitted from an industrial plant (e.g., coal-fired power plant). As such, carbon dioxide-processing systems of the invention configured for recirculation, heat exchange, and/or pressure exchange may reduce the energy demand on power-providing industrial plants while maintaining carbon dioxide processing capacity.

Inevitably, recirculation and other methods described herein consume water as water may become part of a composition of the invention (e.g., precipitation material comprising, for example, amorphous calcium carbonate CaCO₃.H₂O; nesquehonite MgCO₃.2H₂O; etc.), may be vaporized by drying (e.g., spray drying) compositions of the invention, or lost in some other part of the process. As such, make-up water may be provided to account for water lost to processing carbon dioxide to produce compositions of the invention (e.g., spray-dried precipitation material). For example, make-up water amounting to less than 700,000 gallons per day may replace water lost to producing, for example, spray-dried precipitation material from flue gas from a 35 MWe coal-fired power plant. Processes requiring only make-up water may be considered zero process water discharge processes. In processes in which additional water other than make-up water is used, that water may be sourced from any of the water sources (e.g., seawater, brine, etc.) described herein. In some embodiments, for example, water may be sourced from the power plant cooling stream and returned to that stream in a closed loop system. Processes requiring make-up water and additional process water are considered low process water discharge processes because systems and methods of the invention are designed to efficiently use resources.

In some embodiments, the invention provides for contacting a volume of an aqueous solution with a source of carbon dioxide to produce a composition comprising carbonates, bicarbonates, or carbonates and bicarbonates, wherein the composition is a solution or slurry. To produce precipitation material comprising carbonates, bicarbonates, or carbonates and bicarbonates, methods of the invention include contacting a volume of a divalent cation-containing aqueous solution with a source of CO₂ and subjecting the resultant solution to conditions that facilitate precipitation. Divalent cations may come from any of a number of different sources of divalent cations depending upon availability at a particular location. Such sources include industrial wastes, seawater, brines, hard waters, rocks and minerals (e.g., lime, periclase, material comprising metal silicates such as serpentine and olivine), and any other suitable source.

In some locations, waste streams from various industrial processes (i.e., industrial waste streams) provide for convenient sources of divalent cations (as well as proton-removing agents such as metal hydroxides). Such waste streams include, but are not limited to, mining wastes; ash (e.g., coal ash such as fly ash, bottom ash, boiler slag); slag (e.g. iron slag, phosphorous slag); cement kiln waste (e.g., cement kiln dust); oil refinery/petrochemical refinery waste (e.g. oil field and methane seam brines); coal seam wastes (e.g. gas production brines and coal seam brine); paper processing waste; water softening waste brine (e.g., ion exchange effluent); silicon processing wastes; agricultural waste; metal finishing waste; high pH textile waste; and caustic sludge. Ash, cement kiln dust, and slag, collectively waste sources of metal oxides, further described in U.S. patent application Ser. No. 12/486,692, filed 17 Jun. 2009, which is incorporated herein by reference in its entirety, may be used in any combination with material comprising metal silicates, further described in U.S. patent application Ser. No. 12/501,217, filed 10 Jul. 2009, which is also incorporated herein by reference in its entirety. Any of the divalent cations sources described herein may be mixed and matched for the purpose of practicing the invention. For example, material comprising metal silicates (e.g., magnesium silicate minerals such as olivine, serpentine, etc.) may be combined with any of the sources of divalent cations described herein for the purpose of practicing the invention.

In some locations, a convenient source of divalent cations for preparation of compositions of the invention (e.g., precipitation material comprising carbonates, bicarbonates, or carbonates and bicarbonates) is water (e.g., an aqueous solution comprising divalent cations such as seawater or brine), which may vary depending upon the particular location at which the invention is practiced. Suitable aqueous solutions of divalent cations that may be used include solutions comprising one or more divalent cations (e.g., alkaline earth metal cations such as Ca²⁺ and Mg²⁺). In some embodiments, the aqueous source of divalent cations comprises alkaline earth metal cations. In some embodiments, the alkaline earth metal cations include calcium, magnesium, or a mixture thereof. In some embodiments, the aqueous solution of divalent cations comprises calcium in amounts ranging from 50 to 50,000 ppm, 50 to 40,000 ppm, 50 to 20,000 ppm, 100 to 10,000 ppm, 200 to 5000 ppm, or 400 to 1000 ppm. In some embodiments, the aqueous solution of divalent cations comprises magnesium in amounts ranging from 50 to 40,000 ppm, 50 to 20,000 ppm, 100 to 10,000 ppm, 200 to 10,000 ppm, 500 to 5000 ppm, or 500 to 2500 ppm. In some embodiments, where Ca²⁺ and Mg²⁺ are both present, the ratio of Ca²⁺ to Mg²⁺ (i.e., Ca²⁺:Mg²⁺) in the aqueous solution of divalent cations is between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, in some embodiments, the ratio of Ca²⁺ to Mg²⁺ in the aqueous solution of divalent cations is between 1:1 and 1:10; 1:5 and 1:25; 1:10 and 1:50; 1:25 and 1:100; 1:50 and 1:500; or 1:100 and 1:1000. In some embodiments, the ratio of Mg²⁺ to Ca²⁺ (i.e., Mg²⁺:Ca²⁺) in the aqueous solution of divalent cations is between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, in some embodiments, the ratio of Mg²⁺ to Ca²⁺ in the aqueous solution of divalent cations is between 1:1 and 1:10; 1:5 and 1:25; 1:10 and 1:50; 1:25 and 1:100; 1:50 and 1:500; or 1:100 and 1:1000.

One or more components that are present in the source of divalent cations from which compositions of the invention (e.g., precipitation material) are prepared may be used to identify the source of divalent cations used. These identifying components and the amounts thereof may be referred to “source identifiers” or “markers.” For example, if the source of divalent cations is sea water, the source identifiers or markers that may be present in compositions of the invention (e.g., precipitation material) include, but are not limited to, chlorine, sodium, sulfur, potassium, bromine, silicon, strontium, and the like. Such elements may be present in the compositions in any known valency. Any such source identifiers or markers may be present in small amounts ranging from, for example, 20,000 ppm or less, 2000 ppm or less, 200 ppm or less, or 20 ppm or less. In some embodiments, for example, the marker is strontium. In a precipitation material of the invention, strontium may be incorporated into an aragonite lattice, and make up 10,000 ppm or less of the aragonite lattice, ranging in certain embodiments from 3 to 10,000 ppm, such as from 5 to 5000 ppm, including 5 to 1000 ppm, for example, 5 to 500 ppm or 5 to 100 ppm. Source identifiers may vary depending upon the particular source of divalent cations (e.g., saltwater) employed to produce compositions of the invention. In some embodiments, owing at least in part to die source of divalent cations, the calcium carbonate content compositions of the invention (e.g., precipitation material) may be 25% w/w or higher, such as 40% w/w or higher, including 50% w/w or higher, for example, 60% w/w or higher. Such compositions have, in some embodiments, a calcium:magnesium ratio that is influenced by, and therefore reflects, the source of divalent cations from which the composition was produced. In some embodiments, the calcium:magnesium molar ratio ranges from 10:1 to 1:5 Ca:Mg, such as 5:1 to 1:3 Ca:Mg. In some embodiments, the composition is characterized by having a source identifying carbonate:hydroxide compound ratio, wherein this ratio ranges from, for example, 100 to 1, 10 to 1, or 1 to 1.

The aqueous solution of divalent cations may comprise divalent cations derived from freshwater, brackish water, seawater, or brine (e.g., naturally occurring brines or anthropogenic brines such as geothermal plant wastewaters, desalination plant waste waters), as well as other aqueous solutions having a salinity that is greater than that of freshwater, any of which may be naturally occurring or anthropogenic. For convenience in describing the invention, freshwater may be considered to have a salinity of less than 0.5 ppt (parts per thousand). Brackish water may comprise more salt than freshwater, but not as much as salt as seawater. Brackish water may be considered to have a salinity ranging from about 0.5 to about 35 ppt. Seawater may be water from a sea, an ocean, or any other body of water that has a salinity ranging from about 35 to about 50 ppt. Brine may have a salinity that is about 50 ppt or greater. As such, brine may be water saturated or nearly saturated with salt. In some embodiments, the water source from which divalent cations are derived is a mineral rich (e.g., calcium-rich and/or magnesium-rich) freshwater source. In some embodiments, the water source from which divalent cations are derived is a naturally occurring saltwater source selected from a sea, an ocean, a lake, a swamp, an estuary, a lagoon, a surface brine, a deep brine, an alkaline lake, an inland sea, or the like. In some embodiments, the water source from which divalent cations are derived is a surface brine. In some embodiments, the water source from which divalent cations are derived is a subsurface brine. In some embodiments, the water source from which divalent cations are derived is a deep brine. In some embodiments, the water source from which divalent cations are derived is a Ca—Mg—Na—(K)—Cl; Na—(Ca)—SO₄—Cl; Mg—Na—(Ca)—SO₄—Cl; Na—CO₃—Cl; or Na—CO₃—SO₄—Cl brine. In some embodiments, the water source from which divalent cation are derived is an anthropogenic brine selected from a geothermal plant wastewater or a desalination wastewater.

Freshwater is often a convenient source of divalent cations (e.g., cations of alkaline earth metals such as Ca²⁺ and Mg²⁺). Any of a number of suitable freshwater sources may be used, including freshwater sources ranging from sources relatively free of minerals to sources relatively rich in minerals. Mineral-rich freshwater sources may be naturally occurring, including any of a number of hard water sources, lakes, or inland seas. Some mineral-rich freshwater sources such as alkaline lakes or inland seas (e.g., Lake Van in Turkey) also provide a source of pH-modifying agents. Mineral-rich freshwater sources may also be anthropogenic. For example, a mineral-poor (soft) water may be contacted with a source of divalent cations such as alkaline earth metal cations (e.g., Ca²⁺, Mg²⁺, etc.) to produce a mineral-rich water that is suitable for methods and systems described herein. Divalent cations or precursors thereof (e.g. salts, minerals) may be added to freshwater (or any other type of water described herein) using any convenient protocol (e.g., addition of solids, suspensions, or solutions). In some embodiments, divalent cations selected from Ca²⁺ and Mg²⁺ are added to freshwater. In some embodiments, monovalent cations selected from Na and K⁺ are added to freshwater. In some embodiments, freshwater comprising Ca²⁺ is combined with material comprising metal silicates, ash (e.g., fly ash, bottom ash, boiler slag), or products or processed forms thereof, including combinations of the foregoing, yielding a solution comprising calcium and magnesium cations.

As such, some methods include preparing a source of divalent cations by adding one or more divalent cations (e.g., Ca²⁺, Mg²⁺, combinations thereof, etc.) to a source of water. Sources of magnesium cations include, but are not limited, magnesium hydroxides, magnesium oxides, etc. Sources of calcium cations include, but are not limited to, calcium hydroxides, calcium oxides, etc. Both naturally occurring and anthropogenic sources of such cations may be employed. Naturally occurring sources of such cations include, but are not limited to mafic minerals (e.g., olivine, serpentine, periodotite, talc, etc.) and the like. Addition of supplementary magnesium cations to the source water (e.g., seawater) prior to producing compositions of the invention increases yields (e.g., yield of precipitation material) as well as affects the composition of such compositions (e.g., precipitation material), providing a means for increasing CO₂ sequestration by utilizing minerals such as, but not limited to, olivine, serpentine, and Mg(OH)₂ (brucite). The particular cation (e.g., Ca²⁺, Mg²⁺, combinations thereof, etc.) source may be naturally occurring or anthropogenic, and may be pure with respect to the mineral or impure (e.g., a composition made up of the mineral of interest and other minerals and components).

Methods of the invention include adding a magnesium cation source to an initial water in a manner sufficient to produce a magnesium to calcium ratio in the water of 3 or higher, e.g., 4 or higher, such as 5 or higher, for example 6 or higher, including 7 or higher. In certain embodiments, the desired magnesium to calcium cation ratio ranges from 3 to 10, such as 4 to 8. Any convenient magnesium cation source may be added to the water to provide the desired magnesium to calcium cation ratio, where specific magnesium cation sources of interest include, but are not limited to, Mg(OH)₂, serpentine, olivine, mafic minerals, and ultramafic minerals. The amount of magnesium cation source that is added to the water may vary, e.g., depending upon the specific magnesium cation source and the initial water from which the CO₂-charged water is produced. In certain embodiments, the amount of magnesium cation that is added to the water ranges from 0.01 to 100.0 grams/liter, such as from 1 to 100 grams/liter of water, including from 5 to 100 grams/liter of water, for example from 5 to 80 grams/liter of water, including from 5 to 50 grams/liter of water. In certain embodiments, the amount of magnesium cation added to the water is sufficient to produce water with a hardness reading of 0.06 grams/liter or more, such as 0.08 grams/liter or more, including 0.1 grams/liter or more as determined a Metrohm Titrator (Metrohm AG, Switzerland) according to manufacturer's instructions. The magnesium cation source may be combined with the water using any convenient protocol, e.g. with agitation, mixing, etc.

In embodiments where a source of magnesium, calcium, or a combination of magnesium and calcium is added to the water, the source may be in solid form e.g., in the form of large, hard, and often-crystalline particles or agglomerations of particles that are difficult to get into solution. For example, Mg(OH)₂ as brucite can be in such a form, as are many minerals useful in embodiments of the invention, such as serpentine, olivine, and other magnesium silicate minerals, as well as cement waste and the like. Any suitable method may be used to introduce divalent cations such as magnesium cations from such sources into aqueous solution in a form suitable for reaction with carbonate to form carbonates of divalent cations. Increasing surface area by reducing particle size is one such method, which can be done by means well known in the art such as ball grinding and jet milling. Jet milling has the further advantage of destroying much of the crystal structure of the substance, enhancing solubility. Also of interest is sonochemistry, where intense sonication may be employed to increase reaction rates by a desired amount, e.g., 106 times or more. The particles, with or without size reduction, may be exposed to conditions which promote aqueous solution, such as exposure to an acid such as HCl, H₂SO₄, or the like; a weak acid or a base may also be used in some embodiments. See, e.g., U.S. Patent Application Publication Nos. 2005/0022847; 2004/0213705; 2005/0018910; 2008/0031801; and 2007/0217981; European Patent Application Nos. EP1379469 and EP1554031; and International Patent Application Publication Nos. WO 07/016,271 and WO 08/061,305, each of which is incorporated herein by reference in its entirety.

In some embodiments the methods and systems of the invention utilize serpentine as a mineral source. Serpentine is an abundant mineral that occurs naturally and may be generally described by the formula of X₂₋₃Si₂O₅(OH)₄, wherein X is selected from the following: Mg, Ca, Fe²⁺, Fe³⁺, Ni, Al, Zn, and Mn, the serpentine material being a heterogeneous mixture consisting primarily of magnesium hydroxide and silica. In some embodiments of the invention, serpentine is used not only as a source of magnesium, but also as a source of hydroxide. Thus in some embodiments of the invention, hydroxide is provided for removal of protons from water and/or adjustment of pH by dissolving serpentine; in these embodiments an acid dissolution is not ideal to accelerate dissolution, and other means are used, such as jet milling and/or sonication. It will be appreciated that in a batch or continuous process, the length of time to dissolve the serpentine or other mineral is not critical, as once the process is started at the desired scale, and sufficient time has passed for appropriate levels of dissolution, a continuous stream of dissolved material may be maintained indefinitely. Thus, even if dissolution to the desired level takes days, weeks, months, or even years, once the process has reached the first time point at which desired dissolution has occurred, it may be maintained indefinitely. Prior to the time point at which desired dissolution has occurred, other processes may be used to provide some or all of the magnesium and/or hydroxide to the process. Serpentine is also a source of iron, which is a useful component of precipitates that are used for, e.g., cements, where iron components are often desired.

Other examples of silicate-based minerals useful in the invention include, but are not limited to olivine, a natural magnesium-iron silicate ((Mg, Fe)₂SiO₄), which can also be generally described by the formula X₂(SiO₄)ₙ, wherein X is selected from Mg, Ca, Fe²⁺, Fe³⁺, Ni, Al, Zn, and Mn, and n=2 or 3; and a calcium silicate, such as wollastonite. The minerals may be used individually or in combination with each other as described in U.S. Patent Application Publication No. 2009/0301352, published 10 Dec. 2009, which is incorporated herein by reference in its entirety. Additionally, the materials may be found in nature or may be manufactured. Examples of industrial by-products include but are not limited to waste cement, calcium-rich fly ash, and cement kiln dust (CKD) as described in U.S. Patent Application Publication No. 2010/0000444, published 7 Jan. 2010, which is incorporated herein by reference in its entirety.

In some embodiments, an aqueous solution of divalent cations may be obtained from an industrial plant that is also providing a waste gas stream (e.g., combustion gas stream). For example, in water-cooled industrial plants, such as seawater-cooled industrial plants, water that has been used by an industrial plant for cooling may then be used as water for producing precipitation material. If desired, the water may be cooled prior to entering a precipitation system of the invention. Such approaches may be employed, for example, with once-through cooling systems. For example, a city or agricultural water supply may be employed as a once-through cooling system for an industrial plant. Water from the industrial plant may then be employed for producing precipitation material, wherein output water has a reduced hardness and greater purity.

The aqueous solution of divalent cations may further provide proton-removing agents, which may be expressed as alkalinity or the ability of the divalent cation-containing solution to neutralize acids to the equivalence point of carbonate or bicarbonate. Alkalinity (A_{T}) may be expressed by the following equation

A_{T}=[HCO₃⁻]_{T}+2[CO₃²⁻]_{T}+[B(OH)₄⁻]_{T}[OH⁻]_{T}+2[PO₄³⁻]_{T}+[HPO₄²⁻]_{T}+[SiO(OH)₃⁻]_{T}−[H⁺]_{sws}−[HSO₄⁻],

wherein “T” indicates the total concentration of the species in the solution as measured. Other species, depending on the source, may contribute to alkalinity as well. The total concentration of the species in solution is in opposition to the free concentration, which takes into account the significant amount of ion pair interactions that occur, for example, in seawater. In accordance with the equation, the aqueous source of divalent cations may have various concentrations of bicarbonate, carbonate, borate, hydroxide, phosphate, biphosphate, and/or silicate, which may contribute to the alkalinity of the aqueous source of divalent cations. Any type of alkalinity is suitable for the invention. For example, in some embodiments, a source of divalent cations high in borate alkalinity is suitable for the invention. In such embodiments, the concentration borate may exceed the concentration of any other species in solution including, for example, carbonate and/or bicarbonate In some embodiments, the source of divalent cations has at least 10, 100, 500, 1000, 1500, 3000, 5000, or more than 5000 mEq of alkalinity. For example, in some embodiments, the source of divalent cations has between 500 to 1000 mEq of alkalinity.

In some methods of the invention, the water (such as salt water or mineral rich water) is not contacted with a source of CO₂ prior to subjecting the water to precipitation conditions. In these methods, the water will have an amount of CO₂ associated with it, e.g., in the form of bicarbonate ion, which has been obtained from the environment to which the water has been exposed prior to practice of the method. Subjecting the water to precipitate conditions of the invention results in conversion of this CO₂ into a storage-stable precipitate, and therefore sequestration of the CO₂. When the water subject to processes of the invention is again exposed to its natural environment, such as the atmosphere, more CO₂ from the atmosphere will be taken up by the water resulting in a net removal of CO₂ from the atmosphere and incorporation of a corresponding amount of CO₂ into a storage-stable product, where the mineral rich freshwater source may be contacted with a source of CO₂, e.g., as described in greater detail below. Embodiments of these methods may be viewed as methods of sequestering CO₂ gas directly from the Earth's atmosphere. Embodiments of the methods are efficient for the removal of CO₂ from the Earth's atmosphere. For example, embodiments of the methods are configured to remove CO₂ from saltwater at a rate of 0.025 M or more, such as 0.05 M or more, including 0.1 M or more per gallon of saltwater.

In some embodiments, the invention provides for contacting a volume of an aqueous solution with a source of carbon dioxide to produce a composition comprising carbonates, bicarbonates, or carbonates and bicarbonates, wherein the composition is a solution or slurry. In some embodiments, the solution is a slurry comprising a precipitation material comprising carbonates, bicarbonates, or carbonates and bicarbonates. In some embodiments, the precipitation material is produced by subjecting the volume of the aqueous solution to precipitation conditions before, during, or after contact with the source of carbon dioxide. There may be sufficient carbon dioxide in the aqueous solution to produce significant amounts of carbonates, bicarbonates, or carbonates and bicarbonates (e.g., from brine or seawater); however, additional carbon dioxide is generally used. The source of CO₂ may be any convenient CO₂ source. The source of CO₂ may be a gas, a liquid, a solid (e.g., dry ice), a supercritical fluid, or CO₂ dissolved in a liquid. In some embodiments, the CO₂ source is a gaseous CO₂ source such as a waste gas stream. The gaseous CO₂ source may be substantially pure CO₂ or, as described in more detail below, comprise one or more components in addition to CO₂, wherein the one or more components comprise one or more additional gases such as SOx (e.g., SO, SO₂, SO₃), NOx (e.g., NO, NO₂), etc., non-gaseous components, or a combination thereof. The waste streams may further comprise VOC (volatile organic compounds), metals (e.g., mercury, arsenic, cadmium, selenium), and particulate matter comprising particles of solid (e.g., fly ash) or liquid suspended in the gas. In some embodiments, the gaseous CO₂ source may be a waste gas stream (e.g., exhaust) produced by an active process of an industrial plant. The nature of the industrial plant may vary, the industrial plants including, but not limited to, power plants, chemical processing plants, mechanical processing plants, refineries, cement plants, steel plants, and other industrial plants that produce CO₂ as a by-product of fuel combustion or another processing step (e.g., calcination by a cement plant). In some embodiments, for example, the gaseous CO₂ source may be flue gas from coal-fired power plant.

Waste gas streams comprising CO₂ include both reducing condition streams (e.g., syngas, shifted syngas, natural gas, hydrogen, and the like) and oxidizing condition streams (e.g., flue gas resulting from combustion). Particular waste gas streams that may be convenient for the invention include oxygen-containing flue gas resulting from combustion (e.g., from coal or another carbon-based fuel with little or no pretreatment of the flue gas), turbo charged boiler product gas, coal gasification product gas, pre-combustion synthesis gas (e.g., such as that formed during coal gasification in power generating plants), shifted coal gasification product gas, anaerobic digester product gas, wellhead natural gas stream, reformed natural gas or methane hydrates, and the like. Combustion gas from any convenient source may be used in methods and systems of the invention. In some embodiments, a combustion gas from a post-combustion effluent stack of an industrial plant such as a power plant, cement plant, and coal processing plant is used.

Thus, waste gas streams may be produced from a variety of different types of industrial plants. Suitable waste gas streams for the invention include waste gas streams produced by industrial plants that combust fossil fuels (e.g., coal, oil, natural gas, propane, diesel), biomass, and/or anthropogenic fuel products of naturally occurring organic fuel deposits (e.g., tar sands, heavy oil, oil shale, etc.). In some embodiments, a waste gas stream suitable for systems and methods of the invention is sourced from a coal-fired power plant, such as a pulverized coal power plant, a supercritical coal power plant, a mass burn coal power plant, a fluidized bed coal power plant. In some embodiments, the waste gas stream is sourced from gas or oil-fired boiler and steam turbine power plants, gas or oil-fired boiler simple cycle gas turbine power plants, or gas or oil-fired boiler combined cycle gas turbine power plants. In some embodiments, waste gas streams produced by power plants that combust syngas (i.e., gas that is produced by the gasification of organic matter, for example, coal, biomass, etc.) are used. In some embodiments, waste gas streams from integrated gasification combined cycle (IGCC) plants are used. In some embodiments, waste gas streams produced by heat recovery steam generator (HRSG) plants are used in accordance with systems and methods of the invention.

Waste gas streams comprising CO₂ may also result from other industrial processing. Waste gas streams produced by cement plants are also suitable for systems and methods of the invention. Cement plant waste gas streams include waste gas streams from both wet process and dry process plants, which plants may employ shaft kilns or rotary kilns, and may include pre-calciminers. These industrial plants may each burn a single fuel, or may burn two or more fuels sequentially or simultaneously. Other industrial plants such as smelters and refineries are also useful sources of waste gas streams that include carbon dioxide.

The gaseous waste stream may be provided by the industrial plant to the CO₂-processing system of the invention in any convenient manner that conveys the gaseous waste stream. In some embodiments, the waste gas stream is provided with a gas conveyor (e.g., a duct, pipe, etc.) that runs from a flue or analogous structure of the industrial plant (e.g., a flue or smokestack of the industrial plant) to one or more locations of the CO₂-processing system. In such embodiments, a line (e.g., a duct, pipe, etc.) may be connected to the flue of the industrial plant such that gas leaving through the flue is conveyed to the appropriate location(s) of the CO₂-processing system (e.g., processor or a component thereof, such as a gas-liquid contactor or gas-liquid-solid contactor). Depending upon the particular configuration of the CO₂-processing system, the location of the gas conveyor on the industrial plant may vary, for example, to provide a waste gas stream of a desired temperature. As such, in some embodiments, where a gaseous waste stream having a temperature ranging for 0° C. to 2000° C., such as 0° C. to 1800° C., including 60° C. to 700° C., for example, 100° C. to 400° C. is desired, the flue gas may be obtained at the exit point of the boiler, gas turbine, kiln, or at any point of the power plant that provides the desired temperature. The gas conveyor may be configured to maintain flue gas at a temperature above the dew point (e.g., 125° C.) in order to avoid condensation and related complications. Other steps may be taken to reduce the adverse impact of condensation and other deleterious effects, such as employing ducting that is stainless steel or fluorocarbon (such as poly(tetrafluoroethylene)) lined such the duct does not rapidly deteriorate.

Carbon dioxide may be the primary non-air derived component in waste gas streams. In some embodiments, waste gas streams may comprise carbon dioxide in amounts ranging from 200 ppm to 1,000,000 ppm, such as 1000 ppm to 200,000 ppm, including 2000 ppm to 200,000 ppm, for example, 2000 ppm to 180,000 ppm or 2000 ppm to 130,000 ppm. In some embodiments, waste gas streams may comprise carbon dioxide in amounts ranging from 350 ppm to 400,000 ppm. Such amounts of carbon dioxide may be considered time-averaged amounts. For example, in some embodiments, waste gas streams may comprise carbon dioxide in an amount ranging from 40,000 ppm (4%) to 100,000 ppm (10%) depending on the waste gas stream (e.g., CO₂ from natural gas-fired power plants, furnaces, small boilers, etc.). For example, in some embodiments, waste gas streams may comprise carbon dioxide in an amount ranging from 100,000 ppm (10%) to 150,000 ppm (15%) depending on the waste gas stream (e.g., CO₂ from coal-fired power plants, oil generators, diesel generators, etc.). For example, in some embodiments, waste gas streams may comprise carbon dioxide in an amount ranging from 200,000 ppm (20%) to 400,000 ppm (40%) depending on the waste gas stream (e.g., CO₂ from cement plant calcination, chemical plants, etc.). For example, in some embodiments, waste gas streams may comprise carbon dioxide in an amount ranging from 900,000 ppm (90%) to 1,000,000 ppm (100%) depending on the waste gas stream (e.g., CO₂ from ethanol fermenters, CO₂ from steam reforming at refineries, ammonia plants, substitute natural gas (SNG) plants, CO₂ separated from sour gases, etc.). The concentration of CO₂ in a waste gas stream may be decreased by 10% or more, 20% or more, 30% or more, 40% or more, 50% or more, 60% or more, 70% or more, 80% or more, 90% or more, 95% or more, 99% or more, 99.9% or more, or 99.99%. In other words, at least 10%, 20%, 30%, 40%, 50%, 60%, 70%, 80%, 90%, 95%, 99%, 99.9%, or 99.99% of the carbon dioxide may be removed from the waste gas stream. In some embodiments, the methods and systems of the invention are capable of absorbing 5% or more, 10% or more, 15% or more, 20% or more, 25% or more, 30% or more, 35% or more, 40% or more, 45% or more, 50% or more, 55% or more, 60% or more, 65% or more, 70% or more, 75% or more, 80% or more, 85% or more, 90% or more, 95% or more, or 99% or more of the CO₂ in a gaseous source of CO₂, such as an industrial source of CO₂, e.g., flue gas from a power plant or waste gas from a cement plant. In some embodiments, the methods and systems of the invention are capable of absorbing 50% or more of the CO₂ in a gaseous source of CO₂, such as an industrial source of CO₂, e.g., flue gas from a power plant or waste gas from a cement plant.

A portion of the waste gas stream (i.e., not the entire gaseous waste stream) from an industrial plant may be used to produce compositions comprising carbonates, bicarbonates, or carbonates and bicarbonates. In these embodiments, the portion of the waste gas stream that is employed in producing compositions may be 75% or less, such as 60% or less, and including 50% and less of the waste gas stream. In yet other embodiments, most (e.g., 80% or more) of the entire waste gas stream produced by the industrial plant is employed in producing compositions. In these embodiments, 80% or more, such as 90% or more, including 95% or more, up to 100% of the waste gas stream (e.g., flue gas) generated by the source may be employed for producing compositions of the invention.

In some embodiments of the invention substantially 100% of the CO₂ contained in a flue gas, or a portion of the flue gas, from a power plant may be sequestered as a composition of the invention (e.g., precipitation material comprising one or more stable or metastable minerals). Such sequestration may be done in a single step or in multiple steps, and may further involve other processes for sequestering CO₂ (e.g., as the concentration of CO₂ is decreased in the flue gas, more energy-intensive processes that be prohibitive in energy consumption for removing all of the original CO₂ in the gas may become practical in removing the final CO₂ in the gas). Thus, in some embodiments, the gas entering the power plant (ordinary atmospheric air) may contain a concentration of CO₂ that is greater than the concentration of CO₂ in the flue gas exiting the plant, which flue gas has been treated by the processes and systems of the invention. Hence, in some embodiments, the methods and systems of the invention encompass a method comprising supplying a gas (e.g., atmospheric air) to a power plant, wherein the gas comprises CO₂; treating the gas in the power plant (e.g., by combustion of fossil fuel to consume O₂) to produce CO₂, then treating exhaust gas to remove CO₂; and releasing the gas from the power plant, wherein the gas released from the power plant has a lower CO₂; content than the gas supplied to the power plant. In some embodiments, the gas released from the power plant contains at least 10% less CO₂, or at least 20% less CO₂, or at least 30% less CO₂, or at least 40% less CO₂, or at least 50% less CO₂, or at least 60% less CO₂, or at least 70% less CO₂, or at least 80% less CO₂, or at least 90% less CO₂, or at least 95% less CO₂, or at least 99% less CO₂, or at least 99.5% less CO₂, or at least 99.9% less CO₂, than the gas entering the power plant. In some embodiments, the gas entering the power plant is atmospheric air and the gas exiting the power plant is treated flue gas.

Although a waste gas stream from an industrial plant offers a relatively concentrated source of CO₂ and/or additional components resulting from combustion of fossil fuels, methods and systems of the invention are also applicable to removing combustion gas components from less concentrated sources (e.g., atmospheric air), which contains a much lower concentration of pollutants than, for example, flue gas. Thus, in some embodiments, methods and systems encompass decreasing the concentration of CO₂ and/or additional components in atmospheric air by producing compositions of the invention. As with waste gas streams, the concentration of CO₂ in a portion of atmospheric air may be decreased by 10% or more, 20% or more, 30% or more, 40% or more, 50% or more, 60% or more, 70% or more, 80% or more, 90% or more, 95% or more, 99% or more, 99.9% or more, or 99.99%. Such decreases in CO₂ may be accomplished with yields as described herein, or with higher or lower yields, and may be accomplished in one processing step or in a series of processing steps.

The pH of the water that is contacted with the CO₂ source may vary. In some instances, the pH of the water that is contacted with the CO₂ source is acidic, such that the pH is lower than 7, such as 6.5 or lower, 6 or lower, 5.5 or lower, 5 or lower, 4.5 or lower, or 4 or lower. In yet other embodiments, the pH of the water may be neutral to slightly basic, by which is meant that the pH of the water may range from pH 7 to pH 9, such as pH 7 to pH 8.5, including pH 7.5 to pH 8.5.

In some instances, the water, such as alkaline earth metal ion-containing water (including alkaline solutions or natural saline alkaline waters), is basic when contacted with the CO₂ source, such as a carbon dioxide containing gaseous stream. In these instances, while being basic the pH of the water is generally insufficient to cause precipitation of the storage-stable carbon dioxide sequestering product. As such, the pH may be 9.5 or lower, such as 9.3 or lower, including 9 or lower.

In some instances, the pH as described above may be maintained at a substantially constant value during contact with the carbon dioxide containing gaseous stream, or the pH may be manipulated to maximize CO₂ absorption while minimizing base consumption or other means of removing protons, such as by starting at a certain pH and gradually causing the pH to rise as CO₂ continues to be introduced. In embodiments where the pH is maintained substantially constant, where by “substantially constant” is meant that the magnitude of change in pH during some phase of contact with the carbon dioxide source is 0.75 or less, such as 0.50 or less, including 0.25 or less, such as 0.10 or less. The pH may be maintained at substantially constant value, or manipulated to maximize CO₂ absorption but prevent hydroxide precipitation without precipitation, using any convenient approach. In some instances, the pH is maintained at substantially constant value, or manipulated to maximize CO₂ absorption without precipitation, during CO₂ charging of the water by adding a sufficient amount of base to the water in a manner that provides the substantially constant pH. Any convenient base or combination of bases may be adding, including but not limited to oxides and hydroxides, such as magnesium hydroxide, where further examples of suitable bases are reviewed below. In yet other instances, the pH may be maintained at substantially constant value, or manipulated to maximize CO₂ absorption, through use of electrochemical protocols, such as the protocols described below, so that the pH of the water is electrochemically maintained at the substantially constant value. Surprisingly, as shown in Example IV, it has been found that it is possible to absorb, e.g., more than 50% of the CO₂ contained in a gas comprising 20% CO₂ through simple sparging of seawater with addition of base (removal of protons).

In some embodiments, the invention provides for contacting a volume of an aqueous solution with a source of carbon dioxide to produce a composition comprising carbonates, bicarbonates, or carbonates and bicarbonates, wherein the composition is a solution or slurry. Contacting the aqueous solution with the source of carbon dioxide facilitates dissolution of CO₂ into the aqueous solution producing carbonic acid, a species in equilibrium with both bicarbonate and carbonate. In order to produce compositions of the invention (e.g., precipitation material comprising carbonates, bicarbonates, or carbonates and bicarbonates), protons are removed from various species (e.g. carbonic acid, bicarbonate, hydronium, etc.) in the aqueous solution to shift the equilibrium toward bicarbonate, carbonate, or somewhere in between. As protons are removed, more CO₂ goes into solution. In some embodiments, proton-removing agents and/or methods are used while contacting an aqueous solution with CO₂ to increase CO₂ absorption in one phase of the reaction, wherein the pH may remain constant, increase, or even decrease, followed by a rapid removal of protons (e.g., by addition of a base), which, In some embodiments, may cause rapid precipitation of precipitation material. Protons may be removed from the various species (e.g. carbonic acid, bicarbonate, hydronium, etc.) by any convenient approach, including, but not limited to use of naturally occurring proton-removing agents, use of microorganisms and fungi, use of synthetic chemical proton-removing agents, recovery of waste streams from industrial processes, and using electrochemical means.

Naturally occurring proton-removing agents encompass any proton-removing agents found in the wider environment that may create or have a basic local environment. Some embodiments provide for naturally occurring proton-removing agents including minerals that create basic environments upon addition to solution. Such minerals include, but are not limited to, lime (CaO); periclase (MgO); iron hydroxide minerals (e.g., goethite and limonite); and volcanic ash. Methods for digestion of such minerals and rocks comprising such minerals are described in U.S. patent application Ser. No. 12/501,217, filed 10 Jul. 2009, which is incorporated herein by reference in its entirety. Some embodiments provide for using naturally occurring bodies of water as a source proton-removing agents, which bodies of water comprise carbonate, borate, sulfate, or nitrate alkalinity, or some combination thereof. Any alkaline brine (e.g., surface brine, subsurface brine, a deep brine, etc.) is suitable for use in the invention. In some embodiments, a surface brine comprising carbonate alkalinity provides a source of proton-removing agents. In some embodiments, a surface brine comprising borate alkalinity provides a source of proton-removing agents. In some embodiments, a subsurface brine comprising carbonate alkalinity provides a source of proton-removing agents. In some embodiments, a subsurface brine comprising borate alkalinity provides a source of proton-removing agents. In some embodiments, a deep brine comprising carbonate alkalinity provides a source of proton-removing agents. In some embodiments, a deep brine comprising borate alkalinity provides a source of proton-removing agents. Examples of naturally alkaline bodies of water include, but are not limited to surface water sources (e.g. alkaline lakes such as Mono Lake in California) and ground water sources (e.g. basic aquifers such as the deep geologic alkaline aquifers located at Searles Lake in California). Other embodiments provide for use of deposits from dried alkaline bodies of water such as the crust along Lake Natron in Africa's Great Rift Valley. For additional sources of brines and evaporites, see U.S. Provisional Patent Application No. 61/264,564, filed 25 Nov. 2009, which is incorporated herein by reference in its entirety. In some embodiments, organisms that excrete basic molecules or solutions in their normal metabolism are used as proton-removing agents. Examples of such organisms are fungi that produce alkaline protease (e.g., the deep-sea fungus Aspergillus ustus with an optimal pH of 9) and bacteria that create alkaline molecules (e.g., cyanobacteria such as Lyngbya sp. from the Atlin wetland in British Columbia, which increases pH from a byproduct of photosynthesis). In some embodiments, organisms are used to produce proton-removing agents, wherein the organisms (e.g., Bacillus pasteurii, which hydrolyzes urea to ammonia) metabolize a contaminant (e.g. urea) to produce proton-removing agents or solutions comprising proton-removing agents (e.g., ammonia, ammonium hydroxide). In some embodiments, organisms are cultured separately from the precipitation reaction mixture, wherein proton-removing agents or solution comprising proton-removing agents are used for addition to the precipitation reaction mixture. In some embodiments, naturally occurring or manufactured enzymes are used in combination with proton-removing agents to invoke precipitation of precipitation material. Carbonic anhydrase, which is an enzyme produced by plants and animals, accelerates transformation of carbonic acid to bicarbonate in aqueous solution. As such, carbonic anhydrase may be used to enhance dissolution of CO₂ and accelerate precipitation of precipitation material, as described in further detail herein.

Chemical agents for effecting proton removal generally refer to synthetic chemical agents that are produced in large quantities and are commercially available. For example, chemical agents for removing protons include, but are not limited to, hydroxides, organic bases, super bases, oxides, ammonia, and carbonates. Hydroxides include chemical species that provide hydroxide anions in solution, including, for example, sodium hydroxide (NaOH), potassium hydroxide (KOH), calcium hydroxide (Ca(OH)₂), or magnesium hydroxide (Mg(OH)₂). Organic bases are carbon-containing molecules that are generally nitrogenous bases including primary amines such as methyl amine, secondary amines such as diisopropylamine, tertiary amines such as diisopropylethylamine, aromatic amines such as aniline, heteroaromatics such as pyridine, imidazole, and benzimidazole, and various forms thereof. In some embodiments, an organic base selected from pyridine, methylamine, imidazole, benzimidazole, histidine, and a phosphazene is used to remove protons from various species (e.g., carbonic acid, bicarbonate, hydronium, etc.) for preparation of compositions of the invention. In some embodiments, ammonia is used to raise pH to a level sufficient for preparation of compositions of the invention. Super bases suitable for use as proton-removing agents include sodium ethoxide, sodium amide (NaNH₂), sodium hydride (NaH), butyl lithium, lithium diisopropylamide, lithium diethylamide, and lithium bis(trimethylsilyl)amide. Oxides including, for example, calcium oxide (CaO), magnesium oxide (MgO), strontium oxide (SrO), beryllium oxide (BeO), and barium oxide (BaO) are also suitable proton-removing agents that may be used. Carbonates for use in the invention include, but are not limited to, sodium carbonate.

In addition to comprising cations (e.g., Ca²⁺, Mg²⁺, etc.) and other suitable metal forms suitable for use in the invention, waste streams from various industrial processes (i.e., industrial waste streams) may provide proton-removing agents. Such waste streams include, but are not limited to, mining wastes; ash (e.g., coal ash such as fly ash, bottom ash, boiler slag); slag (e.g. iron slag, phosphorous slag); cement kiln waste (e.g., cement kiln dust (CKD)); oil refinery/petrochemical refinery waste (e.g. oil field and methane seam brines); coal seam wastes (e.g. gas production brines and coal seam brine); paper processing waste; water softening waste brine (e.g., ion exchange effluent); silicon processing wastes; agricultural waste; metal finishing waste; high pH textile waste; and caustic sludge. Mining wastes include any wastes from the extraction of metal or another precious or useful mineral from the earth. In some embodiments, wastes from mining are used to modify pH, wherein the waste is selected from red mud from the Bayer aluminum extraction process; waste from magnesium extraction from seawater (e.g., Mg(OH)₂ such as that found in Moss Landing, Calif.); and wastes from mining processes involving leaching. For example, red mud may be used to modify pH as described in U.S. Provisional Patent Application No. 61/161,369, filed 18 Mar. 2009, which is incorporated herein by reference in its entirety. Red mud, depending on processing conditions and source material (e.g., bauxite) might comprise Fe₂O₃, Al₂O₃, SiO₂, Na₂O, CaO, TiO₂, K₂O, MgO, CO₂, S₂O, MnO₂, P₂O₅, each of which species are loosely listed in order from most abundant to least abundant, and each of which species are expressed as oxides for convenience. Coal ash, cement kiln dust, and slag, collectively waste sources of metal oxides, further described in U.S. patent application Ser. No. 12/486,692, filed 17 Jun. 2009, the disclosure of which is incorporated herein in its entirety, may be used in alone or in combination with other proton-removing agents to provide proton-removing agents for the invention. Agricultural waste, either through animal waste or excessive fertilizer use, may contain potassium hydroxide (KOH) or ammonia (NH₃) or both. As such, agricultural waste may be used in some embodiments of the invention as a proton-removing agent. This agricultural waste is often collected in ponds, but it may also percolate down into aquifers, where it can be accessed and used.

In some embodiments of the invention, ash may be employed for proton-removing agents, e.g., to increase the pH of CO₂-charged water. The ash may be used as a as the sole pH modifier or in conjunction with one or more additional pH modifiers. Of interest in certain embodiments is use of a coal ash as the ash. The coal ash as employed in this invention refers to the residue produced in power plant boilers or coal burning furnaces, for example, chain grate boilers, cyclone boilers and fluidized bed boilers, from burning pulverized anthracite, lignite, bituminous or sub-bituminous coal. Such coal ash includes fly ash which is the finely divided coal ash carried from the furnace by exhaust or flue gases; and bottom ash which collects at the base of the furnace as agglomerates.

Fly ashes are generally highly heterogeneous, and include of a mixture of glassy particles with various identifiable crystalline phases such as quartz, mullite, and various iron oxides. Fly ashes of interest include Type F and Type C fly ash. The Type F and Type C fly ashes referred to above are defined by CSA Standard A23.5 and ASTM C618. The chief difference between these classes is the amount of calcium, silica, alumina, and iron content in the ash. The chemical properties of the fly ash are largely influenced by the chemical content of the coal burned (i.e., anthracite, bituminous, and lignite). Fly ashes of interest include substantial amounts of silica (silicon dioxide, SiO₂) (both amorphous and crystalline) and lime (calcium oxide, CaO, magnesium oxide, MgO).

The burning of harder, older anthracite and bituminous coal typically produces Class F fly ash. Class F fly ash is pozzolanic in nature, and contains less than 10% lime (CaO). Fly ash produced from the burning of younger lignite or subbituminous coal, in addition to having pozzolanic properties, also has some self-cementing properties. In the presence of water, Class C fly ash will harden and gain strength over time. Class C fly ash generally contains more than 20% lime (CaO). Alkali and sulfate (SO₄) contents are generally higher in Class C fly ashes.

Fly ash material solidifies while suspended in exhaust gases and is collected using various approaches, e.g., by electrostatic precipitators or filter bags. Since the particles solidify while suspended in the exhaust gases, fly ash particles are generally spherical in shape and range in size from 0.5 μm to 100 μm. Fly ashes of interest include those in which at least 80%, by weight comprises particles of less than 45 microns. Also of interest in certain embodiments of the invention is the use of highly alkaline fluidized bed combustor (FBC) fly ash.

Also of interest in embodiments of the invention is the use of bottom ash. Bottom ash is formed as agglomerates in coal combustion boilers from the combustion of coal. Such combustion boilers may be wet bottom boilers or dry bottom boilers. When produced in a wet or dry bottom boiler, the bottom ash is quenched in water. The quenching results in agglomerates having a size in which 90% fall within the particle size range of 0.1 mm to 20 mm, where the bottom ash agglomerates have a wide distribution of agglomerate size within this range. The main chemical components of a bottom ash are silica and alumina with lesser amounts of oxides of Fe, Ca, Mg, Mn, Na and K, as well as sulfur and carbon.

Also of interest in certain embodiments is the use of volcanic ash as the ash. Volcanic ash is made up of small tephra, i.e., bits of pulverized rock and glass created by volcanic eruptions, less than 2 millimeters (0.079 in) in diameter.

In one embodiment of the invention, cement kiln dust (CKD) is added to the reaction vessel as a means of modifying pH. The nature of the fuel from which the ash and/or CKD were produced, and the means of combustion of said fuel, will influence the chemical composition of the resultant ash and/or CKD. Thus ash and/or CKD may be used as a portion of the means for adjusting pH, or the sole means, and a variety of other components may be utilized with specific ashes and/or CKDs, based on chemical composition of the ash and/or CKD.

In embodiments of the invention, ash is added to the reaction as one source of these additional reactants, to produce carbonate mineral precipitates which contain one or more components such as amorphous silica, crystalline silica, calcium silicates, calcium alumina silicates, or any other moiety which may result from the reaction of ash in the carbonate mineral precipitation process.

The ash employed in the invention may be contacted with the water to achieve the desired pH modification using any convenient protocol, e.g., by placing an amount of ash into the reactor holding the water, where the amount of ash added is sufficient to raise the pH to the desired level, by flowing the water through an amount of the ash, e.g., in the form of a column or bed, etc.

In certain embodiments where the pH is not raised to a level of 12 or higher, the fly ash employed in the method, e.g., as described below, may not dissolve but instead will remain as a particulate composition. This un-dissolved ash may be separated from the remainder of the reaction product, e.g., filtered out, for a subsequent use. Alternatively, the water may be flowed through an amount of ash that is provided in an immobilized configuration, e.g., in a column or analogous structure, which provides for flow through of a liquid through the ash but does not allow ash solid to flow out of the structure with the liquid. This embodiment does not require separation of un-dissolved ash from the product liquid. In yet other embodiments where the pH exceeds 12, the ash dissolved and provides for pozzolanic products, e.g., as described in greater detail elsewhere.

In embodiments of the invention where ash is utilized in the precipitation process, the ash may first be removed from the flue gas by means such as electrostatic precipitation, or may be utilized directly via the flue gas. The use of ash in embodiments of the invention may provide reactants such as alumina or silica in addition to raising the pH.

In certain embodiments of the invention, slag is employed as a pH modifying agent, e.g., to increase the pH of the CO₂ charged water. The slag may be used as a as the sole pH modifier or in conjunction with one or more additional pH modifiers, e.g., ashes, etc. Slag is generated from the processing of metals, and may contain calcium and magnesium oxides as well as iron, silicon, and aluminum compounds. In certain embodiments, the use of slag as a pH modifying material provides additional benefits via the introduction of reactive silicon and alumina to the precipitated product. Slags of interest include, but are not limited to, blast furnace slag from iron smelting, slag from electric-arc or blast furnace processing of steel, copper slag, nickel slag and phosphorus slag.

Electrochemical methods provide another means to remove protons from various species in a solution, either by removing protons from solute (e.g., deprotonation of carbonic acid or bicarbonate) or from solvent (e.g., deprotonation of hydronium or water). Deprotonation of solvent may result, for example, if proton production from CO₂ dissolution matches or exceeds electrochemical proton removal from solute molecules. In some embodiments, low-voltage electrochemical methods are used to remove protons, for example, as CO₂ is dissolved in the precipitation reaction mixture or a precursor solution to the precipitation reaction mixture (i.e., a solution that may or may not contain divalent cations). In some embodiments, CO₂ dissolved in an aqueous solution that does not contain divalent cations is treated by a low-voltage electrochemical method to remove protons from carbonic acid, bicarbonate, hydronium, or any species or combination thereof resulting from the dissolution of CO₂. A low-voltage electrochemical method operates at an average voltage of 2, 1.9, 1.8, 1.7, or 1.6 V or less, such as 1.5, 1.4, 1.3, 1.2, 1.1 V or less, such as 1 V or less, such as 0.9 V or less, 0.8 V or less, 0.7 V or less, 0.6 V or less, 0.5 V or less, 0.4 V or less, 0.3 V or less, 0.2 V or less, or 0.1 V or less. Low-voltage electrochemical methods that do not generate chlorine gas are convenient for use in systems and methods of the invention. Low-voltage electrochemical methods to remove protons that do not generate oxygen gas are also convenient for use in systems and methods of the invention. In some embodiments, low-voltage methods do not generate any gas at the anode. In some embodiments, low-voltage electrochemical methods generate hydrogen gas at the cathode and transport it to the anode where the hydrogen gas is converted to protons. Electrochemical methods that do not generate hydrogen gas may also be convenient. In some instances, electrochemical methods to remove protons do not generate any gaseous by-byproduct. Electrochemical methods for effecting proton removal are further described in U.S. patent application Ser. No. 12/344,019, filed 24 Dec. 2008; U.S. patent application Ser. No. 12/375,632, filed 23 Dec. 2008; International Patent Application No. PCT/US08/088,242, filed 23 Dec. 2008; International Patent Application No. PCT/US09/32301, filed 28 Jan. 2009; and International Patent Application No. PCT/US09/48511, filed 24 Jun. 2009, each of which are incorporated herein by reference in their entirety.

Alternatively, electrochemical methods may be used to produce caustic molecules (e.g., hydroxide) through, for example, the chlor-alkali process, or modification thereof (e.g., low-voltage modification). Electrodes (i.e., cathodes and anodes) may be present in the apparatus containing the aqueous solution or waste gas-charged (e.g., CO₂-charged) solution, and a selective barrier, such as a membrane, may separate the electrodes. Electrochemical systems and methods for removing protons may produce by-products (e.g., hydrogen) that may be harvested and used for other purposes. Additional electrochemical approaches that may be used in systems and methods of the invention include, but are not limited to, those described in U.S. Provisional Patent Application No. 61/081,299, filed 16 Jul. 2008, and U.S. Provisional Patent Application No. 61/091,729, the disclosures of which are incorporated herein by reference. Combinations of the above mentioned sources of proton-removing agents and methods for effecting proton removal may be employed.

In embodiments in which an electrochemical process is used to remove protons and/or to produce base, often an acid stream, such as an HCl stream, is also generated, and this stream, alone or any other convenient source of acid, or a combination thereof, may be used to enhance dissolution of, e.g., magnesium-bearing minerals such as olivine or serpentine, or sources of calcium such as cement waste. Dissolution may be further enhanced by sonication methods, which can produce localized pockets of extreme temperature and pressure, enhancing reaction rates by one hundred to over one million-fold. Such methods are known in the art.

In some embodiments the methods of the invention allow large amounts of magnesium and, in some cases, calcium, to be added to the water used in some embodiments of the invention, increasing the amount of precipitate that may be formed per unit of water in a single precipitation step, allowing surprisingly high yields of carbonate-containing precipitate when combined with methods of dissolution of CO₂ from an industrial source in water, e.g., seawater or other saltwater source. In some embodiments, the methods of the invention include a method of removing CO₂ from a gaseous source, e.g., an industrial gaseous source of CO₂ such as flue gas from a power plant, or such as exhaust gas from a cement plant, by performing a precipitation step on water into which CO₂ has been dissolved from the gaseous source of CO₂, where the precipitation step provides precipitate in an amount of 10 g/L or more in a single precipitation step, 15 g/L or more in a single precipitation step, 20 g/L or more in a single precipitation step, 25 g/L or more in a single precipitation step, 30 g/L or more in a single precipitation step, 40 g/L or more in a single precipitation step, 50 g/L or more in a single precipitation step, 60 g/L or more in a single precipitation step, 70 g/L or more in a single precipitation step, 80 g/L or more in a single precipitation step, 90 g/L or more in a single precipitation step, 100 g/L or more in a single precipitation step, 125 g/L or more in a single precipitation step, or 150 g/L or more in a single precipitation step. In some embodiments, the precipitate comprises magnesium carbonate; in some embodiments the precipitate comprises calcium carbonate; in some embodiments, the precipitate comprises magnesium and calcium, and/or magnesium/calcium carbonates. In some embodiments the ratio of magnesium to calcium in the precipitated material produced in a single precipitation step is at least 0.5:1, or at least 1:1, or at least 2:1, or at least 3:1, or at least 4:1, or at least 5:1, or at least 6:1, or at least 7:1, or at least 8:1, or at least 9:1, or at least 10:1. In some embodiments the ratio of magnesium to calcium in the precipitated material produced in a single precipitation step is at least 2:1. In some embodiments the ratio of magnesium to calcium in the precipitated material produced in a single precipitation step is at least 4:1. In some embodiments the ratio of magnesium to calcium in the precipitated material produced in a single precipitation step is at least 6:1. In some embodiments, the precipitate contains calcium and magnesium carbonates, and contains components that allow at least a portion of the carbon in the carbonate to be traced back to a fossil fuel origin.

As reviewed above, methods of the invention include subjecting water (which may or may have been charged in a charging reactor with CO₂, as described above) to precipitation conditions sufficient to produce a storage-stable precipitated carbon dioxide sequestering product. Any convenient precipitation conditions may be employed, which conditions result in the production of the desired sequestering product.

Precipitation conditions of interest include those that modulate the physical environment of the water to produce the desired precipitate product. For example, the temperature of the water may be adjusted to suitable value for precipitation of the desired product to occur. In such embodiments, the temperature of the water may be adjusted to a value from 5° C. to 70° C., such as from 20° C. to 50° C. and including from 25° C. to 45° C. In some embodiments, the temperature of the water may be adjusted to a value between 0° C. and 30° C., such as to a value between 5° C. and 25° C. As such, while a given set of precipitation conditions may have a temperature ranging from 0° C. to 100° C., the temperature may be adjusted in certain embodiments to produce the desired precipitate. The temperature of the water may be raised using any convenient protocol. In some instances, the temperature is raised using energy generated from low or zero carbon dioxide emission sources, e.g., solar energy sources, wind energy sources, hydroelectric energy sources, geothermal energy sources, from the waste heat of the flue gas which can range up to 500° C., etc.

While the pH of the water may range from 4 to 14 during a given precipitation process, in some instances the pH is raised to alkaline levels in order to produce the desired precipitation product. In these embodiments, the pH is raised to a level sufficient to cause precipitation of the desired CO₂-sequestering product, as described above. As such, the pH may be raised to 9.5 or higher, such as 10 or higher, including 10.5 or higher. Where desired, the pH may be raised to a level that minimizes if not eliminates CO₂ production during precipitation. For example, the pH may be raised to a value of 10 or higher, such as a value of 11 or higher. In certain embodiments, the pH is raised to between 7 and 11, such as between 8 and 11, including between 9 and 11, for example between 10 and 11. In this step, the pH may be raised to and maintained at the desired alkaline level, such that the pH is maintained at a constant alkaline level, or the pH may be transitioned or cycled between two or more different alkaline levels, as desired.

The pH of the water may be raised using any convenient approach. Approaches of interest include, but are not limited to: use of a pH raising agent, electrochemical approaches, using naturally alkaline water such as from an alkaline lake, etc. In some instances, a pH-raising agent may be employed, where examples of such agents include oxides (such as calcium oxide, magnesium oxide, etc.), hydroxides (such as sodium hydroxide, potassium hydroxide, and magnesium hydroxide), carbonates (such as sodium carbonate), and the like. The amount of pH elevating agent which is added to the water will depend on the particular nature of the agent and the volume of water being modified, and will be sufficient to raise the pH of the water to the desired value.

In some embodiments, a source of an agent for removal of protons, during dissolution of CO₂ and/or during the precipitation step in which pH is raised, may be a naturally occurring source. For example, in some embodiments the agent may comprise serpentine dissolved into aqueous solution, as described above. In other embodiments, the agent may comprise a natural body of highly alkaline water. Such bodies of water are well known and are sources of large amounts of alkalinity, e.g., Lake Van in Turkey has an average pH of 9.7-9.8. In addition, fly ash, slag, cement waste, and other industrial wastes can provide sufficient alkalinity to remove at least a portion of the protons and/or provide a sufficient pH change for precipitation.

In addition or as an alternative, protons may be removed from the water, e.g. while CO₂ is dissolved and/or at the precipitation step, using electrochemical approaches, which may remove protons without production of hydroxide (e.g., if proton production from CO₂ dissolution matches or exceeds proton removal by an electrochemical process) or with production of hydroxide. For example, electrodes (cathode and anode) may be provided in the reactor that holds the water source, where a selective barrier, such as a membrane, as desired, may separate the electrodes. Where desired, byproducts of the hydrolysis product, e.g., H₂, sodium metal, etc. may be harvested and employed for other purposes, as desired. Additional electrochemical approaches of interest include, but are not limited to, those described in U.S. Provisional Patent Application No. 61/081,299, filed 16 Jul. 2008 and U.S. Provisional Patent Application No. 61/091,729, filed 25 Aug. 2008, each of which is incorporated herein by reference in its entirety.

In some instances, low-voltage electrochemical protocols are employed remove protons from the water, e.g. while CO₂ is dissolved and at the precipitation step. By “low-voltage” is meant that the employed electrochemical protocol operates at an average voltage of 2.0, 1.9, 1.8, 1.7, or 1.6 V or less, such as 1.5, 1.4, 1.3, 1.2, 1.1 V or less, such as 1.0 V or less, including 0.9V or less, 0.8V or less, 0.7V or less, 0.6V or less, 0.5V or less, 0.4V or less, 0.3V or less, 0.2V or less, or 0.1V or less. Of interest are electrochemical protocols that do not generate chlorine gas. Also of interest are electrochemical protocols that do not generate oxygen gas. Also of interest are electrochemical protocols that do not generate hydrogen gas. In some instances, the electrochemical protocol is one that does not generate any gaseous by-byproduct.

Described below is an exemplary electrochemical process and system that may be used in embodiments of the invention. The system and method make use of one or more ion-selective membranes (a low-voltage system for producing hydroxide), which are further described in International Patent Application No. PCT/US08/88242, filed 23 Dec. 2008, titled “Low-Energy Electrochemical Hydroxide System and Method,” and International Patent Application No. PCT/US08/88246, filed 23 Dec. 2008, titled “Low-Energy Electrochemical Proton Transfer System and Method,” each of which is incorporated herein by reference in its entirety.

### Low Voltage System for Production of Hydroxide

A second set of methods and systems for removing protons from aqueous solution/producing hydroxide pertains to a low energy process for electrochemically preparing an ionic solution utilizing an ion exchange membrane in an electrochemical cell. In one embodiment, the system comprises an electrochemical system wherein an ion exchange membrane separates a first electrolyte from a second electrolyte, the first electrolyte contacting an anode and the second electrolyte contacting a cathode. In the system, on applying a voltage across the anode and cathode, hydroxide ions form at the cathode and a gas does not form at the anode.

In an another embodiment, the system comprises an electrochemical system comprising a first electrolytic cell including an anode contacting a first electrolyte, and an anion exchange membrane separating the first electrolyte from a third electrolyte; and a second electrolytic cell including a second electrolyte contacting a cathode and a cation exchange membrane separating the first electrolyte from the third electrolyte; wherein on applying a voltage across the anode and cathode, hydroxide ions form at the cathode and a gas does not form at the anode.

In one embodiment the method comprises placing an ion exchange membrane between a first electrolyte and a second electrolyte, the first electrolyte contacting an anode and the second electrolyte contacting a cathode; and migrating ions across the ion exchange membrane by applying a voltage across the anode and cathode to form hydroxide ions at the cathode without forming a gas at the anode.

In another embodiment the method comprises placing a third electrolyte between an anion exchange membrane and a cation exchange membrane; a first electrolyte between the anion exchange and an anode; and second electrolyte between the cation exchange membrane and a cathode; and migrating ions across the cation exchange membrane and the anion exchange membrane by applying a voltage to the anode and cathode to form hydroxide ions at the cathode without forming a gas at the anode.

By the methods and systems, ionic species from one solution are transferred to another solution in an low voltage electrochemical manner, thereby providing anionic solutions for various applications, including preparing a solution of sodium hydroxide for use in sequestration carbon dioxide as described herein. In one embodiment, a solution comprising OH— is obtained from salt water and used in sequestering CO₂ by precipitating calcium and magnesium carbonates and bicarbonates from a salt solution comprising alkaline earth metal ions as described herein.

The methods and systems in various embodiments are directed to a low voltage electrochemical system and method for generating a solution of sodium hydroxide in an aqueous solution utilizing one or more ion exchange membranes wherein, a gas is not formed at the anode and wherein hydroxyl ions are formed at the cathode. Thus, in some embodiments, hydroxide ions are formed in an electrochemical process without the formation of oxygen or chlorine gas. In some embodiments, hydroxide ions are formed in an electrochemical process where the voltage applied across the anode and cathode is less than 2.8 V, 2.7 V, 2.5 V, 2.4 V, 2.3 V, 2.2 V, 2.1 V, 2.0 V, 1.9 V, 1.8 V, 1.7 V, 1.6 V, 1.5 V, 1.4 V, 1.3 V, 1.2 V, 1.1 V, 1.0 V, 0.9 V, 0.8 V, 0.7 V, 0.6 V, 0.5 V, 0.4 V, 0.3 V, 0.2 V, or 0.1 V. In various embodiments, an ionic membrane is utilized to separate a salt water in contact with the anode, from a solution of e.g., sodium chloride in contact with the cathode. On applying a low voltage across the cathode and anode, a solution of e.g., sodium hydroxide is formed in the solution around the cathode; concurrently, an acidified solution comprising hydrochloric acid is formed in the solution around the anode. In various embodiments, a gas such as chorine or oxygen does not form at the anode.

In various embodiments, the sodium hydroxide solution is useable to sequester CO₂ as described herein, and the acidic solution is useable to dissolve calcium and magnesium bearing minerals to provide a calcium and magnesium ions for sequestering CO₂, also as described herein.

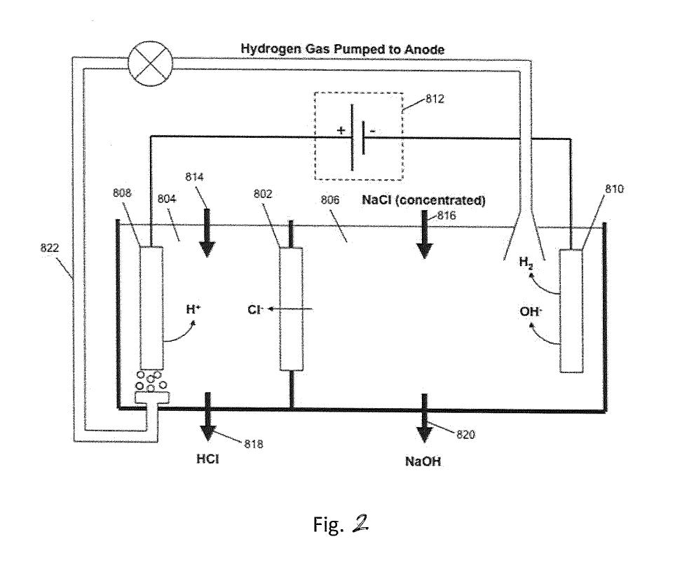

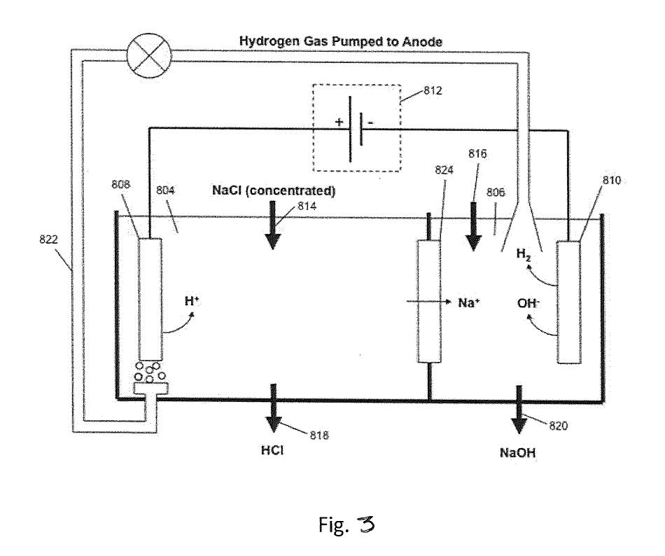

Turning to FIGS. 2-4, in various embodiments the system is adaptable for batch and continuous processes as described herein. Referring to FIGS. 2 and 3, in one embodiment the system includes an electrochemical cell wherein an ion exchange membrane (802, 824) is positioned to separate a first electrolyte (804) from a second electrolyte (806), the first electrolyte contacting an anode (808) and the second electrolyte contacting a cathode (810). As illustrated in FIG. 2, an anion exchange membrane (802) is utilized; in FIG. 3, a cation exchange membrane (824) is utilized.

In various embodiments as illustrated in FIGS. 2 and 3, first electrolyte (804) comprises an aqueous salt solution comprising seawater, freshwater, brine, or brackish water or the like; and second electrolyte comprises a solution substantially of sodium chloride. In various embodiments, second (806) electrolyte may comprise seawater or a concentrated solution of sodium chloride. In various embodiments anion exchange membrane (802) and cation exchange membrane (824) comprise a conventional ion exchange membranes suitable for use in an acidic and/or basic solution at operating temperatures in an aqueous solution up to 100° C. As illustrated in FIGS. 2 and 3, first and second electrolytes are in contact with the anode and cathode to complete an electrical circuit that includes voltage or current regulator (812). The current/voltage regulator is adaptable to increase or decrease the current or voltage across the cathode and anode in the system as desired.

With reference to FIGS. 2 and 3, in various embodiments, the electrochemical cell includes first electrolyte inlet port (814) adaptable for inputting first electrolyte (804) into the system and in contact with anode (808). Similarly, the cell includes second electrolyte inlet port (816) for inputting second electrolyte (806) into the system and in contact with cathode (810). Additionally, the cell includes outlet port (818) for draining first electrolyte from the cell, and outlet port (820) for draining second electrolyte from the cell. As will be appreciated by one ordinarily skilled, the inlet and outlet ports are adaptable for various flow protocols including batch flow, semi-batch flow, or continuous flow. In alternative embodiments, the system includes a duct (822) for directing gas to the anode; in various embodiments the gas comprises hydrogen formed at the cathode (810).

With reference to FIG. 2 where an anion membrane (802) is utilized, upon applying a low voltage across the cathode (810) and anode (808), hydroxide ions form at the cathode (810) and a gas does not form at the anode (808). Further, where second electrolyte (806) comprises sodium chloride, chloride ions migrate into the first electrolyte (804) from the second electrolyte (806) through the anion exchange membrane (802); protons form at the anode (808); and hydrogen gas forms at the cathode (810). As noted above, a gas e.g., oxygen or chlorine does not form at the anode (808).

With reference to FIG. 3 where a cation membrane (824) is utilized, upon applying a low voltage across the cathode (810) and anode (808), hydroxide ions form at the cathode (810) and a gas does not form at the anode (808). In various embodiments cation exchange membrane (824) comprises a conventional cation exchange membrane suitable for use with an acidic and basic solution at operating temperatures in an aqueous solution up to 100° C. As illustrated in FIG. 3, first and second electrolytes are in contact with the anode and cathode to complete an electrical circuit that includes voltage and/or current regulator (812). The voltage/current regulator is adaptable to increase or decrease the current or voltage across the cathode and anode in the system as desired. In the system as illustrated in FIG. 3 wherein second electrolyte (806) comprises sodium chloride, sodium ions migrate into the second electrolyte (806) from the first electrolyte (804) through the cation exchange membrane (824); protons form at the anode (808); and hydrogen gas forms at the cathode (810). As noted above, a gas e.g., oxygen or chlorine does not form at the anode (808).

As can be appreciated by one ordinarily skilled in the art, and with reference to FIG. 2 in second electrolyte (806) as hydroxide ions from the anode (810) and enter in to the second electrolyte (806) concurrent with migration of chloride ions from the second electrolyte, an aqueous solution of sodium hydroxide will form in second electrolyte (806). Consequently, depending on the voltage applied across the system and the flow rate of the second electrolyte (806) through the system, the pH of the second electrolyte is adjusted. In one embodiment, when a potential of 0.1 V or less, 0.2 V or less, 0.3 V or less, 0.4 V or less, 0.5 V or less, 0.6 V or less, 0.7 V or less, 0.8 V or less, 0.9 V or less, 1.0 V or less, 1.1 V or less, 1.2 V or less, 1.3 V or less, 01.4 V or less, 1.5 V or less, 1.6 V or less, 1.7 V or less, 1.8 V or less, 1.9 V or less, or 2.0 V or less, is applied across the anode and cathode, the pH of the second electrolyte solution increased; in another embodiment, when a volt of 0.1 V to 2.0 V is applied across the anode and cathode the pH of the second electrolyte increased; in yet another embodiment, when a voltage of 0.1 V to 1 V is applied across the anode and cathode the pH of the second electrolyte solution increased. Similar results are achievable with voltages of 0.1 V to 0.8 V; 0.1 V to 0.7 V; 0.1 V to 0.6 V; 0.1 V to 0.5 V; 0.1 V to 0.4 V; and 0.1 V to 0.3 V across the electrodes. Exemplary results achieved in accordance with the system are summarized in Table 1.

TABLE 1
Low energy electrochemical method and system.

| Volt across | Time | Initial pH at | End pH at | Initial pH at | End pH at |
|---|---|---|---|---|---|
| Electrodes | (sec) | Anode | Anode | Cathode | Cathode |
| 0.6 | 2000 | 6.7 | 3.8 | 6.8 | 10.8 |
| 1.0 | 2000 | 6.6 | 3.5 | 6.8 | 11.1 |

In this example, both the anode and the cathode comprise platinum, and the first and second electrolytes comprise a solution of sodium chloride.

Similarly, with reference to FIG. 3, in second electrolyte (806) as hydroxide ions from the anode (810) enter into the solution concurrent with migration of sodium ions from the first electrolyte to the second electrolyte, increasingly an aqueous solution of sodium hydroxide will form in second electrolyte (806). Depending on the voltage applied across the system and the flow rate of the second electrolyte through the system, the pH of the solution will be adjusted. In one embodiment, when a volt of 0.1 V or less, 0.2 V or less, 0.3 V or less, 0.4 V or less, 0.5 V or less, 0.6 V or less, 0.7 V or less, 0.8 V or less, 0.9 V or less, 1.0 V or less, 1.1 V or less, 1.2 V or less, 1.3 V or less, 1.4 V or less, 1.5 V or less, 1.6 V or less, 1.7 V or less, 1.8 V or less, 1.9 V or less, or 2.0 V or less is applied across the anode and cathode, the pH of the second electrolyte solution increased; in another embodiment, when a volt of 0.1 V to 2.0 V is applied across the anode and cathode the pH of the second electrolyte increased; in yet another embodiment, when a voltage of 0.1 V to 1 V is applied across the anode and cathode the pH of the second electrolyte solution increased. Similar results are achievable with voltages of 0.1 V to 0.8 V; 0.1 V to 0.7 V; 0.1 V to 0.6 V; 0.1 V to 0.5 V; 0.1 V to 0.4 V; and 0.1 V to 0.3 V across the electrodes. In one embodiment, a volt of 0.6 V or less is applied across the anode and cathode; in another embodiment, a volt of 0.1 V to 0.6 V or less is applied across the anode and cathode; in yet another embodiment, a voltage of 0.1 to 1 V or less is applied across the anode and cathode.

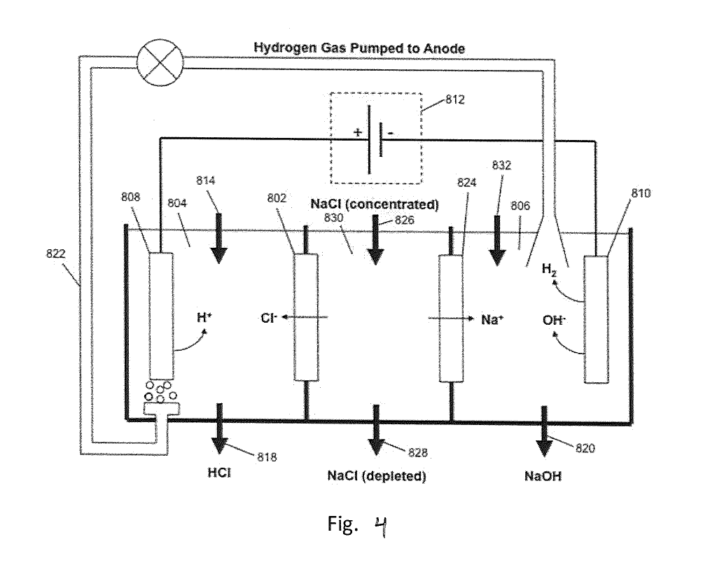

In various embodiments and with reference to FIGS. 2-4, hydrogen gas formed at the cathode (810) is directed to the anode (808) where, without being bound to any theory, it is believed that the gas is adsorbed and/or absorbed into the anode and subsequently forms protons at the anode. Accordingly, as can be appreciated, with the formation of protons at the anode and migration of e.g., chloride ions into the first electrolyte (804) as in FIG. 2, or migration of e.g., sodium ions from the first electrolyte as in FIG. 4, an acidic solution comprising e.g., hydrochloric acid is obtained in the first electrolyte (804).

In another embodiment as illustrated in FIG. 4, the system comprises an electrochemical cell including anode (808) contacting first electrolyte (804) and an anion exchange membrane (802) separating the first electrolyte from a third electrolyte (830); and a second electrolytic cell comprising a second electrolyte (806) contacting a cathode (880) and a cation exchange membrane (824) separating the first electrolyte from the third electrolyte, wherein on applying a voltage across the anode and cathode, hydrogen ions form at the cathode without a gas forming at the anode. As with the system of FIGS. 2 and 3, the system of FIG. 4 is adaptable for batch and continuous processes.

In various embodiments as illustrated in FIG. 4, first electrolyte (804) and second electrolyte (806) comprise an aqueous salt solution comprising seawater, freshwater, brine, or brackish water or the like; and second electrolyte comprises a solution substantially of sodium chloride. In various embodiments, first (804) and second (806) electrolytes may comprise seawater. In the embodiment illustrated in FIG. 4, the third electrolyte (830) comprises substantially sodium chloride solution.

In various embodiments anion exchange membrane (802) comprises any suitable anion exchange membrane suitable for use with an acidic and basic solution at operating temperatures in an aqueous solution up to 100° C. Similarly, cation exchange membrane (824) comprises any suitable cation exchange membrane suitable for use with an acidic and basic solution at operating temperatures in an aqueous solution up to 100° C.

As illustrated in FIG. 4, in various embodiments first electrolyte (804) is in contact with the anode (808) and second electrolyte (806) is in contact with the cathode (810). The third electrolyte (830), in contact with the anion and cation exchange membrane, completes an electrical circuit that includes voltage or current regulator (812). The current/voltage regulator is adaptable to increase or decrease the current or voltage across the cathode and anode in the system as desired.

With reference to FIG. 4, in various embodiments, the electrochemical cell includes first electrolyte inlet port (814) adaptable for inputting first electrolyte 804 into the system; second electrolyte inlet port (816) for inputting second electrolyte (806) into the system; and third inlet port (826) for inputting third electrolyte into the system. Additionally, the cell includes outlet port (818) for draining first electrolyte; outlet port (820) for draining second electrolyte; and outlet port (828) for draining third electrolyte. As will be appreciated by one ordinarily skilled, the inlet and outlet ports are adaptable for various flow protocols including batch flow, semi-batch flow, or continuous flow. In alternative embodiments, the system includes a duct (822) for directing gas to the anode; in various embodiments the gas is hydrogen formed at the cathode (810).

With reference to FIG. 4, upon applying a low voltage across the cathode (810) and anode (808), hydroxide ions form at the cathode (810) and a gas does not form at the anode (808). Further, where third electrolyte (830) comprises sodium chloride, chloride ions migrate into the first electrolyte (804) from the third electrolyte (830) through the anion exchange membrane (802); sodium ions migrate to the second electrolyte (806) from the third electrolyte (830); protons form at the anode; and hydrogen gas forms at the cathode. As noted previously, a gas e.g., oxygen or chlorine does not form at the anode (808).

As can be appreciated by one ordinarily skilled in the art, and with reference to FIG. 4 in second electrolyte (806) as hydroxide ions from the cathode (810) enter into the solution concurrent with migration of sodium ions from the third electrolyte, increasingly an aqueous solution of sodium hydroxide will form in second electrolyte (806). Depending on the voltage applied across the system and the flow rate of the second electrolyte through the system, the pH of the solution will be adjusted. In one embodiment, when a volt of 0.1 V or less, 0.2 V or less, 0.3 V or less, 0.4 V or less, 0.5 V or less, 0.6 V or less, 0.7 V or less, 0.8 V or less, 0.9 V or less, 1.0 V or less, 1.1 V or less, 1.2 V or less, 1.3 V or less, 01.4 V or less, 1.5 V or less, 1.6 V or less, 1.7 V or less, 1.8 V or less, 1.9 V or less, or 2.0 V or less or less is applied across the anode and cathode, the pH of the second electrolyte solution increased; in another embodiment, when a volt of 0.1 to 2.0 V is applied across the anode and cathode the pH of the second electrolyte increased; in yet another embodiment, when a voltage of 0.1 V to 1.0 V is applied across the anode and cathode the pH of the second electrolyte solution increased. Similar results are achievable with voltages of 0.1 V to 0.8 V; 0.1 V to 0.7 V; 0.1 V to 0.6 V; 0.1 V to 0.5 V; 0.1 V to 0.4 V; and 0.1 V to 0.3 V across the electrodes. In one embodiment, a volt of 0.6 volt or less is applied across the anode and cathode; in another embodiment, a volt of 0.1 V to 0.6 V or less is applied across the anode and cathode; in yet another embodiment, a voltage of 0.1 V to 1.0 V or less is applied across the anode and cathode.

Similarly, with reference to FIG. 4, in first electrolyte (804) as proton form at the anode (808) and enter into the solution concurrent with migration of chloride ions from the third electrolyte to the first electrolyte, increasingly an acidic solution will form in first electrolyte (804). Depending on the voltage applied across the system and the flow rate of the second electrolyte through the system, the pH of the solution will be adjusted. In one embodiment, when a volt of 0.1 V or less, 0.2 V or less; 0.3 V or less, 0.4 V or less, 0.5 V or less, 0.6 V or less, 0.7 V or less, 0.8 V or less, 0.9 V or less, 1.0 V or less, 1.1 V or less, 1.2 V or less, 1.3 V or less, 1.4 V or less, 1.5 V or less, 1.6 V or less, 1.7 V or less, 1.8 V or less, 1.9 V or less, or 2.0 V or less is applied across the anode and cathode, the pH of the second electrolyte solution increased; in another embodiment, when a volt of 0.1 V to 2.0 V is applied across the anode and cathode the pH of the second electrolyte increased; in yet another embodiment, when a voltage of 0.1 V to 1 V is applied across the anode and cathode the pH of the second electrolyte solution increased. Similar results are achievable with voltages of 0.1 V to 0.8 V; 0.1 V to 0.7 V; 0.1 V to 0.6 V; 0.1 V to 0.5 V; 0.1 V to 0.4 V; and 0.1 V to 0.3 V across the electrodes. In one embodiment, a volt of 0.6 V or less is applied across the anode and cathode; in another embodiment, a volt of 0.1 V to 0.6 V or less is applied across the anode and cathode; in yet another embodiment, a voltage of 0.1 V to 1.0 V or less is applied across the anode and cathode as indicated in Table 1.

As illustrated in FIG. 4, hydrogen gas formed at the cathode (810) is directed to the anode (808) where, without being bound to any theory, it is believed that hydrogen gas is adsorbed and/or absorbed into the anode and subsequently forms protons at the anode and enters the first electrolyte (804). Also, in various embodiments as illustrated in FIGS. 2-4, a gas such as oxygen or chlorine does not form at the anode (808). Accordingly, as can be appreciated, with the formation of protons at the anode and migration of chlorine into the first electrolyte, hydrochloric acid is obtained in the first electrolyte (804).

As described with reference to FIGS. 2 and 3, as hydroxide ions from the anode (810) and enter in to the second electrolyte (806) concurrent with migration of chloride ions from the second electrolyte, an aqueous solution of sodium hydroxide will form in second electrolyte (806). Consequently, depending on the voltage applied across the system and the flow rate of the second electrolyte (806) through the system, the pH of the second electrolyte is adjusted. In one embodiment, when a volt of 0.1 V or less, 0.2 V or less, 0.3 V or less, 0.4 V or less, 0.5 V or less, 0.6 V or less, 0.7 V or less, 0.8 V or less, 0.9 V or less, 1.0 V or less, 1.1 V or less, 1.2 V or less, 1.3 V or less, 1.4 V or less, 1.5 V or less, 1.6 V or less, 1.7 V or less, 1.8 V or less, 1.9 V or less, or 2.0 V or less is applied across the anode and cathode, the pH of the second electrolyte solution increased; in another embodiment, when a volt of 0.1 V to 2.0 V is applied across the anode and cathode the pH of the second electrolyte increased; in yet another embodiment, when a voltage of 0.1 V to 1 V is applied across the anode and cathode the pH of the second electrolyte solution increased. Similar results are achievable with voltages of 0.1 V to 0.8 V; 0.1 V to 0.7 V; 0.1 V to 0.6 V; 0.1 V to 0.5 V; 0.1 V to 0.4 V; and 0.1 V to 0.3 V across the electrodes. In one embodiment, when a volt of 0.6 V or less is applied across the anode and cathode, the pH of the second electrolyte solution increased; in another embodiment, when a volt of 0.1 V to 0.6 volt or less is applied across the anode and cathode the pH of the second electrolyte increased; in yet another embodiment, when a voltage of 0.1 V to 1.0 V or less is applied across the anode and cathode the pH of the second electrolyte solution increased.

Optionally, a gas including CO₂ is dissolved into the second electrolyte solution by bubbling the gas into the second electrolyte solution 806 as describe above. In an optional step the resulting second electrolyte solution is used to precipitate a carbonate and/or bicarbonate compounds such as calcium carbonate or magnesium carbonate and or their bicarbonates, as described herein. The precipitated carbonate compound can be used as cements and build material as described herein.

In another optional step, acidified first electrolyte solution 804 is utilized to dissolve a calcium and/or magnesium rich mineral, such as mafic mineral including serpentine or olivine for use as the solution for precipitating carbonates and bicarbonates as described herein. In various embodiments, the resulting solution can be used as the second electrolyte solution. Similarly, in embodiments where hydrochloric acid is produced in first electrolyte 804, the hydrochloric acid can be used in place of, or in addition to, the acidified second electrolyte solution.

Embodiments described above produce electrolyte solutions enriched in bicarbonate ions and carbonate ions, or combinations thereof as well as an acidified stream. The acidified stream can also find application in various chemical processes. For example, the acidified stream can be employed to dissolve calcium and/or magnesium rich minerals such as serpentine and olivine to create the electrolyte solution used in the reservoir 816. Such an electrolyte solution can be charged with bicarbonate ions and then made sufficiently basic so as to precipitate carbonate compounds as described herein

In some embodiments, a first electrochemical process may be used to remove protons from solution to facilitate CO₂ absorption, without concomitant production of hydroxide, while a second electrochemical process may be used to produce hydroxide in order to further remove protons to shift equilibrium toward carbonate and cause precipitation of carbonates. The two processes may have different voltage requirements, e.g., the first process may require lower voltage than the second, thus minimizing total overall voltage used in the process. For example, the first process may be a bielectrode process as described above, operating at 1.0 V or less, or 0.9 V or less, or 0.8 V or less, or 0.7 V or less, or 0.6 V or less, or 0.5 V or less, or 0.4 V or less, or 0.3 V or less, or 0.2 V or less, or 0.1 V or less, while the second process may be a low-voltage hydroxide producing process as described above, operating at 1.5 V or less, or 1.4 V or less, or 1.3 V or less, or 1.2 V or less, or 1.1 V or less, 1.0 V or less, or 0.9 V or less, or 0.8 V or less, or 0.7 V or less, or 0.6 V or less, or 0.5 V or less, or 0.4 V or less, or 0.3 V or less, or 0.2V or less, or 0.1 V or less. For example, in some embodiments the first process is a bielectrode process operating at 0.6 V or less and the second process is a low-voltage hydroxide producing process operating at 1.2 V or less.

Also of interest are the electrochemical approaches described in published U.S. Patent Application Publication No. 2006/0185985, published 24 Aug. 2006; U.S. Patent Application Publication No. 2008/0248350, published 9 Oct. 2008; International Patent Application Publication No. WO 2008/018928, published 14 Feb. 2008; and International Patent Application Publication No. WO 2009/086460, published 7 Jul. 2009, each of which is incorporated herein by reference in its entirety.

Stoichiometry dictates that the production of a carbonate to be precipitated in order to sequester CO₂ from a source of CO₂ requires the removal of two protons from the initial carbonic acid that is formed when CO₂ is dissolved in water (see equations 1-5, above). Removal of the first proton produces bicarbonate and removal of the second produces carbonate, which may be precipitated as, e.g., a carbonate of a divalent cation, such as magnesium carbonate or calcium carbonate. The removal of the two protons requires some process or combination of processes that typically require energy. For example, if the protons are removed through the addition of sodium hydroxide, the source of renewable sodium hydroxide is typically the chloralkali process, which uses an electrochemical process requiring at least 2.8 V and a fixed amount of electrons per mole of sodium hydroxide. That energy requirement may be expressed in terms of a carbon footprint, i.e., amount of carbon produced to provide the energy to drive the process.

A convenient way of expressing the carbon footprint for a given process of proton removal is as a percentage of the CO₂ removed from the source of CO₂. That is, the energy required for the removal of the protons may be expressed in terms of CO₂ emission of a conventional method of power generation to produce that energy, which may in turn be expressed as a percent of the CO₂ removed from the source of CO₂. For convenience, and as a definition in this aspect of the invention, the “CO₂ produced” in such a process will be considered the CO₂ that would be produced in a conventional coal/steam power plant to provide sufficient energy to remove two protons. Data are publicly available for such power plants for the last several years that show tons of CO₂ produced per total MWh of energy produced. See, e.g., the website having the address produced by combining “http://carma.” with “org/api/”. For purposes of definition here, a value of 1 ton CO₂ per MWh will be used, which corresponds closely to typical coal-fired power plants; for example, the WA Parish plant produced 18,200,000 MWh of energy in 2000 while producing approximately 19,500,000 tons of CO₂ and at present produces 21,300,00 MWh of energy while producing 20,900,000 tons of CO₂, which average out very close to the definitional 1 ton CO₂ per MWh that will be used herein. These numbers can then be used to calculate the CO₂ production necessary to remove sufficient protons to remove CO₂ from a gas stream, and compare it to the CO₂ removed. For example, in a process utilizing the chloralkali process operating at 2.8 V to provide base, and used to sequester CO₂ from a coal/stem power plant, the amount of CO₂ produced by the power plant to supply the energy to create base by the chloralkali process to remove two protons, using the 1 ton CO₂/1MWh ratio, would be well above 200% of the amount of CO₂ sequestered by the removal of the two protons and precipitation of the CO₂ in stable form. As a further condition of the definition of “CO₂ produced” in this aspect of the invention, no theoretical or actual calculations of reduction of the energy load due to, e.g., reuse of byproducts of the process for removing the protons (e.g., in the case of the chloralkali process, use of hydrogen produced in the process in a fuel cell or by direct combustion to produce energy) are included in the total of “CO₂ produced.” In addition, no theoretical or actual supplementation of the power supplied by the power plant with renewable sources of energy is considered, e.g., sources of energy that produce little or no carbon dioxide, such as wind, solar, tide, hydroelectric, and the like. If the process of removing protons includes the use of a hydroxide or other base, including a naturally-occurring or stockpiled base, the amount of CO₂ produced would be the amount that may be stoichiometrically calculated based on the process by which the base is produced, e.g., for industrially produced base, the standard chloralkali process or other process by which the base is produced, and for natural base, the best theoretical model for the natural production of the base.

Using this definition of “CO₂ produced,” in some embodiments the invention includes forming a stable CO₂-containing precipitate from a human-produced gaseous source of CO₂, wherein the formation of the precipitate utilizes a process for removing protons from an aqueous solution in which a portion or all of the CO₂ of the gaseous source of CO₂ is dissolved, and wherein the CO₂ produced by the process of removing protons is less than 100, 90, 80, 70, 65, 60, 55, 50, 45, 40, 35, 30, 25, 20, 15, 10, or 5% of the CO₂ removed from the gaseous source of CO₂ by said formation of precipitate. In some embodiments, the invention includes forming a stable CO₂-containing precipitate from a human-produced gaseous source of CO₂, wherein the formation of the precipitate utilizes a process for removing protons from an aqueous solution in which a portion or all of the CO₂ of the gaseous source of CO₂ is dissolved, and wherein the CO₂ produced by the process of removing protons is less than 70% of the CO₂ removed from the gaseous source of CO₂ by the formation of precipitate. In some embodiments the invention includes forming a stable CO₂-containing precipitate from a human-produced gaseous source of CO₂, wherein the formation of the precipitate utilizes a process for removing protons from an aqueous solution in which a portion or all of the CO₂ of the gaseous source of CO₂ is dissolved, and wherein the CO₂ produced by the process of removing protons is less than 50% of the CO₂ removed from the gaseous source of CO₂ by the formation of precipitate. In some embodiments the invention includes forming a stable CO₂-containing precipitate from a human-produced gaseous source of CO₂, wherein the formation of the precipitate utilizes a process for removing protons from an aqueous solution in which a portion or all of the CO₂ of the gaseous source of CO₂ is dissolved, and wherein the CO₂ produced by the process of removing protons is less than 30% of the CO₂ removed from the gaseous source of CO₂ by the formation of precipitate. In some embodiments, the process of removing protons is a process, such as an electrochemical process as described herein, that removes protons without producing a base, e.g., hydroxide. In some embodiments, the process of removing protons is a process, such as an electrochemical process as described herein, that removes protons by producing a base, e.g., hydroxide. In some embodiments, the process is a combination of a process, such as an electrochemical process as described herein, that removes protons without producing a base, e.g., hydroxide, and a process, such as an electrochemical process as described herein, that removes protons by producing a base, e.g., hydroxide. In some embodiments, the process of proton removal comprises an electrochemical process, either removes protons directly (e.g., direct removal of protons) or indirectly (e.g., production of hydroxide). In some embodiments a combination of processes, e.g., electrochemical processes is used, where a first process, e.g., electrochemical process, removes protons directly and a second process, e.g., electrochemical process, removes protons indirectly (e.g., by production of hydroxide).

In some instances, precipitation of the desired product following CO₂ charging (e.g., as described above) occurs without addition of a source divalent metal ions. As such, after the water is charged in a charging reactor with CO₂, the water is not then contacted with a source of divalent metal ions, such as one or more divalent metal ion salts, e.g., calcium chloride, magnesium chloride, sea salts, etc.

In one embodiment of the invention, a carbonate precipitation process may be employed to selectively precipitate calcium carbonate materials from the solution in order to provide the desired ratio of magnesium to calcium, followed by additional CO₂ charging, and in some embodiments additional Mg ion charging, and a final carbonate precipitation step. This embodiment is useful in utilizing concentrated waters such as desalination brine, wherein the cation content is sufficiently high that addition of more Mg ions is difficult. This embodiment is also useful in solutions of any concentration where two different products are desired to be produced—a primarily calcium carbonate material, and then a magnesium carbonate dominated material.

The yield of product from a given precipitation reaction may vary depending on a number of factors, including the specific type of water employed, whether or not the water is supplemented with divalent metal ions, the particular precipitation protocol employed, etc. In some instances, the precipitate protocols employed to precipitate the product are high yield precipitation protocols. In these instances, the amount of product produced from a single precipitation reaction (by which is meant a single time that that the water is subjected to precipitation conditions, such as increasing the pH to a value of 9.5 or higher, such as 10 or higher as reviewed above in greater detail) may be 5 g or more, such as 10 g or more, 15 g or more, 20 g or more, 25 g or more, 30 g or more, 35 g or more, 40 g or more, 45 g or more, 50 g or more, 60 g or more, 70 g or more, 80 g or more, 90 g or more, 100 g or more, 120 g or more, 140 g or more, 160 g or more, 180 g or more, 200 g or more of the storage-stable carbon dioxide sequestering product for every liter of water. In some instances, the amount of product produced for every liter of water ranges from 5 to 200 g, such as 10 to 100 g, including 20 to 100 g. In instances where the divalent metal ion content of the water is not supplemented prior to subjecting the water to precipitate conditions (for example where the water is seawater and the seawater is not supplemented with a source of divalent metal ion or ions), the yield of product may range from 5 to 20 g product per liter of water, such as 5 to 10, e.g., 6 to 8, g product per liter of water. In other instances where the water is supplemental with a source of divalent metal ions, such as magnesium and/or calcium ions, the yield of product may be higher, 2-fold higher, 3-fold higher, 5-fold higher, 10-fold higher, 20-fold higher or more, such that the yield of such processes may range in some embodiments from 10 to 200, such as 50 to 200 including 100 to 200 g product for every liter of water subjected to precipitation conditions.

In certain embodiments, a multi-step process is employed. In these embodiments, a carbonate precipitation process may be employed to selectively precipitate calcium carbonate materials from the solution, followed by additional steps of CO₂ charging and subsequent carbonate precipitation. The steps of additional CO₂ charging and carbonate precipitation can in some cases be repeated one, two, three, four, five, six, seven, eight, nine, ten, or more times, precipitating additional amounts of carbonate material with each cycle. In some cases, the final pH ranges from pH 8 to pH 10, such as from pH 9 to pH 10, including from pH 9.5 to pH 10, for example, from pH 9.6 to pH 9.8.

In certain embodiments, two or more reactors may be used to carry out the methods described herein. In these embodiments, the method may include a first reactor and a second reactor. In these cases, the first reactor is used for contacting the initial water with a magnesium ion source and for charging the initial water with CO₂, as described above. The water may be agitated to facilitate the dissolution of the magnesium ion source and to facilitate contact of the initial water with the CO₂. In some cases, before the CO₂ charged water is transferred to the second reactor, agitation of the CO₂ charged water is stopped, such that undissolved solids may settle by gravity. The CO₂ charged water is then transferred from the first reactor to the second reactor. After transferring the CO₂ charged water to the second reactor, the step of carbonate precipitation may be performed, as described herein:

In certain embodiments, a multi-step process, as described above, employing two or more reactors, as described above, can be used to carry out the methods described herein. In these embodiments, a first reactor is used for contacting the initial water with a magnesium ion source and for charging the initial water with CO₂, as described above. Subsequently, the CO₂ charged water is transferred from the first reactor to a second reactor for the carbonate precipitation reaction. In certain embodiments, one or more additional steps of CO₂ charging and subsequent carbonate precipitation may be performed in the second reactor, as described above.

In certain embodiments, precipitation conditions can be used that favor the formation of particular morphologies of carbonate compound precipitates. For instance, precipitation conditions can be used that favor the formation of amorphous carbonate compound precipitates over the formation of crystalline carbonate compound precipitates. In these cases, in addition to contacting the initial water with a magnesium ion source and charging the initial water with CO₂, as described above, a precipitation facilitator may be added. In these cases, the precipitation facilitator facilitates the formation of carbonate compound precipitates at lower pH's sufficient for nucleation, but insufficient for crystal formation and growth. Examples of precipitation facilitators include, but are not limited to, aluminum sulfate (Al₂SO₄)₃. In certain embodiments, the amount of precipitation facilitator added ranges from 1 ppm to 1000 ppm, such as from 1 ppm to 500, including from 10 ppm to 200 ppm, for example from 25 ppm to 75 ppm. Additionally, the pH of the water can be maintained between 6 and 8, such as between 7 and 8, during carbonate compound precipitation formation by alternating CO₂ charging and subsequent carbonate precipitation, as described above.

Alternatively, in yet other embodiments, precipitation conditions can be used that favor the formation of crystalline carbonate compound precipitates over the formation of amorphous carbonate compound precipitates. In some embodiments, precipitation conditions can be used that favor the formation of predominantly amorphous carbonate compound precipitates and metastable carbonate compound precipitates over the formation of highly crystalline stable carbonate compound precipitates.

Further details regarding specific precipitation protocols employed in certain embodiments of the invention are provided below with respect to the description of the figures of the application.

Following production of the precipitate product from the water, a composition is produced which includes precipitated product and a mother liquor or supernatant solution (i.e., the remaining liquid from which the precipitated product was produced). This composition may be a slurry of the precipitate and mother liquor or supernatant solution.

As summarized above, in sequestering carbon dioxide, the precipitated product is disposed of in some manner following its production. The phrase “disposed of” means that the product is either placed at a storage site or employed for a further use in another product, i.e., a manufactured or man-made item, where it is stored in that other product at least for the expected lifetime of that other product. In some instances, this disposal step includes forwarding the slurry composition described above to a long-term storage site. The storage site could be an above ground site, a below ground site or an underwater site. In these embodiments, following placement of the slurry at the storage site, the supernatant component of the slurry may naturally separate from the precipitate, e.g., via evaporation, dispersal, etc.

Where desired, the resulting precipitated product may be separated from the supernatant component of the slurry. Separation of the precipitated product may be achieved using any of a number of convenient approaches. As detailed further herein, liquid-solid separators such as Epuramat's Extrem-Separator (“ExSep”) liquid-solid separator, Xerox PARC's spiral concentrator, or a modification of either of Epuramat's ExSep or Xerox PARC's spiral concentrator, are useful in some embodiments. Separation may also be achieved by drying the precipitated product to produce a dried precipitated product. Drying protocols of interest include filtering the precipitate from the mother liquor or supernatant solution to produce a filtrate and then air-drying the filtrate. Where the filtrate is air dried, air-drying may be at a temperature ranging from −70 to 120° C., as desired. In some instances, drying may include placing the slurry at a drying site, such as a tailings pond, and allowing the liquid component of the precipitate to evaporate and leave behind the desired dried product. Also of interest are freeze-drying (i.e., lyophilization) protocols, where the precipitate is frozen, the surrounding pressure is reduced and enough heat is added to allow the frozen water in the material to sublime directly from the frozen precipitate phase to gas. Yet another drying protocol of interest is spray drying, where the liquid containing the precipitate is dried by feeding it through a hot gas, e.g., where the liquid feed is pumped through an atomizer into a main drying chamber and a hot gas is passed as a co-current or counter-current to the atomizer direction.

Where the precipitated product is separated from the mother liquor or supernatant solution, the resultant precipitate may be disposed of in a variety of different ways, as further elaborated below. For example, the precipitate may be employed as a component of a building material, as reviewed in greater detail below. Alternatively, the precipitate may be placed at a long-term storage site (sometimes referred to in the art as a carbon bank), where the site may be above ground site, a below ground site or an underwater site. Further details regarding disposal protocols of interest are provided below.

The resultant mother liquor or supernatant solution may also be processed as desired. For example, the mother liquor or supernatant solution may be returned to the source of the water, e.g., ocean, or to another location. In certain embodiments, the mother liquor or supernatant solution may be contacted with a source of CO₂, e.g., as described above, to sequester further CO₂. For example, where the mother liquor or supernatant solution is to be returned to the ocean, the mother liquor or supernatant solution may be contacted with a gaseous source of CO₂ in a manner sufficient to increase the concentration of carbonate ion present in the mother liquor or supernatant solution. Contact may be conducted using any convenient protocol, such as those described above. In certain embodiments, the mother liquor or supernatant solution has an alkaline pH, and contact with the CO₂ source is carried out in a manner sufficient to reduce the pH to a range between 5 and 9, e.g., 6 and 8.5, including 7.5 to 8.2.

Dewatering is the separation of solids and liquid in mixtures of solids and liquids such as slurries and suspensions. Dewatering may be divided into three types by the methods employed: gravity separation, mechanical separation, and thermal separation. Dewatering may also be classified by the amount of solids present in the mixtures. Primary dewatering is a term used to describe the steps or methods used to obtain a mixture that is more concentrated in solids than the original mixture (e.g., up to and including 30 wt % solids). Secondary dewatering is a term used to describe the steps or methods used to obtain a mixture that is more concentrated in solids than the original mixture, usually following primary dewatering, and resulting in a mixture greater than about 30 wt % solids (e.g., 30 wt %-90 wt % solids). Steps or methods that result in mixtures that are more concentrated in solids than the original mixture such that the solids make up greater than 90 wt % of the mixture may be referred to subsequent dewatering or final dewatering, depending on how many steps are included and if any further separation takes place. Dewatering of slurries and other mixtures of solids (e.g. particles, colloids) and liquid encompasses: activities to agglomerate or enlarge the solid particles in a mixture or slurry such as coagulation, flocculation, and growth of existing crystals; settling out of solids; physical separation of solids and liquid; and if required by the intended application, thermal removal of liquid from solids of a mixture or slurry.

Gravity separation of solids from liquid is one type of separation or dewatering. Gravity separation is characterized by utilizing the difference in the density or specific gravity of the solids and liquid. Settling out is the simplest form of gravity separation. The activities to agglomerate or enlarge the solid particles in a slurry or mixture allow for thickening or settling out of the solids in the liquid with less energy and/or time Other methods that employ gravity include, but are not limited to, centrifugal separation, use of a hydrocyclone, use of a clarifier, use of a Lamella clarifier/thickener.

Mechanical separation is another type of solid-liquid separation or dewatering. Mechanical separation may indicate filtration methods or that a machine is used to separate solids from liquids in a mixture or slurry without exploiting the differences in density between the solids and liquids. Mechanical or physical separation methods that are described as filtration utilize a barrier through which the liquid and some solids may pass. A force may be applied to increase the flow rate of liquid through the barrier or filter. Filtration may be surface or depth filtration. Surface filtration occurs when a barrier, e.g. a sieve or wire mesh, prevents particles larger than the openings of the barrier from passing through and such particles are retained on the barrier surface. Depth filtration employs the thickness of a barrier in addition to the surface of the barrier with the intent of trapping solids in the voids within the thickness of the barrier and allowing the liquid in a mixture of solid particles and a liquid to pass. There are situations in which both surface filtration and depth filtration take place. When a barrier begins to separate solid particles and a liquid, during which surface filtration occurs, with the formation of additional layers of particles will lead to the formation of a cake. When a cake stands above a barrier, depth filtration occurs through the thickness of the cake. Filters may be characterized by the size of the smallest particle that may be stopped by the filter, by the permeability of the filter, and the amount of solids that accumulate in the filter and the rate of increased resistance to flow of liquid through the filter. The flow of the mixture towards the barrier, and particularly the flow of the liquid portion of the mixture through the barrier may be facilitated by the application of a vacuum or pressure above the mixture. The pressure may be applied by a solid implement, such as a plate or belt pressing upon a layer of the mixture, by a gas, or by hydraulic means in combination with a physical implement. Filter aids are inert aids to separation. Filter aids act to either form a pre-coat on a coarse barrier or mix with the mixture to be separated so as to increase the permeability of the filter cake that forms; or in some cases to filter aids do both. Suitable filter aid materials include diatomaceous earth, expanded perilitic rock, asbestos, cellulose, non-activated carbon, ashes, ground chalk, or a mixture thereof. In some cases, material that is cheap, waste, or otherwise rejected material is used a filter aid material.

Barriers used in surface and cake filtration include, but are not limited to: ceramic rigid porous media, stoneware rigid porous media, sintered metal rigid porous media, sintered woven-wire porous media, plastic rigid porous media, polymer membranes, woven wire, woven metal fabric, wire cloth, wire mesh, supported glass paper, supported cellulose paper, woven fabrics of synthetic fibers (e.g. nylon, polyester, polypropylene, polyethylene), woven fabrics of natural fibers (e.g. wool, cellulose), or any combination thereof.

Other methods of mechanical separation include spraying mixtures or slurries into volumes air or other gases as droplets such that the act of the droplets moving through the gas will cause a separation of the solids and liquid. In some embodiments of the methods of the invention, droplets of slurry or other mixtures of solids and liquid are made by any suitable atomization technique, including, but not limited to use of: a pressure atomizer, a rotary atomizer, an air-assist atomizer, an airblast atomizer, or an ultrasonic atomizer or any combination thereof. In some embodiments, the droplets of solids and liquid are of average diameter from 5 μm to 500 μm. In some embodiments, the droplets of solids and liquid are of average diameter of greater than 500 μm, such as greater than 600 μm, such as greater than 700 μm, such as greater than 800 μm, such as greater than 900 μm, such as greater than 1 mm. In some embodiments, the droplets of solids and liquid are sprayed into air at ambient atmospheric temperature. In some embodiments, the droplets of solids and liquid are sprayed into air at a temperature above ambient temperature. In such embodiments, the air is raised to a temperature above ambient temperature through contact with a heat exchanger in contact with a fluid at an elevated temperature such as, but not limited to, industrial waste gas (e.g. flue gas from a power plant), a geothermal brine, or effluent brine from a geothermal power plant. In some embodiments, the gas into which the droplets of solids and liquid are sprayed is a gas that will not interact with the solids. In some embodiments, the air or other gas into which the droplets of solids and liquid are sprayed is at a humidity above ambient relative humidity.

Dewatering methods may include primary, secondary, and final or subsequent dewatering. In some embodiments, dewatering methods of the invention include only primary dewatering. In some embodiments in which only primary dewatering is employed, primary dewatering may include methods or steps of gravity separation, mechanical separation, thermal evaporation or separation, or any combination thereof. In some embodiments, primary dewatering is followed by secondary dewatering, and during secondary dewatering methods or steps of gravity separation, mechanical separation, thermal evaporation or separation, or any combination thereof may be utilized. In some embodiments, secondary dewatering is preceded by primary dewatering and followed by final dewatering, and in final dewatering methods or steps of gravity separation, mechanical separation, thermal evaporation or separation, or any combination thereof may be used.

In some embodiments, a mixture of a precipitated CO₂-sequestering carbonate compound composition characterized by having a δ¹³C value less than −10% and the supernatant solution from which the CO₂-sequestering carbonate compound composition was precipitated is dewatered to provide a dewatered CO₂-sequestering carbonate compound composition of at least 20 wt % solids and an effluent solution that includes the supernatant solution. In such embodiments, dewatering the mixture of a precipitated CO₂-sequestering carbonate compound composition characterized by having a δ¹³C value less than −10‰ and the supernatant solution from which the CO₂-sequestering carbonate compound composition was precipitated means to separate the carbonate compound composition from the supernatant solution such that a mixture with a higher concentration of carbonate compound composition results. In some embodiments, gravity separation, mechanical separation, thermal evaporation or separation, or any combination thereof may be used to dewater a mixture of a precipitated CO₂-sequestering carbonate compound composition characterized by having a δ¹³C value less than −10‰ and the supernatant solution from which the CO₂-sequestering carbonate compound composition was precipitated. In some embodiments, the dewatered CO₂-sequestering carbonate compound composition and the effluent solution are processed after the separating step. In some embodiments, processing of the effluent solution includes adjusting the pH and/or chemical composition of the effluent solution so that it is suitable for release into an ocean, sea, river, other body of surface water, or a subterranean repository. In some embodiments, processing of the effluent solution includes subjecting the effluent solution to desalination methods or protocols. In some embodiments, the desalination methods or protocols include membrane protocols, distillation protocols, or a combination thereof. In some embodiments, the desalination methods or protocols include: a reverse osmosis protocol, a forward osmosis protocol, a nano-filtration protocol, a micro-filtration protocol, a pH adjusting protocol, a membrane distillation protocol, an electro-dialysis protocol, or a combination thereof. In some embodiments, processing of the effluent solution includes a reverse osmosis protocol, a forward osmosis protocol, a nano-filtration protocol, a micro-filtration protocol, a pH adjusting protocol, a membrane distillation protocol, a salt recovery protocol, a cation recovery protocol, an electro-dialysis protocol, or a combination thereof. In some embodiments processing the CO₂-sequestering carbonate compound composition includes particle size refining. In such embodiments, particle size refining may include reduction of the particle size through crushing, grinding, milling, or any combination thereof. In embodiments in which processing the CO₂-sequestering carbonate compound composition includes particle size refining, particle size refining may include agglomeration, sintering, or other enlarging of the particle into larger objects. In some embodiments processing the CO₂-sequestering carbonate compound composition includes the production of a building material that includes the CO₂-sequestering carbonate compound composition such as a hydraulic cement, a cement, an aggregate, a supplementary cementitious material, a concrete or any combination thereof. In such embodiments, the building material that includes the CO₂-sequestering carbonate compound composition contains at least 25 wt % of the CO₂-sequestering carbonate compound composition.

The methods of the invention may be carried out at land or sea, e.g., at a land location where a suitable water is present at or is transported to the location, or in the ocean or other body of alkali-earth-metal-containing water, be that body naturally occurring or manmade. In certain embodiments, a system is employed to perform the above methods, where such systems include those described below in greater detail.

The above portion of this application provides an overview of various aspects of the methods of the invention. Certain embodiments of the invention are now reviewed further in greater detail in terms of the certain figures of the invention.

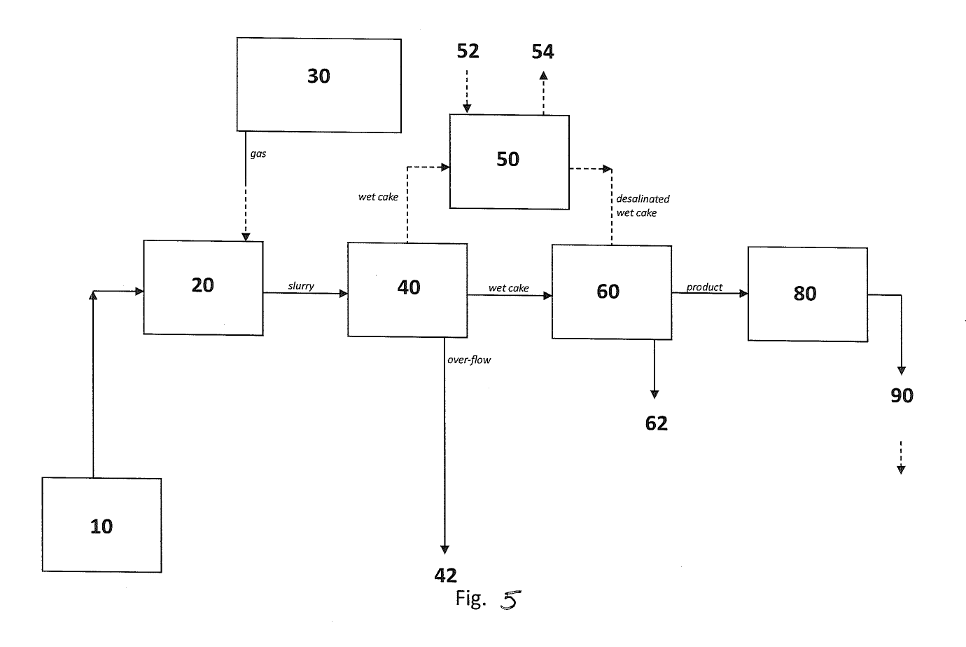

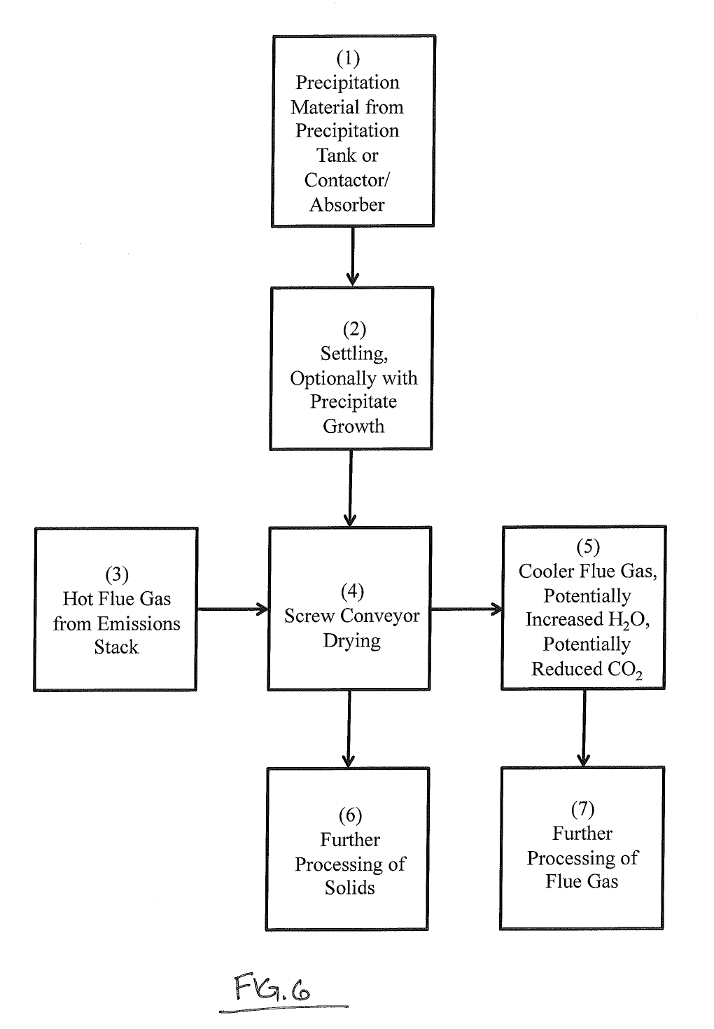

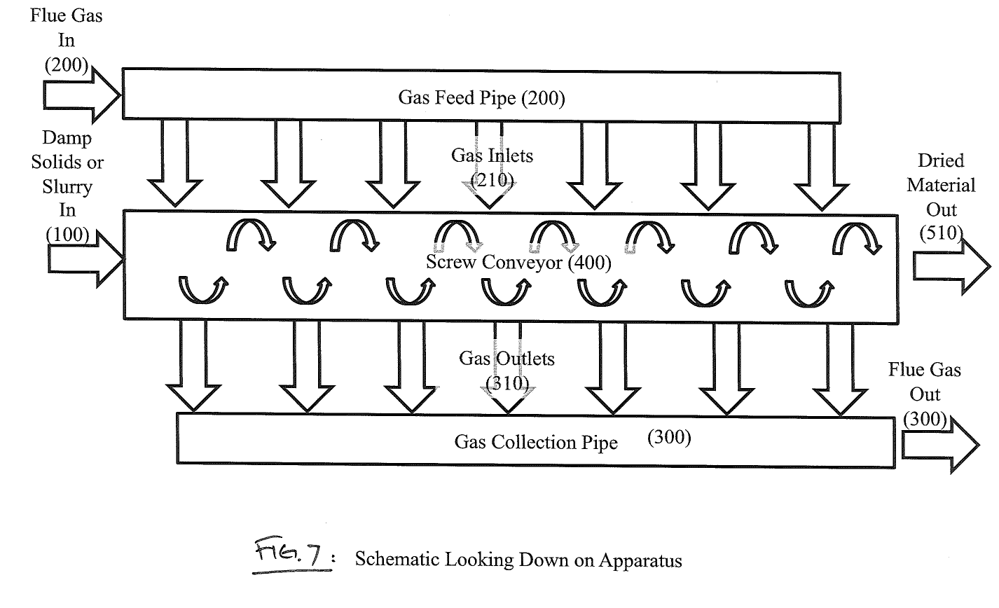

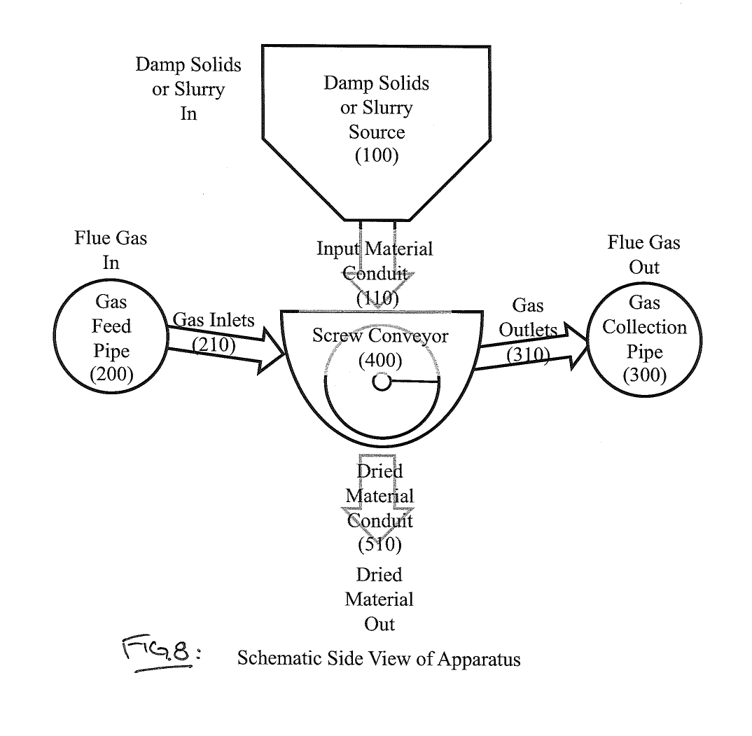

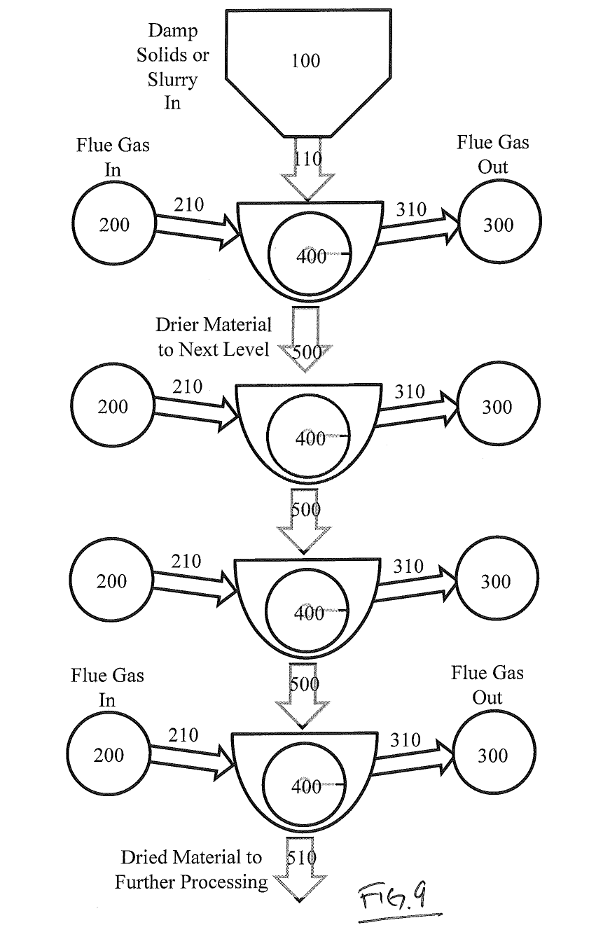

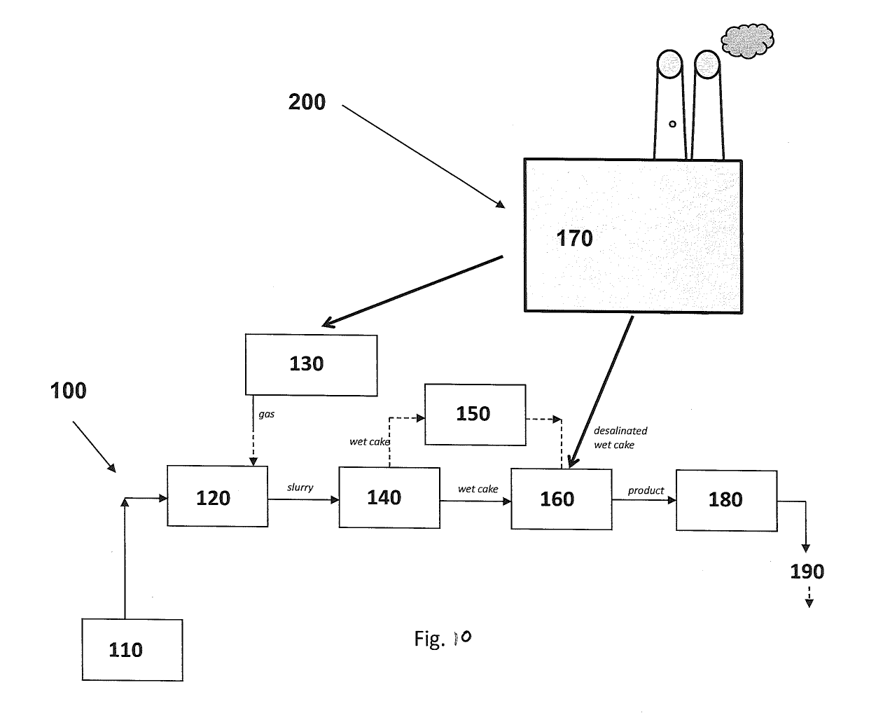

FIG. 5 provides a schematic flow diagram of a carbon dioxide sequestration process that may be implemented in a system, where the system may be manifested as a stand-alone plant or as an integrated part of another type of plant, such as a power generation plant, a cement production plant, etc. In FIG. 5, water 10 is delivered to a precipitation reactor 20, e.g., via a pipeline or other convenient manner, and subjected to carbonate mineral precipitation conditions. The water employed in the process illustrated in FIG. 5 is one that includes, for example, one or more alkaline earth metal ions such as Ca²⁺ and Mg²⁺. In certain embodiments of the invention, the water of interest is one that includes calcium in amounts ranging from 50 ppm to 20,000 ppm, such as 200 ppm to 5000 ppm and including 400 ppm to 1000 ppm. Also of interest are waters that include magnesium in amounts ranging from 50 ppm to 40,000 ppm, such as 100 ppm to 10,000 ppm and including 500 ppm to 2500 ppm. In embodiments of the invention, the water (e.g., alkaline earth metal ion-containing water) is a saltwater. As reviewed above, saltwaters of interest include a number of different types of aqueous fluids other than fresh water, such as brackish water, sea water and brine (including man-made brines, for example geothermal plant wastewaters, desalination waste waters, etc., as well as naturally occurring brines as described herein), as well as other salines having a salinity that is greater than that of freshwater. Brine is water saturated or nearly saturated with salt and has a salinity that is 50 ppt (parts per thousand) or greater. Brackish water is water that is saltier than fresh water, but not as salty as seawater, having a salinity ranging from 0.5 to 35 ppt. Seawater is water from a sea or ocean and has a salinity ranging from 35 to 50 ppt. Freshwater is water that has a salinity of less than 5 ppt dissolved salts. Saltwaters of interest may be obtained from a naturally occurring source, such as a sea, ocean, lake, swamp, estuary, lagoon, etc., or a man-made source, as desired.

As reviewed above, waters of interest also include freshwaters. In certain embodiments, the water employed in the invention may be a mineral rich, e.g., calcium and/or magnesium rich, freshwater source. In some embodiments, freshwaters, such as calcium rich waters may be combined with magnesium silicate minerals, such as olivine or serpentine, in a solution that has become acidic due to the addition of carbon dioxide from carbonic acid, which dissolves the magnesium silicate, leading to the formation of calcium magnesium silicate carbonate compounds. In certain embodiments, the water source can be freshwater wherein metal-ions, e.g., sodium, potassium, calcium, magnesium, etc. are added. Metal-ions can be added to the freshwater source using any convenient protocol, e.g., as a solid, aqueous solution, suspension etc.

In certain embodiments, the water may be obtained from the industrial plant that is also providing the gaseous waste stream. For example, in water cooled industrial plants, such as seawater cooled industrial plants, water that has been employed by the industrial plant may then be sent to the precipitation system and employed as the water in the precipitation reaction. Where desired, the water may be cooled prior to entering the precipitation reactor. Such approaches may be employed, e.g., with once-through cooling systems. For example, a city or agricultural water supply may be employed as a once-through cooling system for an industrial plant. The water from the industrial plant may then be employed in the precipitation protocol, where output water has a reduced hardness and greater purity. Where desired, such systems may be modified to include security measures, e.g., to detect tampering (such as addition of poisons) and coordinated with governmental agencies, e.g., Homeland Security or other agencies. Additional tampering or attack safeguards may be employed in such embodiments.

As shown in FIG. 5, an industrial plant gaseous waste stream 30 is contacted with the water at precipitation step 20 to produce a CO₂ charged water (which may occur in a charging reactor in certain embodiments). By CO₂ charged water is meant water that has had CO₂ gas contacted with it, where CO₂ molecules have combined with water molecules to produce, e.g., carbonic acid, bicarbonate and carbonate ion. Charging water in this step results in an increase in the “CO₂ content” of the water, e.g., in the form of carbonic acid, bicarbonate and carbonate ion, and a concomitant decrease in the amount of CO₂ of the waste stream that is contacted with the water. The CO₂ charged water is acidic in some embodiments, having a pH of 6.0 or less, such as 4.0 or less, and including 3.0 and less. In certain embodiments, the amount of CO₂ of the gas that is used to charge the water decreases by 85% or more, such as 99% or more as a result of this contact step, such that the methods remove 50% or more, such as 75% or more, e.g., 85% or more, including 99% or more of the CO₂ originally present in the gaseous waste stream that is contacted with the water. Contact protocols of interest include, but are not limited to: direct contacting protocols, e.g., bubbling the gas through the volume of water, concurrent contacting means, i.e., contact between unidirectionally flowing gaseous and liquid phase streams, countercurrent means, i.e., contact between oppositely flowing gaseous and liquid phase streams, and the like. The gaseous stream may contact the water source vertically, horizontally, or at some other angle.

The CO₂ may be contacted with the water source from one or more of the following positions: below, above, or at the surface level of the water (e.g., alkaline earth metal ion-containing water). Contact may be accomplished through the use of infusers, bubblers, fluidic Venturi reactor, sparger, gas filter, spray, tray, catalytic bubble column reactors, draft-tube type reactors or packed column reactors, and the like, as may be convenient. Where desired, two or more different CO₂ charging reactors (such as columns or other types of reactor configurations) may be employed, e.g., in series or in parallel, such as three or more, four or more, etc. In certain embodiments, various means, e.g., mechanical stirring, electromagnetic stirring, spinners, shakers, vibrators, blowers, ultrasonication, to agitate or stir the reaction solution are used to increase the contact between CO₂ and the water source.

At step 20, the storage-stable product is precipitated at precipitation step 20. Precipitation conditions of interest include those that modulate the physical environment of the water to produce the desired precipitate product. For example, the temperature of the water may be raised to an amount suitable for precipitation of the desired carbonate mineral to occur. In such embodiments, the temperature of the water may be raised to a value from 5 to 70° C., such as from 20 to 50° C. and including 25 to 45° C. As such, while a given set of precipitation conditions may have a temperature ranging from 0 to 100° C., the temperature may be raised in certain embodiments to produce the desired precipitate. In certain embodiments, the temperature is raised using energy generated from low- or zero-carbon dioxide emission sources, e.g., solar energy source, wind energy source, hydroelectric energy source, etc. In certain embodiments, excess and/or process heat from the industrial plant carried in the gaseous waste stream is employed to raise the temperature of the water during precipitation either as hot gases or steam. In certain embodiments, contact of the water with the gaseous waste stream may have raised the water to the desired temperature, where in other embodiments, the water may need to be cooled to the desired temperature.

In normal seawater, 93% of the dissolved CO₂ is in the form of bicarbonate ions (HCO₃⁻) and 6% is in the form of carbonate ions (CO₃²⁻). When calcium carbonate precipitates from normal seawater, CO₂ is released. In fresh water, above pH 10.33, greater than 90% of the carbonate is in the form of carbonate ion, and no CO₂ is released during the precipitation of calcium carbonate. In seawater this transition occurs at a slightly lower pH, closer to a pH of 9.7. While the pH of the water employed in methods may range from 5 to 14 during a given precipitation process, in certain embodiments the pH is raised to alkaline levels in order to drive the precipitation of carbonate compounds, as well as other compounds, e.g., hydroxide compounds, as desired. In certain of these embodiments, the pH is raised to a level which minimizes if not eliminates CO₂ production during precipitation, causing dissolved CO₂, e.g., in the form of carbonate and bicarbonate, to be trapped in the carbonate compound precipitate. In these embodiments, the pH may be raised to 9 or higher, such as 10 or higher, including 11 or higher.

As summarized above, the pH of the water source, e.g., alkaline earth metal ion-containing water, is raised using any convenient approach. In certain embodiments, a pH raising agent may be employed, where examples of such agents include oxides (calcium oxide, magnesium oxide), hydroxides (e.g., potassium hydroxide, sodium hydroxide, brucite (Mg(OH)₂, etc.), carbonates (e.g., sodium carbonate) and the like.

As indicated above, ash (or slag in certain embodiments) is employed in certain embodiments as the sole way to modify the pH of the water to the desired level. In yet other embodiments, one or more additional pH modifying protocols is employed in conjunction with the use of ash.

Alternatively or in conjunction with the use of a pH-elevating agent (such as described above), the pH of the water (e.g., alkaline earth metal ion-containing water) source can be raised to the desired level by electrolysis of the water using an electrolytic or electrochemical protocol. Electrochemical protocols of interest include, but are not limited to, those described above as well as those described in U.S. Provisional Patent Application No. 61/081,299, filed 16 Jul. 2008 and U.S. Provisional Patent Application No. 61/091,729, filed 25 Aug. 2008, each of which is incorporated herein by reference in its entirety. Also of interest are the electrolytic approaches described in U.S. Patent Application Publication No. 2006/0185985, published 24 Aug. 2006 and U.S. Patent Application Publication No. 2008/0248350, published 9 Oct. 2008, as well as International Patent Application Publication No. WO 2008/018928, published 14 Feb. 2008, each of which is incorporated herein by reference in its entirety.

Where desired, additives other than pH elevating agents may also be introduced into the water in order to influence the nature of the precipitate that is produced. As such, certain embodiments of the methods include providing an additive in the water before or during the time when the water is subjected to the precipitation conditions. Certain calcium carbonate polymorphs can be favored by trace amounts of certain additives. For example, vaterite, a highly unstable polymorph of CaCO₃ that precipitates in a variety of different morphologies and converts rapidly to calcite, can be obtained at very high yields by including trace amounts of lanthanum as lanthanum chloride in a supersaturated solution of calcium carbonate. Other additives besides lanthanum that are of interest include, but are not limited to transition metals and the like. For instance, the addition of ferrous or ferric iron is known to favor the formation of disordered dolomite (protodolomite) where it would not form otherwise.

The nature of the precipitate can also be influenced by selection of appropriate major ion ratios. Major ion ratios also have considerable influence of polymorph formation. For example, as the magnesium:calcium ratio in the water increases, aragonite becomes the favored polymorph of calcium carbonate over low-magnesium calcite. At low magnesium:calcium ratios, low-magnesium calcite is the preferred polymorph.

Rate of precipitation also has a large effect on compound phase formation. The most rapid precipitation can be achieved by seeding the solution with a desired phase. Without seeding, rapid precipitation can be achieved by rapidly increasing the pH of the sea water, which results in more amorphous constituents. When silica is present, the more rapid the reaction rate, the more silica is incorporated with the carbonate precipitate. The higher the pH is, the more rapid the precipitation is, and the more amorphous the precipitate is.

Accordingly, a set of precipitation conditions to produce a desired precipitate from a water include, in certain embodiments, the water's temperature and pH, and in some instances the concentrations of additives and ionic species in the water. Precipitation conditions may also include factors such as mixing rate, forms of agitation such as ultrasonics, and the presence of seed crystals, catalysts, membranes, or substrates. In some embodiments, precipitation conditions include supersaturated conditions, temperature, pH, and/or concentration gradients, or cycling or changing any of these parameters. The protocols employed to prepare carbonate compound precipitates according to the invention may be batch or continuous protocols. It will be appreciated that precipitation conditions may be different to produce a given precipitate in a continuous flow system compared to a batch system.

In certain embodiments, contact between the water (e.g., alkaline earth metal ion-containing water) and CO₂ may be accomplished using any convenient protocol, (e.g., spray gun, segmented flow-tube reactor) to control the range of sizes of precipitate particles. One or more additives may be added to the metal-ion containing water source, e.g., flocculants, dispersants, surfactants, antiscalants, crystal growth retarders, sequestration agents etc, in the methods and systems of the claimed invention in order to control the range of sizes of precipitate particles.

In the embodiment depicted in FIG. 5, the water (e.g., water comprising alkaline earth metal ions) from the water source 10 is first charged with CO₂ to produce CO₂ charged water, which CO₂ is then subjected to carbonate mineral precipitation conditions. As depicted in FIG. 5, a CO₂ gaseous stream 30 is contacted with the water at precipitation step 20. The provided gaseous stream 30 is contacted with a suitable water at precipitation step 20 to produce a CO₂ charged water. By CO₂ charged water is meant water that has had CO₂ gas contacted with it, where CO₂ molecules have combined with water molecules to produce, e.g., carbonic acid, bicarbonate and carbonate ion. Charging water in this step results in an increase in the “CO₂ content” of the water, e.g., in the form of carbonic acid, bicarbonate and carbonate ion, and a concomitant decrease in the pCO₂ of the waste stream that is contacted with the water. The CO₂ charged water can be acidic, having a pH of 6 or less, such as 5 or less and including 4 or less. In some embodiments, the CO₂ charged water is not acidic, e.g., having a pH of 7 or more, such as a pH of 7-10, or 7-9, or 7.5-9.5, or 8-10, or 8-9.5, or 8-9. In certain embodiments, the concentration of CO₂ of the gas that is used to charge the water is 10% or higher, 25% or higher, including 50% or higher, such as 75% or higher.

CO₂ charging and carbonate mineral precipitation may occur in the same or different reactors of the system. As such, charging and precipitation may occur in the same reactor of a system, e.g., as illustrated in FIG. 5 at step 20, according to certain embodiments of the invention. In yet other embodiments of the invention, these two steps may occur in separate reactors, such that the water is first charged with CO₂ in a charging reactor and the resultant CO₂ charged water is then subjected to precipitation conditions in a separate reactor. Further reactors may be used to, e.g., charge the water with desired minerals.

Contact of the water with the source CO₂ may occur before and/or during the time when the water is subjected to CO₂ precipitation conditions. Accordingly, embodiments of the invention include methods in which the volume of water is contacted with a source of CO₂ prior to subjecting the volume of water (e.g., alkaline earth metal ion-containing water) to mineral precipitation conditions. Embodiments of the invention also include methods in which the volume of water is contacted with a source of CO₂ while the volume of water is being subjected to carbonate compound precipitation conditions. Embodiments of the invention include methods in which the volume of water is contacted with a source of a CO₂ both prior to subjecting the volume of water (e.g., alkaline earth metal ion-containing water) to carbonate compound precipitation conditions and while the volume of water is being subjected to carbonate compound precipitation conditions. In some embodiments, the same water may be cycled more than once, wherein a first cycle of precipitation removes primarily calcium carbonate and magnesium carbonate minerals and leaves water to which metal ions, for example, alkaline earth metal ions, may be added, and that may have more CO₂ cycled through it, precipitating more carbonate compounds.

Regardless of when the CO₂ is contacted with the water, in some instances when the CO₂ is contacted with the water, the water is not exceedingly alkaline, such that the water contacted with the CO₂ may have a pH of 10 or lower, such as 9.5 or lower, including 9 or lower and even 8 or lower. In some embodiments, the water that is contacted with the CO₂ is not a water that has first been made basic from an electrochemical protocol. In some embodiments, the water that is contacted with the CO₂ is not a water that has been made basic by addition of hydroxides, such as sodium hydroxide. In some embodiment, the water is one that has been made only slightly alkaline, such as by addition of an amount of an oxide, such as calcium oxide or magnesium oxide).

The carbonate mineral precipitation station 20 (i.e., reactor) may include any of a number of different components, such as temperature control components (e.g., configured to heat the water to a desired temperature), chemical additive components, e.g., for introducing chemical pH elevating agents (such as KOH, NaOH) into the water, electrolysis components, e.g., cathodes/anodes, etc, gas charging components, pressurization components (for example where operating the protocol under pressurized conditions, such as from 50-800 psi, or 100-800 psi, or 400 to 800 psi, or any other suitable pressure range, is desired) etc, mechanical agitation and physical stirring components and components to re-circulate industrial plant flue gas through the precipitation plant.

As illustrated in FIG. 5, the precipitation product resulting from precipitation at step 20 may be separated from the precipitation station effluent at step 40 to produce separated precipitation product. As a freshly separated precipitation product may be dried in a later step, the separated precipitation product may also be a “wet dewatered precipitate.” Separation of the precipitation product from the precipitation station effluent is achieved using any of a number of convenient approaches, including draining (e.g., gravitational sedimentation of the precipitation product followed by draining), decanting, filtering (e.g., gravity filtration, vacuum filtration, filtration using forced air), centrifuging, pressing, or any combination thereof. In some embodiments, precipitation product is separated from precipitation station effluent by flowing precipitation station effluent against a baffle, against which supernatant deflects and separates from particles of precipitation product, which is collected in a collector. In some embodiments, precipitation product is separated from precipitation station effluent by flowing precipitation station effluent in a spiral channel separating particles of precipitation product and collecting the precipitation product in from an array of spiral channel outlets. Mechanically, at least one liquid-solid separation apparatus is operably connected to the precipitation station such that precipitation station effluent may flow from the precipitation station to the liquid-solid separation apparatus (e.g., liquid-solid separation apparatus comprising either a baffle or a spiral channel). The precipitation station effluent may flow directly to the liquid-solid separation apparatus, or the effluent may be pre-treated as described in more detail below.

Energy requirements for any of the foregoing separation approaches may be fulfilled by adapting the approach to utilize any of a number of energy-containing waste streams (e.g., waste heat or waste gas streams) provided by industrial plants; however, it will be appreciated by a person having ordinary skill in the art that separation approaches requiring less energy are desirable in terms of lessening the carbon footprint of the invention.

Apparatus for dewatering mixtures of solids and liquids, such as precipitation product and precipitation station effluent, may employ one or more of the following types of separation: gravity (with or without chemical pre-treatment), mechanical, or thermal. Thermal separation refers to the evaporation off of the liquid portion of the mixture to increase the percentage of the mixture that is solids. Thermal separation may occur before gravity or mechanical separation as a pre-treatment step, or thermal separation may occur after gravity or mechanical separation to bring a mixture to a percent solids value that is suitable for the processing of the solids that is to follow. Apparatus that utilize thermal separation apply heat or radiation to the mixture and drive off the liquid portion of the mixture from the solid portion. The source of the heat or radiation include, but are not limited to: heat of the ambient air; flue gas heat; excess heat from geothermal power plant brines; heat from subterranean brines that are brought to the Earth's surface; solar heat; solar radiation; heat from power plant effluent water; subterranean gas heat; heat from burning municipal waste; heat from other waste sources; or any combination thereof. Dewatering may be done in batch-wise or in continuous manners.

When retention of the liquid component of the mixture of a solid and liquid is not required, utilizing thermal separation may require little more than sufficient area for an evaporation pond. Apparatus that employ thermal separation may employ more elements such as means for conveyance of the mixture of solid particles and liquid through a chamber or area where the temperature is sufficient to cause evaporation of the liquid, heat exchangers, means of introducing or elevating the temperature directly or indirectly, and means of mixing the mixture while evaporation takes place. In cases where recovery of the liquid is desired, the evaporation may take place in a closed volume and condensing apparatus may be employed to recover the vaporized liquid. Spray dryers atomize the mixture of solid particles and liquid and employ heated gas, e.g. air, nitrogen, to increase the evaporation of the liquid as droplets of the mixture pass through the dryer. The temperature of the gas is typically above the boiling point of the liquid of the mixture. The gas of elevated temperature may include industrial waste gas, such as flue gas. The droplet size produced by the atomizing system of the spray dryer may produce droplets ranging in size from 10 to 500 microns in diameter. The atomizing system of a spray drying apparatus may include nozzles, ultrasonic atomizers, and other suitable atomizing equipment that is compatible with the mixture in terms of the abrasiveness of the particles, the pH of the liquid, the temperature of the mixture and other variables that may influence the durability of the equipment.

Screw conveyors are used in applications where it is desirable to move liquids or slurries against gravity and in which pumping may not be an option. Screw conveyor apparatus typically include a center shaft about which the screw turns and to which a motor is connected. The screw is encased in a housing. The housing of the conveyor is usually “u” shaped with material inputs and outlets either at the extremities or along the length of the conveyor. When a damp material or slurry (i.e. a mixture of solid particles and a liquid) is transported using a screw conveyor, drying of the damp material or slurry may simultaneously occur due to the ambient conditions or because of applied heating, such as the application of heated air or the use of heat exchangers, and/or removal of liquid.

Gravity separation may also be referred to as settling. In gravity separation apparatus the Earth's gravity, gravity applied in the form of centripetal acceleration or centrifugal acceleration, or both are used to separate out solid particles from the surrounding liquid. Apparatus that employ gravity separation include, but are not limited to: centrifuges; hydrocyclones; settlers; clarifiers; and a sludge bed clarifier. Gravity separation is typically made easier when the size of the solid particles is increased. Means of increasing the apparent size of particles suspended in a liquid in a mixture include coagulation, flocculation, and methods of crystal growth. Crystal growth may be accelerated or enhanced by the introduction of seeds, nucleation sites, catalysts, agents which adjust the pH to favor growth of the desired crystal, agents which adjust the supersaturation of the solution to favor growth of the desired crystal, or any combination thereof. Coagulation is a process by which small particles, usually colloidal in size (i.e. 1 μm or smaller in diameter), are brought together through the addition of electrolytes to the mixture of the solid particles and liquid, such that the electrolytes reduce the charges on the particles so that the particles may be in closer contact. Flocculation is typically defined as a process whereby small particles or small groups of particles form large aggregates. Flocculation usually occurs with the addition of a flocculant, which may be an electrolyte or a polyelectrolyte. Electrolytes include, but are not limited to, NaCl, KCl; CaCl₂, BaCl₂, Al(NO₃)₃, Al₂(SO₄)₃, K₂SO₄, K₂CrO₄, K₃[Fe(CN)₆], K₄[Fe(CN)₆], or combinations thereof. Flocculants may be non-ionic, anionic, or cationic. Monomers that may be used to make up the polyelectrolytes that are used as flocculants include, but are not limited to: acrylamide, sodium acrylate, and polyquarternary ester. Nonionic polymers used as polyelectrolytes include, but are not limited to, are polyacrylamides and polyethylene oxide. Anionic polymers used as polyelectrolytes include, but are not limited to, acrylamide co-polymer and polyacrylics. Cationic polymers that may be used as polyelectrolytes include, but are not limited to, polyamines and acrylamide co-polymers. In addition to the use of coagulants and flocculants, gentle stirring to promote orthokinetic flocculation may be employed. In crystal growth, coagulation, and flocculation, the formation of larger particles may allow the solids to settle out of the mixture more quickly and thus less time and/or less energy is needed to separate the solid particles from the liquid in the mixture.

The amount of material gravity settlers may be able to separate is often limited by the area of the apparatus. To effectively increase the area of a clarifier, inclined plates may be inserted into a clarifier resulting in a Lamella clarifier/thickener. In a Lamella clarifier/thickener, the mixture, that may have been pretreated with flocculant or coagulant, is fed through the clarifier/thickener such that the liquid flows up through the lamella and the solids slide down the plates. Vibration may be used to increase the sliding of solids down the plates. Changes to the plates may also be made to facilitate the sliding of solids, such as corrugation of the plates. The incline of the plates in a Lamella clarifier/thickener may also be such that the settling rate of the solids in the mixture is optimized. The plates in a Lamella clarifier/thickener may also be replaced by tube bundles, in which case the apparatus is called a “tube settler.” The tubes in a tube settler may be of cross-sections other than rounds, e.g. square or U-shaped. Lamella clarifiers and tube settlers may be used with electrostatic fields to enhance the separation of solids and liquids. Electrophoresis may be used in conjunction with lamella or inclined tubes to hasten the settling time of particles in suspended in liquids.

Apparatus that employ forces other than the Earth's gravity include centrifuges and hydrocyclones. Such apparatus rely on the difference in density between the particles and the liquid to affect the separation, and the shape of the apparatus and angular velocity with which it is rotated can help to determine the cut-off particle size which would be separated from the liquid. Some centrifuge and hydrocyclone apparatus have rigid porous barriers which allow for expulsion of liquid through filtration as well as separation through the usual means of a centrifuge or hydrocyclone and are known as a filter hydrocyclone. Types of centrifuges include continuous type centrifuges, nozzle disk type centrifuges, scroll type centrifuges, and filter centrifuges. In some embodiments, a centrifuge or hydrocyclone that additionally employs a rinsing system to rinse the cake that forms on the apparatus is employed.

In some embodiments, the invention provides a centrifuge that is a scroll type centrifuge which in which a spraying apparatus is located in the center of the centrifuge that after the material has formed a “cake” rinses then dewaters the material repeatedly. Such an embodiment will conserve energy by allowing for the precipitate cake to be rinsed without full dilution of the filter cake.

Physical separation, or mechanical separation, apparatus apply a force, introduce a barrier, or employ both a barrier and a force to separate solid particles from the liquid in a mixture. Barriers can be filters, sieves, perforated plates or walls, or other implements that immobilize the solid particles and allow the liquid to pass through. Filtration occurs primarily through either surface filtration or depth filtration. Surface filtration occurs when a barrier, e.g. a sieve or wire mesh, prevents particles larger than the openings of the barrier from passing through and such particles are retained on the barrier surface. Depth filtration employs the thickness of a barrier in addition to the surface of the barrier with the intent of trapping solids in the voids within the thickness of the barrier and allowing the liquid in a mixture of solid particles and a liquid to pass. There are situations in which both surface filtration and depth filtration take place. When a barrier begins to separate solid particles and a liquid, during which surface filtration occurs, with the formation of additional layers of particles will lead to the formation of a cake. When a cake stands above a barrier, depth filtration occurs through the thickness of the cake. Filters may be characterized by the size of the smallest particle that may be stopped by the filter, by the permeability of the filter, and the amount of solids that accumulate in the filter and the rate of increased resistance to flow of liquid through the filter. The flow of the mixture towards the barrier, and particularly the flow of the liquid portion of the mixture through the barrier may be facilitated by the application of a vacuum or pressure above the mixture. The pressure may be applied by a solid implement, such as a plate or belt pressing upon a layer of the mixture, by a gas, or by hydraulic means in combination with a physical implement. Filter aids are inert aids to separation. Filter aids act to either form a pre-coat on a coarse barrier or mix with the mixture to be separated so as to increase the permeability of the filter cake that forms, or in some cases to filter aids do both. Suitable filter aid materials include diatomaceous earth, expanded perilitic rock, asbestos, cellulose, non-activated carbon, ashes, ground chalk, or a mixture thereof. In some cases, material that is cheap, waste, or otherwise rejected material is used a filter aid material.

Barriers used in surface and cake filtration include, but are not limited to: ceramic rigid porous media, stoneware rigid porous media, sintered metal rigid porous media, sintered woven-wire porous media, plastic rigid porous media, polymer membranes, woven wire, woven metal fabric, wire cloth, wire mesh, supported glass paper, supported cellulose paper, woven fabrics of synthetic fibers (e.g. nylon, polyester, polypropylene, polyethylene), woven fabrics of natural fibers (e.g. wool, cellulose), or any combination thereof.

Apparatus that employ mechanical separation include, but are not limited to: a filter press, a belt press, a vacuum drum, a separating conveyor belt, a vertical press, a centrifuge or hydrocyclone with a rigid perforated wall, and a spraying apparatus. A spraying apparatus may not have a barrier as the other apparatus, however it is a mechanical means of separating the solid particles from the liquid as it forces droplets of the mixture through a volume of air or other gas. During the flight of the droplets through the gas, forces, e.g. frictional forces, separate the liquid from the solid particles. Vibration, intentionally applied or caused by the operation of the apparatus, may aid in the separation of liquid from a mixture of solid particles and a liquid by effectively shaking the liquid free of the solids. Other sources of additional energy that may be used in mechanical separation systems include, but are not limited to, sound waves and radio waves. A separating conveyor belt may be separating by utilizing a woven or porous belt that allows the liquid to be removed from the mixture in addition to taking advantage of vibration. A vacuum drum is a rotating cylinder composed of a rigid, porous material, with a vacuum in the center of the apparatus that allows for surface and subsequently cake filtration. Washing of the cake may occur before the cake is removed from the drum by means of a knife or other similar cutting edge.

In some embodiments, the dewatering apparatus of the invention comprises a gravity separation compartment. In some embodiments, the dewatering apparatus is configured to accept a slurry, or a solid particle and liquid mixture, that includes one or more carbonate compound compositions such that the inlet and separation compartment are resistant to degradation due to constant contact with the carbonate compound composition particulates or the liquid component of the slurry. In some embodiments, the gravity separation compartment utilizes at least one of: a decanting baffle, a Lamella clarifier/thickener, a filter; a clarifier; a sludge bed clarifier; a centrifuge; a hydrocyclone; a flocculant introduction system; a filtering aid introduction system; a coagulant introduction system; or a crystallization accelerant introduction system. In some embodiments, the apparatus for dewatering a solution includes a centrifuge in the gravity separation compartment, in which the centrifuge is a continuous type centrifuge. The continuous type centrifuge may be a nozzle disk type centrifuge or a scroll type centrifuge or a combination of both the nozzle disk type centrifuge and a scroll type centrifuge. In some embodiments, the apparatus for dewatering a solution includes at least one system for creating larger solid particles or agglomerating the solid particles such as a coagulant introduction system, a flocculant introduction system, or a crystallization accelerant introduction system in the gravity separation compartment. In such embodiments, the coagulant introduction system may include inorganic chemicals. In some embodiments, the apparatus for dewatering a solution includes temperature controls, mixing controls, or both types of controls for influencing the contents and/or activities of the systems in the gravity separation compartment. In some embodiments, the apparatus for dewatering a solution includes a hydrocyclone in the gravity separation compartment. In such embodiments, the hydrocyclone may be a filter hydrocyclone. In some embodiments, the apparatus for dewatering a solution includes a Lamella clarifier/thickener in the gravity separation compartment. In such embodiments, the plates of the Lamella clarifier/thickener may be of a material favorable to the sliding downwards of the solid particle portion of the mixture to be separated. In some embodiments, the Lamella clarifier/thickener uses corrugated plates. In some embodiments, vibration is used to help solid particles move down the lamella in the Lamella clarifier/thickener. In some embodiments, the Lamella clarifier/thickener employs tubes and is a tube settler in which the tubes may be round, square, or U-shaped in cross-section. In some embodiments, the tube settler includes tubes with a non-circular cross-section that enhances the settling rate of the solid particles out of the mixture of solid particles and a liquid.

In some embodiments, the dewatering apparatus of the invention comprises a gravity separation compartment and a mechanical separation compartment. In such embodiments, the gravity separation compartment is as described hereinabove and the mechanical separation compartment is as described hereinbelow. In such embodiments in which the dewatering apparatus includes a gravity separation compartment and a mechanical separation compartment, the compartments are connected by any convenient means, e.g. conduit, piping and pumps, conveyor belt, screw conveyor, discrete containers (i.e. buckets) that are filled at one compartment to feed the other compartment or a combination thereof. In some embodiments, the dewatering apparatus of the invention comprises a mechanical separation compartment that includes at least one of: a filter press; a belt press; a vacuum drum; a separating conveyor belt; a vertical press; a spray drying apparatus, or a spraying system. In some embodiments, the dewatering apparatus of the invention includes a spray drying apparatus that is configured to operate at ambient temperature and at the relative humidity of the surrounding atmosphere. In some embodiments, the dewatering apparatus of the invention includes a spray drying apparatus that includes an inlet for gas at a temperature above ambient temperature. In such embodiments, the gas may be air, nitrogen, an inert gas, or industrial waste gas. In embodiments in which the dewatering apparatus of the invention includes a spray drying apparatus that includes an inlet for an industrial waste gas, the industrial waste gas may be effluent gas from the combustion of organic fuel, effluent gas from the burning of fossil fuel, effluent gas from calcinations processes, effluent gas from smelting processes or a combination thereof.

In some embodiments, the dewatering apparatus of the invention comprises a thermal separation compartment, a gravity separation compartment, and a mechanical separation compartment. In such embodiments, in which the dewatering apparatus of the invention comprises a thermal separation compartment, a gravity separation compartment, and a mechanical separation compartment the gravity and mechanical separation compartments are as described hereinabove and the thermal separation compartment may include: an oven, a furnace, a solar concentrator, a heat exchanger in contact with industrial waste gas at a temperature above ambient atmospheric temperature, a heat exchanger in contact with a geological brine at a temperature above ambient atmospheric temperature, a spray drying apparatus, one or more evaporation ponds or pools, a conveyance apparatus that allows direct exposure of the mixture to industrial waste gas at a temperature above that off the ambient atmosphere, or any combination thereof. In embodiments, in which the dewatering apparatus of the invention comprises a thermal separation compartment, a gravity separation compartment, and a mechanical separation compartment the compartments are the compartments are connected by any convenient means, e.g. conduit, piping and pumps, conveyor belt, screw conveyor, discrete containers (i.e. buckets) that are filled at one compartment to feed the other compartment or a combination thereof. In such embodiments, in which the dewatering apparatus of the invention includes thermal, gravity, and mechanical separation compartments, the mixture that is being dewatered may be directed to the compartments in any order as needed to obtain the desired dryness of the mixture, as indicated by the weight percent of the mixture that is solids. For example, the mixture may be initially thickened in the thermal separation compartment, then the mixture is provided to the gravity separation compartment until the mixture attains 30 wt % solids, at which point it is provided to the mechanical separation compartment. Alternatively, the mixture may be initially provided to the gravity separation compartment where it is thickened until the mixture attains 20 wt % solids, when it is provided to the mechanical separation compartment, through which the mixture passes more than once until the mixture is at least 60 wt % solids, at which point the mixture leaves the apparatus. Another alternative scenario is one in which the mixture may be initially provided to the gravity separation compartment where it is thickened until the mixture attains 20 wt % solids, when it is provided to the mechanical separation compartment, through which the mixture passes more than once until the mixture is at least 60 wt % solids, then the mixture is passed to the thermal separation compartment where it remains until the mixture is at least 90 wt % solids.

In some embodiments, the dewatering apparatus of the invention may be a screw apparatus that utilizes an enclosed housing with inlets for hot gas and outlets for cooler gas along the length of the housing, perpendicular to the length of the screw. As the screw conveyor slowly moves material or slurry along, the hot gas contacts the material or slurry, causing some of the liquid to evaporate off. The evaporated liquid and cooler gas leaves the housing of the screw conveyor and is further processed. The material or slurry enters the screw apparatus with a percent solids (by weight) ranging from 10% to 45%. The material leaving the apparatus may be from 45% to more than 90% solids by weight. The material or slurry may be subjected to multiple passes through the screw apparatus to achieve the desired percent solids. Consecutive passes of a material or slurry through the screw apparatus may be applied by having similar apparatus in series, such that the output of the first is the input of the second, and so on, until the desired percent solids is achieved. In such a case, the input gas for all apparatus in the series would be hot gas directly from the gas source. For example, a series of 5 screw apparatus powered by 2 HP motors, turning with a frequency of 14 RPM with a screw diameter of 61 cm (2 feet) and input gas at 176° C. (350° F.) would be able to process 10 tons/hour. Such a system of screw apparatus could also be located on a rail car and transported to facilities as needed.

In some embodiments, the source of hot gas in the dewatering apparatus of the invention is the flue gas from an industrial process, such as the flue gas from a coal-fired power plant. The industrial flue gas may contain carbon dioxide or other pollutant compounds or particulates. Some of those may be incorporated into the material or slurry passing through the screw apparatus as the flue gas passed through and contacted with the material or slurry. In such cases, the gas that leaves the screw apparatus has lost some heat and thus has a reduced temperature, may have a reduced amount of pollutants (e.g. carbon dioxide) and particulate matter (e.g. fly ash), and may have increased moisture content.

In some embodiments, the dewatering apparatus of the invention may be a screw apparatus for dewatering a mixture of a synthetic, carbon dioxide sequestering carbonate compound composition and a supernatant solution that employs thermal separation that has connections that convey gas (e.g. flue gas, hot air) to a flue gas source and to a carbon dioxide sequestering apparatus and that employs a screw conveyor that allows for simultaneous movement of the mixture and exposure of the mixture to the flue gas. In some embodiments, the flue gas source is the flue gas stack of an industrial plant, such as a cement kiln, a fossil fuel burning power plant, an iron or steel smelting plant, or any other industrial plant with hot effluent gas. In some embodiments, the flue gas source is the flue gas stack of a power plant. In some embodiments of the apparatus of the invention, the flue gas source is the flue gas stack of a coal fired power plant. In some embodiments of the apparatus of the invention, the flue gas comprises carbon dioxide that enters the dewatering apparatus at a temperature greater than 100° F. (37.78° C.), such as greater than 110° F. (43.33° C.), such as greater than 120° F. (48.89° C.), such as greater than 130° F. (54.44° C.), such as greater than 140° F. (60.0° C.), such as greater than 150° F. (65.56° C.), such as greater than 160° F. (71.11° C.), such as greater than 170° F. (76.67° C.), such as greater than 180° F. (82.22° C.), such as greater than 190° F. (87.78° C.), such as greater than 200° F. (93.33° C.), such as greater than 210° F. (98.89° C.), such as greater than 212° F. (100.0° C.). In some embodiments, the gas leaving the dewatering screw apparatus is 10° F. (5.56° C.) less than the temperature of the flue gas entering the dewatering screw apparatus. In some embodiments, the gas leaving the dewatering screw apparatus is 20° F. (11.11° C.) less than the temperature of the flue gas entering the dewatering screw apparatus. In some embodiments, the drop in the gas temperature between the flue gas entering the dewatering screw apparatus and the gas leaving the dewatering screw apparatus is more than 20° F. (11.11° C.), such as more than 25° F., such as more than 30° F., such as more than 35° F., such as more than 40° F., such as more than 45° F., such as more than 50° F., such as more than 55° F., such as more than 60° F., such as more than 65° F., such as more than 70° F., such as more than 75° F., such as more than 80° F., such as more than 85° F., such as more than 90° F., such as more than 95° F., such as more than 100° F.

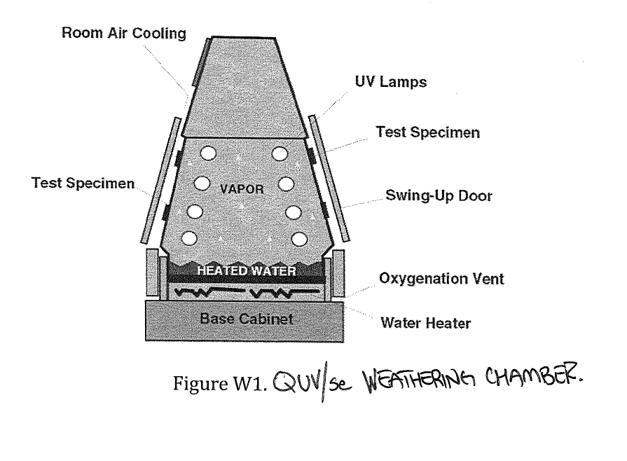

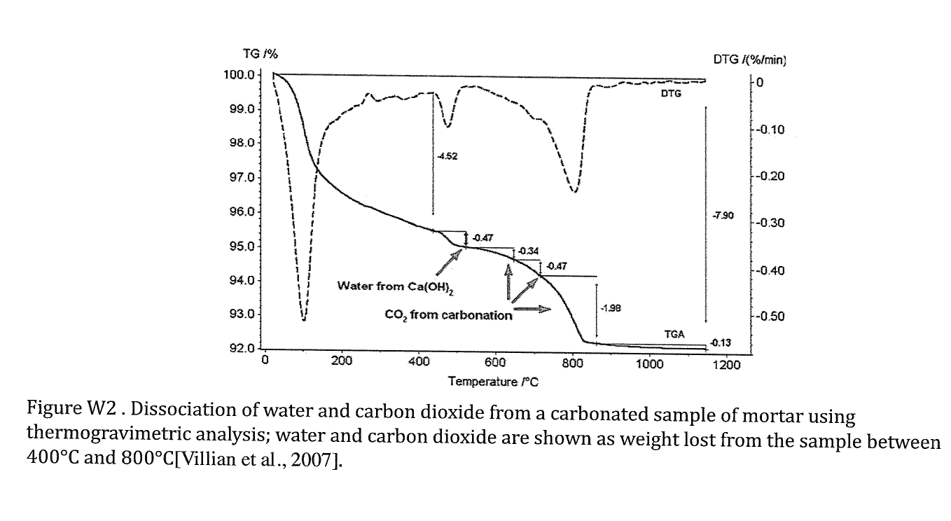

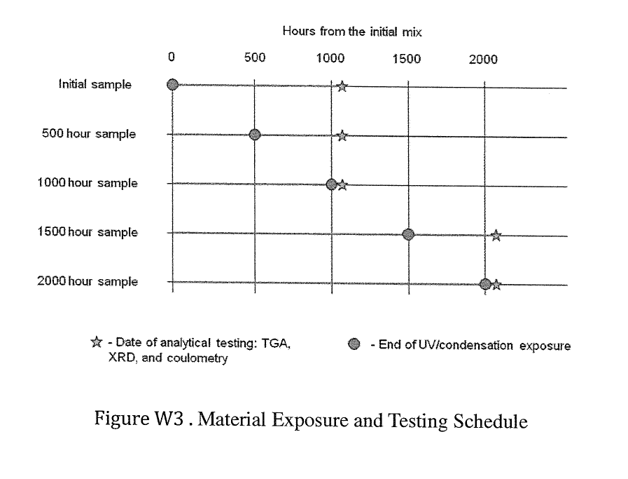

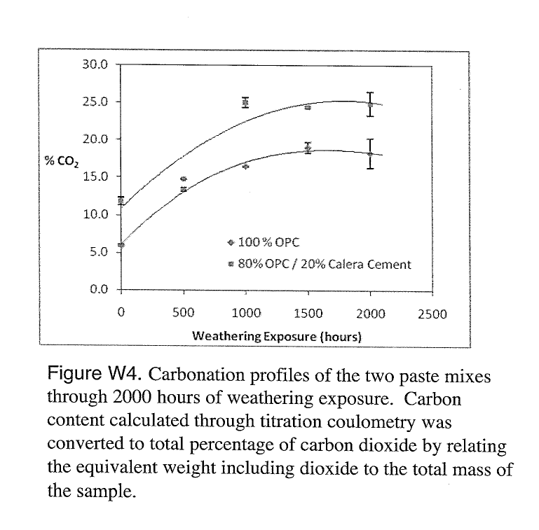

In some embodiments, the dewatering apparatus of the invention may be a screw apparatus (e.g., FIGS. 6-9) for dewatering a mixture of a synthetic, carbon dioxide sequestering carbonate compound composition and a supernatant solution that employs thermal separation that has connections that convey gas (e.g. flue gas, hot air) to a flue gas source and to a carbon dioxide sequestering apparatus and that employs a screw conveyor (e.g., FIG. 7 (looking down on screw conveyor) and FIG. 8 (side view of screw conveyor)) that allows for simultaneous movement of the mixture and exposure of the mixture to the flue gas. FIG. 6 shows the interaction of incoming precipitation material (1), hot flue gas (3), a screw drying apparatus (4), dried precipitation material (6) and the cooler flue gas (5). In some embodiments, the incoming precipitation material (1), is undergoes settling, optionally with precipitate growth (2) before feeding a slurry of precipitate material and supernatant solution to the screw drying apparatus. The slurry may be fed to the screw drying apparatus in any convenient way, including using buckets, using pipes and pumps, using a belt conveyor, or a screw conveyor. The screw drying apparatus (4) takes in hot flue gas (3) from a source such as, but not limited to, a flue stack from a coal burning power plant. After the hot flue gas contacts the precipitation material in the screw drying apparatus, the flue gas is at a lower temperature (i.e. cooled flue gas (5)) that may be depleted in CO₂ and have an increased water or humidity content. In some embodiments, this cooled flue gas is released to the atmosphere. In some embodiments, this cooled flue gas is fed into the apparatus or system that creates the incoming precipitation material (7). In some embodiments, the precipitation material leaves the screw drying apparatus and goes to a system or station for further processing (6).

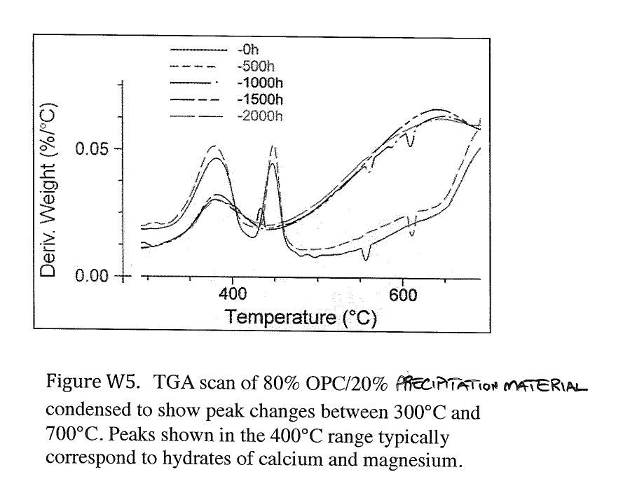

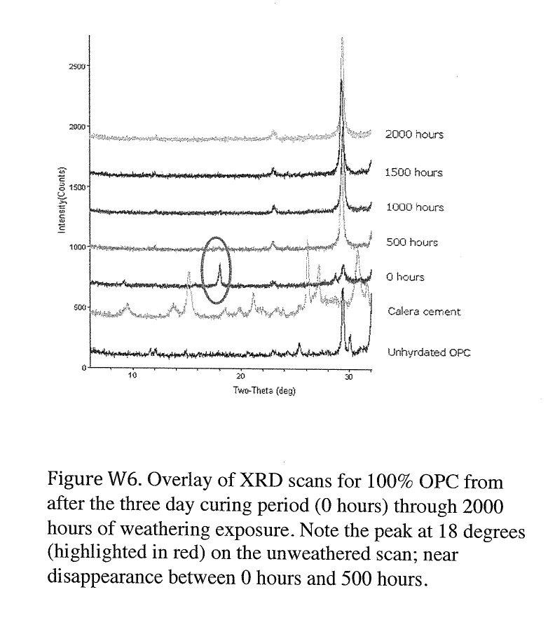

In some embodiments, the screw drying apparatus may include multiple screw conveyors in series. FIG. 9 shows the inlet of damp solids or slurry that include precipitation solids (100) that is fed into the first screw conveyor through a conduit or other suitable conveyance means (110) such as a belt conveyor into the drying screw conveyor (400). Flue gas from an industrial process is collected in a conduit (200) and conveyed into the drying screw conveyor through smaller conduits (210) that are present down the line of the drying screw conveyor. After the flue gas intimately contacts the precipitation material in the drying screw conveyor, the gas leaves through many conduits (310) along the length of the drying screw apparatus and is collected in larger conduits (300) for further processing. After passing through on drying screw conveyor, the material may require further drying for the end use. In that case, the material may be passed to subsequent drying screw conveyors through an opening or conduit (500). In some embodiments, the first drying screw conveyor is located above the subsequent drying screw conveyors. In some embodiments, the material (i.e. slurry or damp material) has the least percent solids at the top of the system or apparatus that includes multiple drying screw conveyors and has the most percent solids at the bottom or the system or apparatus where it is fed to further precipitate processing (510).

In some embodiments, the material, or mixture of solid particles and liquid (i.e. slurry), leaves the dewatering apparatus (e.g., screw apparatus) such that the mixture is at least 35 wt % solids. In some embodiments, the dewatered mixture is at least 40 wt % solids, such as at least 45 wt % solids, such as at least 50 wt % solids, such as at least 55 wt % solids, such as at least 60 wt % solids, such as at least 65 wt % solids, such as at least 70 wt % solids, such as at least 75 wt % solids, such as at least 80 wt % solids, such as at least 85 wt % solids, such as at least 90 wt % solids, such as at least 95 wt % solids. In some embodiments, the mixture enters the dewatering apparatus at one level of solids and leaves the apparatus at a level of solids that is greater than upon entering the apparatus. In some embodiments, the dewatered mixture of solid particles and a liquid is at least 5 wt % more solids than before the mixture entered the apparatus. In some embodiments, the dewatered mixture of solid particles and a liquid is at least 10 wt % more solids than before the mixture entered the apparatus. In some embodiments, the dewatered mixture of solid particles and a liquid is at least 15 wt % more solids, such as at least 20 wt % more solids, such as at least 25 wt % more solids, such as at least 30 wt % more solids, such as at least 35 wt % more solids, such as at least 40 wt % more solids, such as at least 45 wt % more solids, such as at least 50 wt % more solids, such as at least 55 wt % more solids, such as 60 wt % more solids, such as at least 65 wt % more solids, such as at least 70 wt % more solids, such as at least 75 wt % more solids; such as at least 80 wt % more solids, such as at least 85 wt % more solids, such as at least 90 wt % more solids, such as at least 95 wt % more solids, such as at least 100 wt % more solids than before the mixture entered the apparatus.

Dewatering of the mixture or slurry that is provided by the precipitation station, other wise known as concentration and separation of the precipitation product from the precipitation station effluent, may be achieved continuously or batch wise with methods and liquid-solid separation apparatus described in WO 2007/051640 and CA 02628270, the disclosures of which are incorporated herein by reference. In some embodiments, the liquid-solid separation apparatus comprises a container having a funnel shaped section, a precipitation station effluent pipe arranged in the container to extend in a longitudinal direction and opening into the container through an inlet opening for introducing the precipitation station effluent flow falling through the precipitation station effluent pipe, and a removal opening formed at the lower end of the funnel-shaped section for removing separated precipitation product from the container characterized by a baffle arranged in the region of the inlet opening by which the precipitation station effluent flow is deflected. Liquid-solid separators such as Epuramat's Extrem-Separator (“ExSep”) liquid-solid separator, or a modification thereof, are useful in some embodiments for separation of the precipitation product from precipitation station effluent. For an example of a liquid-solid separator useful in some embodiments of the invention, see FIG. 1 the related description in WO 2007/051640, published 10 May 2007, which is incorporated herein by reference.

To separate precipitation product from the water, the precipitation station effluent is introduced in the direction of gravity into a bath, in which precipitation product particles descend under the action of gravity and are removed from the lower region thereof. This removal of the precipitation product particles may be performed continuously or batch-wise. Precipitation station effluent, upon its introduction into the bath, is flowed against a baffle, by which the flow in the bath is deflected. By this process control a hydraulic-physical reaction zone is generated in the region of the inlet opening, in which at least the predominant flow energy of the precipitation station effluent flowing in the direction of gravity is destroyed. Deflecting the precipitation station effluent flow flowing into the precipitation station effluent pipe in a vertical direction favors the separation of the precipitation product particles due to the density differences over the water. On deflecting the precipitation station effluent, the heavier precipitation product particles have a greater tendency to continue their path of motion in the direction of the precipitation station effluent pipe (i.e., in the downward direction, while the water is deflected and, separated from the heavy precipitation product particles, ascends. The destruction of the flow energy is substantially caused by the deflection losses when flowing against the baffle (i.e., in the flow direction of precipitation station effluent flowing through the precipitation station effluent pipe on and predominantly after exiting the precipitation station effluent pipe downstream of the baffle. Precipitation station effluent is particularly deflected in such a way that precipitation product particles (i.e., particles having a higher density than the water, which, generally, are to descend with the container continue their descending motion initiated by the precipitation station effluent pipe during the introduction in to the bath in a substantially undisturbed manner. The deflection should not have the result that the precipitation product particles having higher density, that is, the precipitation product particles have an upwardly directed speed compound imposed on them during the deflection. Such speed component should solely be imposed on the light water during the deflection so that as a result of the deflection at the baffle, the water receives the desired speed component for ascending in the bath.

Alternatively, concentration and separation of the precipitation product from the precipitation station effluent may be achieved continuously or batch wise with methods and liquid-solid separation apparatus described in US 2008/018331, the disclosure of which is incorporated herein by reference. In some embodiments, the liquid-solid separation apparatus comprises an inlet operative to receive precipitation station effluent; a channel operative to allow flow of the precipitation station effluent, the channel being in a spiral configuration; a separating means for separating precipitation product from precipitation station effluent; and at least one outlet for precipitation product-depleted supernatant. Liquid-solid separators such as Xerox PARC's spiral concentrator, or a modification thereof, are useful in some embodiments for separation of the precipitation product from precipitation station effluent.

Precipitation product is separated from the precipitation station effluent based on size and mass separation of precipitation product particles, which are made to flow in a spiral channel. On the spiral sections, the inward directed transverse pressure field from fluid shear competes with the outward directed centrifugal force to allow for separation of precipitation product particles. At high velocity, centrifugal force dominates and precipitation product particles move outward. At low velocities, transverse pressure dominates and the precipitation product particles move inward. The magnitudes of the two opposing forces depend on flow velocity, particle size, radius of curvature of the spiral section, channel dimensions, and viscosity of the precipitation station effluent. At the end of the spiral channel, a parallel array of outlets collects separated particles of precipitation product. For any particle size, the required channel dimension is determined by estimating the transit time to reach the side-wall. This time is a function of flow velocity, channel width, viscosity, and radius of curvature. Larger particles of precipitation product may reach the channel wall earlier than the smaller particles which need more time to reach the side wall. Thus, a spiral channel may have multiple outlets along the channel. This technique is inherently scalable over a large size range from sub-millimeter down to 1 micron.

It may be desirable to pre-treat (e.g., coarse filtration) the precipitation station effluent to remove large-sized particles of precipitation product from the effluent prior to providing the effluent to the liquid-solid separation apparatus as large-sized particles may interfere with the liquid-solid separation apparatus or process. Separation of the precipitation product from the precipitation station effluent may be achieved with a single liquid-solid separation apparatus. In some embodiments, a combination of two, three, four, five, or more than five liquid-solid separation apparatus may be used to separate the precipitation product from the precipitation station effluent. Combinations of liquid-solid separators may be used in series, parallel, or in combination of series and parallel depending on desired throughput. In some embodiments, liquid-solid separation apparatus or combinations thereof are capable of processing precipitation station effluent at 100 L/min to 2,000,000 L/min, 100 L/min to 1,000,000 L/min, 100 L/min to 500,000 L/min, 100 L/min to 250,000 L/min, 100 L/min to 100,000 L/min, 100 L/min to 50,000 L/min, 100 L/min to 25,000 L/min, and 100 L/min to 20,000 L/min. In some embodiments, liquid-solid separation apparatus or combinations thereof are capable of processing precipitation station effluent at 1000 L/min to 2,000,000 L/min, 5000 L/min to 2,000,000 L/min, 10,0000 L/min to 2,000,000 L/min, 20,000 L/min to 2,000,000 L/min, 25,000 L/min to 2,000,000 L/min, 50,000 L/min to 2,000,000 L/min, 100,000 L/min to 2,000,000 L/min, 250,000 L/min to 2,000,000 L/min, 500,000 L/min to 2,000,000 L/min, and 1,000,000 L/min to 2,000,000 L/min. In some embodiments, liquid-solid separation apparatus or combinations thereof are capable of processing precipitation station effluent at 1000 L/min to 20,000 L/min, 5000 L/min to 20,000 L/min, 10,000 L/min to 20,000 L/min, 1000 L/min to 10,000 L/min, 2000 L/min to 10,000 L/min, 3000 L/min to 10,000 L/min, 4000 L/min to 10,000 L/min, 5000 L/min to 10,000 L/min, 6000 L/min to 10,000 L/min, 7000 L/min to 10,000 L/min, 8000 L/min to 10,000 L/min, 9000 L/min to 10,000 L/min, or 9500 L/min to 10,000 L/min.

Combinations of liquid-solid separators in series, parallel, or in combination of series and parallel may also be used to increase separation efficiencies. In addition, the supernatant resulting from one or more liquid-solid separation apparatus may be recirculated through the liquid-solid separation apparatus to increase separation efficiency. In some embodiments, 30% to 100%, 40% to 100%, 50% to 100%, 60% to 100%, 70% to 100%, 75% to 100%, 80% to 100%, 85% to 100%, 90% to 100%, 95% to 100%, 96% to 100%, 97% to 100%, 98% to 100%, 99% to 100% of precipitation product is collected from the precipitation station effluent. Depending on the amount of precipitation product removed from the precipitation station effluent, the supernatant may be delivered back to the precipitation station or provided to an electrolytic cell of the invention. In some embodiments, supernatant with a relatively high concentration of precipitation product is delivered back to the precipitation station for agglomeration of precipitation product particles. In some embodiments, supernatant with a relatively high concentration of dissolved divalent cations (e.g., Ca²⁺or Mg²⁺) is delivered back to the precipitation station as a source of divalent cations. In some embodiments, supernatant with a relatively low concentration of precipitation product and dissolved divalent cations is filtered to remove a substantial amount of the remaining divalent cations and provided to an electrolytic cell of the invention.

This removal of the precipitation product particles may be performed continuously or batch-wise.

In some embodiments the precipitation product is not separated, or is only partially separated, from the precipitation station effluent. In such embodiments, the effluent, including some (e.g., after passing through a liquid-solid separation apparatus) or all of the precipitation product, may be disposed of in any of a number of different ways. In some embodiments, the effluent from the precipitation station, including some or all of the precipitation product, is transported to a land or water location and deposited at the location, Transportation to the ocean is especially useful in embodiments wherein the source of water is seawater. It will be appreciated that the carbon footprint, amount of energy used, and/or amount of CO₂ produced for sequestering a given amount of CO₂ from an industrial exhaust gas is minimized in a process where no further processing beyond disposal occurs with the precipitate.

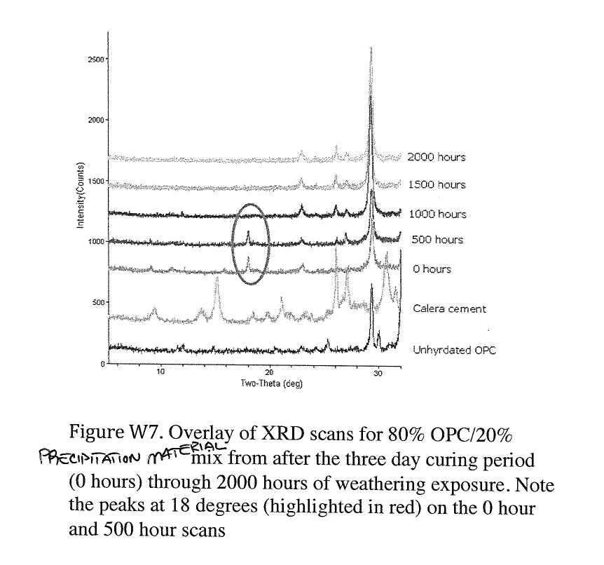

In the embodiment illustrated in FIG. 5, the resultant dewatered precipitate is then dried to produce a product, as illustrated at step 60 of FIG. 5. Drying can be achieved by air drying the filtrate. Where the filtrate is air dried, air drying may be at room or elevated temperature. In certain embodiments, the elevated temperature is provided by the industrial plant gaseous waste stream, as illustrated at step 70 of FIG. 10. In these embodiments, the gaseous waste stream (e.g., flue gas) from the power plant may be first used in the drying step, where the gaseous waste stream may have a temperature ranging from 30 to 700° C., such as 75 to 300° C. The gaseous waste stream may be contacted directly with the wet precipitate in the drying stage, or used to indirectly heat gases (such as air) in the drying stage. The desired temperature may be provided in the gaseous waste stream by having the gas conveyer, e.g., duct, from the industrial plant originate at a suitable location, e.g., at a location a certain distance in the HRSG or up the flue, as determined based on the specifics of the exhaust gas and configuration of the industrial plant. In yet another embodiment, the precipitate is spray dried to dry the precipitate, where the liquid containing the precipitate is dried by feeding it through a hot gas (such as the gaseous waste stream from the industrial plant), e.g., where the liquid feed is pumped through an atomizer into a main drying chamber and hot gas is passed as a co-current or counter-current to the atomizer direction. In certain embodiments, drying is achieved by freeze-drying (i.e., lyophilization), where the precipitate is frozen, the surrounding pressure is reduced and enough heat is added to allow the frozen water in the material to sublime directly from the frozen precipitate phase to gas. Depending on the particular drying protocol of the system, the drying station may include a filtration element, freeze drying structure, spray drying structure, etc.

Where desired, the dewatered precipitate product from the separation reactor 40 may be washed before drying, as illustrated at optional step 50 of FIG. 5. The precipitate may be washed with freshwater, e.g., to remove salts (such as NaCl) from the dewatered precipitate. Used wash water may be disposed of as convenient, e.g., disposing of it in a tailings pond, etc.

In certain embodiments of the invention, the precipitate can be separated, washed, and dried in the same station for all processes, or in different stations for all processes or any other possible combination. For example, in one embodiment, the precipitation and separation may occur in precipitation reactor 20, but drying and washing occur in different reactors. In yet another embodiment, precipitation, separation, and drying may occur all in the precipitation reactor 20 and washing occurring in a different reactor.

Following separation of the precipitate from the mother liquor, also known as the supernatant solution, e.g., as described above, the separated precipitate may be further processed as desired. In certain embodiments, the precipitate may then be transported to a location for long term storage, effectively sequestering CO₂. For example, the precipitate may be transported and placed at long term storage sites, e.g., above ground, below ground, in the deep ocean, etc. as desired.

The dried product may be disposed of in a number of different ways. In certain embodiments, the precipitate product is transported to a location for long term storage, effectively sequestering CO₂ in a stable precipitated product, e.g., as a storage-stable above ground CO₂-sequestering material. For example, the precipitate may be stored at a long term storage site adjacent to the industrial plant and precipitation system. In yet other embodiments, the precipitate may be transported and placed at long term storage sites, e.g., above ground, below ground, etc. as desired, where the long term storage site is distal to the power plant (which may be desirable in embodiments where real estate is scarce in the vicinity of the power plant). In these embodiments where the precipitate is transported to a long term storage site, it may be transported in empty conveyance vehicles (e.g., barges, train cars, trucks, etc.) that were employed to transport the fuel or other materials to the industrial plant and/or precipitation plant. In this manner, conveyance vehicles used to bring fuel to the industrial plant, materials to the precipitation plant (e.g., alkali sources) may be employed to transport precipitated product, and therefore sequester CO₂ from the industrial plant.

In certain embodiments, the composition is disposed of in an underwater location. Underwater locations may vary depending on a particular application. While the underwater location may be an inland underwater location, e.g., in a lake, including a freshwater lake, or interest in certain embodiments are ocean or sea underwater locations. The composition may be still in the mother liquor or supernatant solution, without separation or without complete separation, or the composition may have been separated from the mother liquor (i.e. supernatant solution). The underwater location may be shallow or deep. Shallow locations are locations which are 200 feet or less, such as 150 feet or less, including 1000 feet or less. Deep locations are those that are 200 feet or more, e.g., 500 feet or more, 1000 feet or more, 2000 feet or more, including 5000 feet or more.

Where desired, the compositions made up of the precipitate and the mother liquor (i.e. supernatant solution) may be stored for a period of time following precipitation and prior to disposal. For example, the composition may be stored for a period of time ranging from 1 to 1000 days or longer, such as 1 to 10 days or longer, at a temperature ranging from 1° C. to 40° C., such as 20° C. to 25° C.

Any convenient protocol for transporting the composition to the site of disposal may be employed, and will necessarily vary depending on the locations of the precipitation reactor and site of disposal relative to each other, where the site of disposal is an above ground or below ground site disposal, etc. In certain embodiments, a pipeline or analogous slurry conveyance structure is employed, where these approaches may include active pumping, gravitational mediated flow, etc., as desired.

While in certain embodiments the precipitate is directly disposed at the disposal site without further processing following precipitation, in yet other embodiments the composition may be further processed prior to disposal. For example, in certain embodiments solid physical shapes may be produced from the composition, where the resultant shapes are then disposed of at the disposal site of interest. One example of this embodiment is where artificial reef structures are produced from the carbonate compound compositions, e.g., by placing the flowable composition in a suitable mold structure and allowing the composition to solidify over time into the desired shape. The resultant solid reef structures may then be deposited in a suitable ocean location, e.g., a shallow underwater locations, to produce an artificial reef, as desired.

In certain embodiments, the precipitate produced by the methods of the invention is disposed of by employing it in an article of manufacture. In other words, the product is employed to make a man-made item, i.e., a manufactured item. The product may be employed by itself or combined with one or more additional materials, such that it is a component of the manufactured items. Manufactured items of interest may vary, where examples of manufactured items of interest include building materials and non-building materials, such as non-cementitious manufactured items. Building materials of interest include components of concrete, such as cement, aggregate (both fine and coarse), supplementary cementitious materials, etc. Building materials of interest also include pre-formed building materials.

Where the product is disposed of by incorporating the product in a building material, the CO₂ from the gaseous waste stream of the industrial plant is effectively sequestered in the built environment. Examples of using the product in a building material include instances where the product is employed as a construction material for some type of manmade structure, e.g., buildings (both commercial and residential), roads, bridges, levees, dams, and other manmade structures etc. The building material may be employed as a structure or nonstructural component of such structures. In such embodiments, the precipitation plant may be co-located with a building products factory.

In certain embodiments, the precipitate product is refined (i.e., processed) in some manner prior to subsequent use. Refinement as illustrated in step 80 of FIG. 5 may include a variety of different protocols. In certain embodiments, the product is subjected to mechanical refinement, e.g., grinding, in order to obtain a product with desired physical properties, e.g., particle size, etc. In certain embodiments, the precipitate is combined with a hydraulic cement, e.g., as a supplemental cementitious material, as a sand, a gravel, as an aggregate, etc. In certain embodiments, one or more components may be added to the precipitate, e.g., where the precipitate is to be employed as a cement, e.g., one or more additives, sands, aggregates, supplemental cementitious materials, etc. to produce final product, e.g., concrete or mortar, 90.

In certain embodiments, the carbonate compound precipitate is utilized to produce aggregates. Such aggregates, methods for their manufacture, and use thereof are described in co-pending U.S. patent application Ser. No. 12/475,378, filed 29 May 2008, which is incorporated herein by reference in its entirety.

In certain embodiments, the carbonate compound precipitate is employed as a component of hydraulic cement. The term “hydraulic cement” is employed in its conventional sense to refer to a composition that sets and hardens after combining with water. Setting and hardening of the product produced by combination of the cements of the invention with an aqueous fluid result from the production of hydrates that are formed from the cement upon reaction with water, where the hydrates are essentially insoluble in water. Such carbonate compound component hydraulic cements, methods for their manufacture and use are described in co-pending U.S. patent application Ser. No. 12/126,776, filed 23 May 2008, which is incorporated herein by reference in its entirety.

Also of interest are formed building materials. The formed building materials of the invention may vary greatly. By “formed” is meant shaped, e.g., molded, cast, cut or otherwise produced, into a man-made structure defined physical shape, i.e., configuration. Formed building materials are distinct from amorphous building materials, e.g., particulate (such as powder) compositions that do not have a defined and stable shape, but instead conform to the container in which they are held, e.g., a bag or other container. Illustrative formed building materials include, but are not limited to: bricks; boards; conduits; beams; basins; columns; drywalls; etc. Further examples and details regarding formed building materials include those described in U.S. patent application Ser. No. 12/571,398, filed 30 Sep. 2009, which is incorporated herein by reference in its entirety.

Also of interest are non-cementitious manufactured items that include the product of the invention as a component. Non-cementitious manufactured items of the invention may vary greatly. By non-cementitious is meant that the compositions are not hydraulic cements. As such, the compositions are not dried compositions that, when combined with a setting fluid, such as water, set to produce a stable product. Illustrative compositions include, but are not limited to: paper products; polymeric products; lubricants; asphalt products; paints; personal care products, such as cosmetics, toothpastes, deodorants, soaps and shampoos; human ingestible products, including both liquids and solids; agricultural products, such as soil amendment products and animal feeds; etc. Further examples and details non-cementitious manufactured items include those described in U.S. patent application Ser. No. 12/609,491, filed 30 Oct. 2009, which is incorporated herein by reference in its entirety.

The resultant mother liquor or supernatant solution may also be processed as desired. For example, the mother liquor may (i.e. supernatant solution) be returned to the source of the water, e.g., ocean, or to another location. In certain embodiments, the mother liquor (i.e. supernatant solution) may be contacted with a source of CO₂, e.g., as described above, to sequester further CO₂. For example, where the mother liquor (i.e. supernatant solution) is to be returned to the ocean, the mother liquor may be contacted with a gaseous source of CO₂ in a manner sufficient to increase the concentration of carbonate ion present in the mother liquor. Contact may be conducted using any convenient protocol, such as those described above. In certain embodiments, the mother liquor (i.e. supernatant solution) has an alkaline pH, and contact with the CO₂ source is carried out in a manner sufficient to reduce the pH to a range between 5 and 9, e.g., 6 and 8.5, including 7.5 to 8.2. Accordingly, the resultant mother liquor (i.e. supernatant solution) of the reaction, e.g., mineral carbonate depleted water, may be disposed of using any convenient protocol. In certain embodiments, it may be sent to a tailings pond for disposal. In certain embodiments, it may be disposed of in a naturally occurring body of water, e.g., ocean, sea, lake, or river. In certain embodiments, it may be employed as a coolant for the industrial plant, e.g., by a line running between the precipitation system and the industrial plant. In certain embodiments, it may be employed as grey water, as water input for desalination and subsequent use as fresh water, e.g., in irrigation, for human and animal consumption, etc. Accordingly, of interest are configurations where the precipitation plant is co-located with a desalination plant, such that output water from the precipitation plant is employed as input water for the desalination plant.

As mentioned above, in certain embodiments the mother liquor (i.e. supernatant solution) produced by the precipitation process may be employed to cool the power plant, e.g., in a once through cooling system. In such embodiments, heat picked up in the process may then be recycled back to precipitation plant for further use, as desired. In such embodiments, the initial water source may come from the industrial plant. Such embodiments may be modified to employ pumping capacity provided by the industrial plant, e.g., to increase overall efficiencies.

Where desired and subsequent to the production of a CO₂-sequestering product, e.g., as described above, the amount of CO₂ sequestered in the product is quantified. By “quantified” is meant determining an amount, e.g., in the form of a numeric value, of CO₂ that has been sequestered (i.e., fixed) in the CO₂-sequestering product. The determination may be an absolute quantification of the product where desired, or it may be an approximate quantification, i.e., not exact. In some embodiments, the quantification is adequate to give a market-acceptable measure of the amount of CO₂ sequestered.

The amount of CO₂ in the CO₂-sequestering product may be quantified using any convenient method. In certain embodiments the quantification may be done by actual measurement of the composition. A variety of different methods may be employed in these embodiments. For example, the mass or volume of the composition is measured. In certain embodiments, such measurement can be taken while the precipitate is in the mother liquor. In these cases, additional methods such as X-ray diffraction may be used to quantify the product. In other embodiments, the measurement is taken after the precipitate has been washed and/or dried. The measurement is then used to quantify the amount of CO₂ sequestered in the product, for example, by mathematical calculation. For example, a Coulometer may be used to obtain a reading of the amount of carbon in the precipitated sequestration product. This Coulometer reading may be used to determine the amount of carbonate in the precipitate, which may then be converted into CO₂ sequestered by stoichiometry based on several factors, such as the initial metal ion content of the water, the limiting reagent of the chemical reaction, the theoretical yield of the starting materials of the reaction, waters of hydration of the precipitated products, etc. In some embodiments, contaminants may be present in the product, and other determinations of the purity of the product, e.g., elemental analysis, may be necessary to determine the amount of CO₂ sequestered.

In yet other embodiments, an isotopic method is employed to determine the carbon content of the product. The ratio of carbon isotopes in fossil fuels is substantially different than the ratio of such isotopes in geologic sources such as limestone. Accordingly, the source or ratio of sources of carbon in a sample is readily elucidated via mass spectrometry that quantitatively measures isotopic mass. So even if limestone aggregate is used in concrete (which will increase total carbon determined via coulometry), the utilization of mass spectrometry for isotopic analysis will allow elucidation of the amount of the carbon attributable to captured CO₂ from fossil fuel combustion. In this manner, the amount of carbon sequestered in the precipitate or even a downstream product that incorporates the precipitate, e.g., concrete, may be determined, particularly where the CO₂ gas employed to make the precipitate is obtained from combustion of fossil fuels, e.g., coal. Benefits of this isotopic approach include the ability to determine carbon content of pure precipitate as well as precipitate that has been incorporated into another product, e.g., as an aggregate or sand in a concrete, etc.

In other embodiments, the quantification may be done by making a theoretical determination of the amount of CO₂ sequestered, such as by calculating the amount of CO₂ sequestered. The amount of CO₂ sequestered may be calculated by using a known yield of the above-described method, such as where the yield is known from previous experimentation. The known yield may vary according to a number of factors, including one or more of the input of gas (e.g. CO₂) and water, the concentration of metal ions (e.g., alkaline earth metal ions), pH, salinity, temperature, the rate of the gaseous stream, the embodiment of the method selected, etc., as reviewed above. Standard information, e.g., a predetermined amount of CO₂ sequestered per amount of product produced by a given reference process, may be used to readily determine the quantity of CO₂ sequestered in a given process that is the same or approximately similar to the reference process, e.g., by determining the amount produced and then calculating the amount of CO₂ that must be sequestered therein.

### Systems of CO₂ Sequestration

Aspects of the invention further include systems, e.g., processing plants or factories, for sequestering CO₂, e.g., by practicing methods as described above. Systems of the invention may have any configuration that enables practice of the particular production method of interest.

In some embodiments, the invention provides a system for processing carbon dioxide as shown in FIG. 1A, wherein the system comprises a processor (110) configured for an aqueous-based process for processing carbon dioxide from a source of carbon dioxide (130) using a source of proton-removing agents (140), and wherein the source of carbon dioxide comprises one or more additional components in addition to carbon dioxide. As shown in FIG. 1A, the system may further comprise a source of divalent cations (150) operably connected to the processor. The processor may comprise a contactor such as a gas-liquid or a gas-liquid-solid contactor, wherein the contactor is configured for charging an aqueous solution or slurry with carbon dioxide to produce a carbon dioxide-charged composition, which composition may be a solution or slurry. In some embodiments, the contactor is configured to produce compositions from the carbon dioxide, such as from solvated or hydrated forms of carbon dioxide (e.g., carbonic acid, bicarbonates; carbonates), wherein the compositions comprise carbonates, bicarbonates, or carbonates and bicarbonates. In some embodiments, the processor may further comprise a reactor configured to produce compositions comprising carbonates, bicarbonates, or carbonates and bicarbonates from the carbon dioxide. In some embodiments, the processor may further comprise a settling tank configured for settling compositions comprising precipitation material comprising carbonates, bicarbonates, or carbonates and bicarbonates. As shown in FIG. 1B, the system may further comprise a treatment system (e.g., treatment system 120 of FIG. 1B) configured to concentrate compositions comprising carbonates, bicarbonates, or carbonates and bicarbonates and produce a supernatant; however, in some embodiments the compositions are used without further treatment. For example, systems of the invention may be configured to directly use compositions from the processor (optionally with minimal post-processing) in the manufacture of building materials. In another non-limiting example, systems of the invention may be configured to directly inject compositions from the processor (optionally with minimal post-processing) into a subterranean site as described in U.S. Provisional Patent Application No. 61/232,401, filed 7 Aug. 2009, which is incorporated herein by reference in its entirety. The source of carbon dioxide may be any of a variety of industrial sources of carbon dioxide, including, but not limited to coal-fired power plants and cement plants. The source of proton-removing agents may be any of a variety of sources of proton-removing agents, including, but not limited to, natural sources of proton-removing agents and industrial sources of proton-removing agents (including industrial waste sources). The source of divalent cations may be from any of a variety of sources of divalent cations, including, but not limited to, seawater, brines, and freshwater with added minerals. In such embodiments, the source of divalent cations may be operably connected to the source of proton-removing agents or directly to the processor. In some embodiments, the source of divalent cations comprises divalent cations of alkaline earth metals (e.g., Ca²⁺, Mg⁺).

Systems of the invention such as that shown in FIG. 1A may further comprise a treatment system. As such, in some embodiments, the invention provides a system for processing carbon dioxide as shown in FIG. 1B, wherein the system comprises a processor (110) and a treatment system (120) configured for an aqueous-based process for processing carbon dioxide from a source of carbon dioxide (130) using a source of proton-removing agents (140), and wherein the source of carbon dioxide comprises one or more additional components in addition to carbon dioxide. As with FIG. 1A, the system of FIG. 1B may further comprise a source of divalent cations (150) operably connected to the processor. The processor may comprise a contactor such as a gas-liquid or a gas-liquid-solid contactor, wherein the contactor is configured for charging an aqueous solution or slurry with carbon dioxide to produce a carbon dioxide-charged composition, which composition may be a solution or slurry. In some embodiments, the contactor is configured to produce compositions from the carbon dioxide, such as from solvated or hydrated forms of carbon dioxide (e.g., carbonic acid, bicarbonates, carbonates), wherein the compositions comprise carbonates, bicarbonates, or carbonates and bicarbonates. In some embodiments, the processor may further comprise a reactor configured to produce compositions comprising carbonates, bicarbonates, or carbonates and bicarbonates from the carbon dioxide. In some embodiments, the processor may further comprise a settling tank configured for settling compositions comprising precipitation material comprising carbonates, bicarbonates, or carbonates and bicarbonates. The treatment system may comprise a dewatering system configured to concentrate compositions comprising carbonates, bicarbonates, or carbonates and bicarbonates. The treatment system may further comprise a filtration system, wherein the filtration system comprises at least one filtration unit configured for filtration of supernatant from the dewatering system, filtration of the composition from the processor, or a combination thereof. For example, in some embodiments, the filtration system comprises one or more filtration units selected from a microfiltration unit, an ultrafiltration unit, a nanofiltration unit, and a reverse osmosis unit. In some embodiments, the carbon dioxide processing system comprises a nanofiltration unit configured to increase the concentration of divalent cations in the retentate and reduce the concentration of divalent cations in the retentate. In such embodiments, nanofiltration unit retentate may be recirculated to a processor of the system for producing compositions of the invention. As shown in FIG. 1D, systems of the invention may be further configured to recirculate at least a portion of the supernatant from the treatment system.

Systems such as that shown in FIG. 1C may further comprise a processor (110) comprising a contactor (112) (e.g., gas-liquid contactor, gas-liquid-solid contactor, etc.) and a reactor (114), wherein the processor is operably connected to each of a source of CO₂-containing gas (130), a source of proton-removing agents (140), and a source of divalent cations (150). Such systems of the invention are configured for aqueous-based processing of carbon dioxide from the source of carbon dioxide using both the source of proton-removing agents and the source of divalent cations, wherein the source of carbon dioxide comprises one or more additional components in addition to carbon dioxide. The contactor (112) may be operably connected to each of the source of carbon dioxide (130) and the source of proton-removing agents (140), and the contactor may be configured for charging an aqueous solution or slurry with carbon dioxide to produce a carbon dioxide-charged solution or slurry. In some embodiments, the contactor is configured to charge an aqueous solution with carbon dioxide to produce a substantially clear solution (i.e., substantially free of precipitation material, such as at least 95% or more free). As shown in FIG. 1C, the reactor (114) may be operably connected to the contactor (112) and the source of divalent cations (150), and the reactor may be configured to produce a composition of the invention, wherein the composition is a solution or slurry comprising carbonates, bicarbonates, or carbonates and bicarbonates. In some embodiments, the reactor is configured to receive a substantially clear solution of carbonates, bicarbonates, or carbonates and bicarbonates from the processor and produce a composition comprising precipitation material (e.g., a slurry of carbonates, bicarbonates, or carbonates and bicarbonates of divalent cations). Systems such as the one shown in FIG. 1C may optionally be operably connected to a treatment system, which treatment system may comprise a liquid-solid separator (122) or some other dewatering system configured to treat processor-produced compositions to produce supernatant and concentrated compositions (e.g., concentrated with respect to carbonates and/or bicarbonates, and any other co-products resulting from processing an industrial waste gas stream). The treatment system may further comprise a filtration system, wherein the filtration system comprises at least one filtration unit configured for filtration of supernatant from the dewatering system, filtration of the composition from the processor, or a combination thereof.

In some embodiments, the invention provides a system for processing carbon dioxide as shown in FIG. 1D, wherein the system comprises a processor (110) and a treatment system (120) configured for an aqueous-based process for processing carbon dioxide from a source of carbon dioxide (130) using a source of proton-removing agents (140), wherein the source of carbon dioxide comprises one or more additional components in addition to carbon dioxide, and further wherein the processor and the treatment system are operably connected for recirculating at least a portion of treatment system supernatant. The treatment system of such carbon dioxide-processing systems may comprise a dewatering system and a filtration system. As such, the dewatering system, the filtration system, or a combination of the dewatering system and the filtration system may be configured to provide at least a portion of supernatant to the processor for processing carbon dioxide. Although not shown in FIG. 1D, the treatment system may also be configured to provide at least a portion of supernatant to a washing system configured to wash compositions of the invention, wherein the compositions comprise precipitation material (e.g., CaCO₃, MgCO₃, or combinations thereof). The processor of carbon dioxide-processing systems of the invention may be configured to receive treatment system supernatant in a contactor (e.g., gas-liquid contactor, gas-liquid-solid contactor), a reactor, a combination of the contactor and the reactor, or in any other unit or combination of units in the processor. In some embodiments, the carbon dioxide-processing system is configured to provide at least a portion of the supernatant to a system or process external to the carbon-dioxide processing system. For example, a system of the invention may be operably connected to a desalination plant such that the system provides at least a portion of treatment system supernatant to the desalination plant for desalination.

In some embodiments, the invention provides a system for processing carbon dioxide as shown in FIG. 1E, wherein the system comprises a processor (110) and a treatment system (120) configured for an aqueous-based process for processing carbon dioxide from a source of carbon dioxide (130) using a source of proton-removing agents (140), wherein the source of carbon dioxide comprises one or more additional components in addition to carbon dioxide, wherein the system further comprises an electrochemical system (160), and further wherein the processor, the treatment system, and the electrochemical system are operably connected for recirculating at least a portion of treatment system supernatant. As described above in reference to the treatment system of FIG. 1D, the dewatering system, the filtration system, or a combination of the dewatering system and the filtration system may be configured to provide at least a portion of treatment system supernatant to the processor for processing carbon dioxide. The treatment system may also be configured to provide at least a portion of the treatment system supernatant to the electrochemical system, wherein the electrochemical system may be configured to produce proton-removing agents or effect proton removal. As described in reference to FIG. 1D, the treatment system may also be configured to provide at least a portion of supernatant to a washing system configured to wash compositions of the invention, wherein the compositions comprise precipitation material (e.g., CaCO₃, MgCO₃, or combinations thereof). The processor of carbon dioxide-processing systems of the invention may be configured to receive treatment system supernatant or an electrochemical system stream in a contactor (e.g., gas-liquid contactor, gas-liquid-solid contactor), a reactor, a combination of the contactor and the reactor, or in any other unit or combination of units in the processor. In some embodiments, the carbon dioxide-processing system may be configured to provide at least a portion of the supernatant to a system (e.g., desalination plant) or process (e.g., desalination) external to the carbon-dioxide processing system.

Recirculation of treatment system supernatant is advantageous as recirculation provides efficient use of available resources; minimal disturbance of surrounding environments; and reduced energy requirements, which reduced energy requirements provide for lower (e.g., small, neutral, or negative) carbon footprints for systems and methods of the invention. When a carbon dioxide-processing system of the invention is operably connected to an industrial plant (e.g., fossil fuel-fired power plant such as coal-fired power plant) and utilizes power generated at the industrial plant, reduced energy requirements provided by recirculation of treatment system supernatant provide for a reduced energy demand on the industrial plant. A carbon dioxide-processing system not configured for recirculation (i.e., a carbon-dioxide processing system configured for a once-through process) such as that shown in FIG. 1B, may have an energy demand on the industrial plant of at least 10% attributable to continuously pumping a fresh source of alkalinity (e.g., seawater, brine) into the system. In such an example, a 100 MW power plant (e.g., a coal-fired power plant) would need to devote 10 MW of power to the carbon dioxide-processing system for continuously pumping a fresh source of alkalinity into the system. In contrast, a system configured for recirculation such as that shown in FIG. 1D or FIG. 1E may have an energy demand on the industrial plant of less than 10%, such as less than 8%, including less than 6%, for example, less than 4% or less than 2%, which energy demand may be attributable to pumping make-up water and recirculating supernatant. Carbon dioxide-processing systems configured for recirculation, may, when compared to systems designed for a once-through process, exhibit a reduction in energy demand of at least 2%, such as at least 5%, including at least 10%, for example, at least 25% or at least 50%. For example, if a carbon dioxide-processing system configured for recirculation consumes 9 MW of power for pumping make-up water and recirculating supernatant and a carbon dioxide-processing system designed for a once-through process consumes 10 MW attributable to pumping, then the carbon dioxide-processing system configured for recirculation exhibits a 10% reduction in energy demand. For systems such as those shown in FIGS. 1D and 1E (i.e., carbon dioxide-processing systems configured for recirculation), the reduction in the energy demand attributable to pumping and recirculating may also provide a reduction in total energy demand, especially when compared to carbon dioxide-processing systems configured for once-through process. In some embodiments, recirculation provides a reduction in total energy demand of a carbon dioxide-processing system, wherein the reduction is at least 2%, such as at least 4%, including at least 6%, for example at least 8% or at least 10% when compared to total energy demand of a carbon dioxide-processing system configured for once-through process. For example, if a carbon dioxide-processing system configured for recirculation has a 15% energy demand and a carbon dioxide-processing system designed for a once-through process has a 20% energy demand, then the carbon dioxide-processing system configured for recirculation exhibits a 5% reduction in total energy demand. For example, a carbon dioxide-processing system configured for recirculation, wherein recirculation comprises filtration through a filtration unit such as a nanofiltration unit (e.g., to concentrate divalent cations in the retentate and reduce divalent cations in the permeate), may have a reduction in total energy demand of at least 2%, such as at least 4%, including at least 6%, for example at least 8% or at least 10% when compared to a carbon dioxide-processing system configured for once-through process.

FIG. 10 provides a schematic of a system according to one embodiment of the invention. In FIG. 10, system 100 includes water source 110. In certain embodiments, water source 110 includes a structure having an input for water (e.g., alkaline earth metal ion-containing water), such as a pipe or conduit from an ocean, etc. Where the water source that is processed by the system to produce the precipitate is seawater, the input is in fluid communication with a source of sea water, e.g., such as where the input is a pipe line or feed from ocean water to a land based system or a inlet port in the hull of ship, e.g., where the system is part of a ship, e.g., in an ocean based system.

Also shown in FIG. 10, is CO₂ source 130. This system also includes a pipe, duct, or conduit, which directs CO₂ to system 100. The gaseous waste stream employed in methods of the invention may be provided from the industrial plant to the site of precipitation in any convenient manner that conveys the gaseous waste stream from the industrial plant to the precipitation plant. In certain embodiments, the waste stream is provided with a gas conveyer, e.g., a duct, which runs from a site of the industrial plant, e.g., a flue of the industrial plant, to one or more locations of the precipitation site. The source of the gaseous waste stream may be a distal location relative to the site of precipitation, such that the source of the gaseous waste stream is a location that is 1 mile or more, such as 10 miles or more, including 100 miles or more, from the precipitation location. For example, the gaseous waste stream may have been transported to the site of precipitation from a remote industrial plant via a CO₂ gas conveyance system, e.g., a pipeline. The industrial plant generated CO₂ containing gas may or may not be processed, e.g., remove other components, etc., before it reaches the precipitation site (i.e., a carbonate compound precipitation plant). In yet other instances, source of the gaseous waste stream is proximal to the precipitation site, where such instances may include instances where the precipitation site is integrated with the source of the gaseous waste stream, such as a power plant that integrates a carbonate compound precipitation reactor.

Where desired, a portion of but less than the entire gaseous waste stream from the industrial plant may be employed in precipitation reaction. In these embodiments, the portion of the gaseous waste stream that is employed in precipitation may be 75% or less, such as 60% or less and including 50% and less. In yet other embodiments, substantially the entire gaseous waste stream produced by the industrial plant, e.g., substantially all of the flue gas produced by the industrial plant, is employed in precipitation. In these embodiments, 80% or more, such as 90% or more, including 95% or more, up to 100% of the gaseous waste stream (e.g., flue gas) generated by the source may be employed during precipitation.

As indicated above, the gaseous waste stream may be one that is obtained from a flue or analogous structure of an industrial plant. In these embodiments, a line, e.g., duct, is connected to the flue so that gas leaves the flue through the line and is conveyed to the appropriate location(s) of a precipitation system (described in greater detail below). Depending on the particular configuration of the portion of the precipitation system at which the gaseous waste stream is employed, the location of the source from which the gaseous waste stream is obtained may vary, e.g., to provide a waste stream that has the appropriate or desired temperature. As such, in certain embodiments where a gaseous waste stream having a temperature ranging for 0° C. to 1800° C., such as 60° C. to 700° C. is desired, the flue gas may be obtained at the exit point of the boiler or gas turbine, the kiln, or at any point through the power plant or stack, that provides the desired temperature. Where desired, the flue gas is maintained at a temperature above the dew point, e.g., 125° C., in order to avoid condensation and related complications. Where such is not possible, steps may be taken to reduce the adverse impact of condensation, e.g., employing ducting that is stainless steel, fluorocarbon (such as poly(tetrafluoroethylene)) lined, diluted with water and pH controlled, etc., so the duct does not rapidly deteriorate.

To provide for efficiencies, the industrial plant that generates the gaseous waste stream may be co-located with the precipitation system. By “co-located” is meant that the distances between the industrial plant and precipitation system range from 10 to 500 yards, such as 25 to 400 yards, including 30 to 350 yards. Where desired, the precipitation and industrial plants may be configured relative to each other to minimize temperature loss and avoid condensation, as well as minimize ducting costs, e.g., where the precipitation plant is located within 40 yards of the industrial plant.

Also of interest in certain embodiments is a fully integrated plant that includes an industrial function (such as power generation, cement production, etc.) and a precipitation system of the invention. In such integrated plants, conventional industrial plants and precipitation system, such as described below, are modified to provide for the desired integrated plant. Modifications include, but are not limited to: coordination of stacks, pumping, controls, instrumentation, monitoring, use of plant energy, e.g., steam turbine energy to run portions of the precipitation component, e.g., mechanical press, pumps, compressors, use of heat from cement and/or power plant obtained from steam or heat from air to air heat exchanger, etc.

In certain embodiments, the CO₂-containing gaseous stream may be pretreated or preprocessed (e.g., treated with H₂O₂) prior to contacting it with water, e.g., alkaline earth metal-containing water (e.g., in a charging reactor). Illustrative pretreatment or preprocessing steps may include: temperature modulation (e.g., heating or cooling), decompression, compression, incorporation of additional components (e.g., hydrate promoter gases), oxidation of various components to convert them to forms more amenable to sequestration in a stable form, and the like. In certain embodiments, pretreatment of the gaseous waste stream improves the absorption of components of the CO₂-containing gaseous stream into water, e.g., alkaline earth metal-containing water. An exemplary pretreatment for improving absorption includes subjecting the CO₂-containing gaseous stream to oxidizing conditions.

The water source 110 of FIG. 10 and the CO₂ gaseous stream source 130 are connected to a CO₂ charger in precipitation reactor 120. The precipitation reactor 120 may include any of a number of different design features, such as temperature regulators (e.g., configured to heat the water to a desired temperature), chemical additive components, e.g., for introducing chemical pH elevating agents (such as hydroxides, metal oxides, or fly ash) into the water, electrochemical components, e.g., cathodes/anodes, mechanical agitation and physical stirring mechanisms and components to re-circulate industrial plant flue gas through the precipitation plant. Precipitation reactor 120 may also contain design features that allow for the monitoring of one or more parameters such as internal reactor pressure, pH, precipitate particle size, metal-ion concentration, conductivity and alkalinity of the aqueous solution, and pCO₂. This reactor 120 may operate as a batch process or a continuous process.

Precipitation reactor 120, further includes an output conveyance for mother liquor. In some embodiments, the output conveyance may be configured to transport the mother liquor to a tailings pond for disposal or in a naturally occurring body of water, e.g., ocean, sea, lake, or river. In other embodiments, the systems may be configured to allow for the mother liquor to be employed as a coolant for an industrial plant by a line running between the precipitation system and the industrial plant. In certain embodiments, the precipitation plant may be co-located with a desalination plant, such that output water from the precipitation plant is employed as input water for the desalination plant. The systems may include a conveyance (i.e., duct) where the output water (e.g., mother liquor) may be directly pumped into the desalination plant.

The system illustrated in FIG. 10 further includes a liquid-solid separation apparatus 140 for separating a precipitated carbonate mineral composition from the precipitation system effluent. The liquid-solid separation apparatus may achieve separation of a precipitation product from precipitation system effluent by draining (e.g., gravitational sedimentation of the precipitation product followed by draining), decanting, filtering (e.g., gravity filtration, vacuum filtration, filtration using forced air), centrifuging, pressing, or any combination thereof. In some embodiments, the liquid-solid separation apparatus comprises a baffle, against which precipitation station effluent is flowed to effect precipitation product and supernatant separation. In such embodiments, the liquid-solid separation apparatus may further comprise a collector for collecting precipitation product. A source of liquid-solid separators useful in some embodiments is Epuramat's Extrem-Separator (“ExSep”) liquid-solid separator, or a modification thereof, an embodiment of which is described in International Patent Application Publication WO 2007/051640, published 10 May 2007, which publication is incorporated herein by reference in its entirety. See, for example, FIG. 1 of WO 2007/051640 and the related description, which discloses a liquid-solid separator useful in some embodiments of the invention. In some embodiments, the liquid-solid separation apparatus comprises a spiral channel, into which precipitation station effluent is flowed to effect precipitation product and supernatant separation. In such embodiments, the liquid-solid separation apparatus may further comprise an array of spiral channel outlets for collecting precipitation product. A source of liquid-solid separators useful in some embodiments is Xerox PARC's spiral concentrator, or a modification thereof. At least one liquid-solid separation apparatus is operably connected to the precipitation station such that precipitation station effluent may flow from the precipitation station to the liquid-solid separation apparatus (e.g., liquid-solid separation apparatus comprising either a baffle or a spiral channel). As detailed above, any of a number of different liquid-solid apparatus may be used in combination, in any arrangement (e.g., parallel, series, or combinations thereof), and the precipitation station effluent may flow directly to the liquid-solid separation apparatus, or the effluent may be pre-treated.

The system also includes a washing station, 150, where bulk dewatered precipitate from separation station, 140 is washed, e.g., to remove salts and other solutes from the precipitate, prior to drying at the drying station.

The system further includes a drying station 160 for drying the precipitated carbonate mineral composition produced by the carbonate mineral precipitation station. Depending on the particular drying protocol of the system, the drying station may include a filtration element, freeze drying structure, spray drying structure, etc as described more fully above. The system may include a conveyer, e.g., duct, from the industrial plant that is connected to the dryer so that a gaseous waste stream (i.e., industrial plant flue gas) may be contacted directly with the wet precipitate in the drying stage.

The dried precipitate may undergo further processing, e.g., grinding, milling, in refining station, 180, in order to obtain desired physical properties. One or more components may be added to the precipitate where the precipitate is used as a building material.

The system further includes outlet conveyers, e.g., conveyer belt, slurry pump, that allow for the removal of precipitate from one or more of the following: the reactor, drying station, washing station or from the refining station. The product of the precipitation reaction may be disposed of in a number of different ways. The precipitate may be transported to a long term storage site in empty conveyance vehicles, e.g., barges, train cars, trucks, etc., that may include both above ground and underground storage facilities. In other embodiments, the precipitate may be disposed of in an underwater location. Any convenient protocol for transporting the composition to the site of disposal may be employed. In certain embodiments, a pipeline or analogous slurry conveyance structure may be employed, where these approaches may include active pumping, gravitational mediated flow, etc.

In certain embodiments, the system will further include a station for preparing a building material, such as cement, from the precipitate. This station can be configured to produce a variety of cements, aggregates, or cementitious materials from the precipitate, e.g., as described in co-pending U.S. Patent Application Publication No. 2009/0020044, published 25 Nov. 2008, which is incorporated herein by reference in its entirety.

### Systems of Dewatering

Dewatering systems may combine apparatus that utilize thermal, gravity, and mechanical dewatering. Dewatering systems may categorize the apparatus into stations that accept mixtures of solid particles and a liquid, also known as slurries, and provide dewatered mixtures that include a minimum amount of solid particles expressed as percent solids in weight percent. Primary dewatering separates the solids from the liquid such that the primary dewatered mixture or slurry may be up to about 50 wt % solids, depending upon the primary dewatering system. In one embodiment of the invention, the primary dewatered mixture or slurry may be 30 wt % solids. Depending upon the primary dewatering system, the primary dewatered mixture or slurry may be somewhat more than 30 wt % solids, such as up to 35 wt % 40 wt %, or even 45 wt %. As such, a primary dewatering system may be configured to effect a primary dewatered mixture or slurry comprising up to 5 wt %, 10 wt %, 15 wt %, 20 wt %, 25 wt %, 30 wt %, 35 wt %, 40 wt %, or 45 wt % solids after primary dewatering. Secondary dewatering may take place after primary dewatering (i.e., after dewatering the mixture or slurry to around 30 wt % solids, or sometimes more, such as up to 35 wt % 40 wt %, 45 wt %, etc. solids), and secondary dewatering may be used to effect greater separation of the solids from the liquid such that the secondary dewatered mixture or slurry comprises a greater wt % solids than primary dewatered mixture. The secondary dewatered mixture or slurry may be greater than about 35 wt % solids. As such, a secondary dewatering system may be configured to effect a secondary dewatered mixture or slurry comprising greater than 35 wt %, 40 wt %, 45 wt %, 50 wt %, 55 wt %, 60 wt %, 65 wt % 70 wt %, 75 wt %, 80 wt %, 85 wt % or 90% solids after secondary dewatering. In one embodiment the secondary dewatered mixture is greater than about 90 wt % solids. In some embodiments, the secondary dewatered mixture or slurry may be even greater than 90 wt % solids depending upon the secondary dewatering system used. Further dewatering, which can be ternary, quaternary, etc. or final dewatering separates the solids from the liquid such that the ternary, quaternary, etc. or final dewatered mixture or slurry comprises a greater wt % solids than secondary dewatered mixture.

Systems of the invention may include a primary dewatering station that includes at least one of a decanting baffle, a Lamella clarifier/thickener, a filter, a clarifier, a sludge bed clarifier, a centrifuge, a hydrocyclone, a flocculation system, a filtering aid introduction system, a coagulation system, a crystallization acceleration system, or any other suitable apparatus that is capable of producing a slurry, or mixture of solid particles and liquid, that is at least 30 wt % solids. For example, in some embodiments, systems of the invention may include an Andritz™ centrifuge decanter; a WesTech™ thickener; an Infilco (IDI) Vertical Plates Tower; Lamella™ gravity settler; Multiflo™ clarifier; Epuramat™ gravity clarifier, or some combination thereof.

Systems of the invention may include a secondary dewatering station that includes at least one of a filter press, a belt press, a vacuum drum, a separating conveyor belt, a vertical press, a spray drying apparatus, a vacuum filter, a gas-pressure filter, or any other suitable apparatus that is capable of producing a slurry, or mixture of solid particles and liquid, that is more than 30 wt % solids but less than 90 wt % solids. For example, in some embodiments, systems of the invention may include a WesTech™ filter press; horizontal belt filter; waste heat dehydrator; Veolia INOS filter press; spray dryer, or some combination thereof.

Systems of the invention may include a final dewatering station that includes at least one of at least one evaporation pond, a spray drying apparatus, an oven, a furnace, a solar concentrator, a heat exchanger in contact with industrial waste gas at a temperature above ambient temperature, a heat exchanger in contact with a geological brine at a temperature above ambient temperature, a conveyance apparatus that allows direct exposure of the mixture or slurry to industrial waste gas at a temperature above ambient temperature, or any other suitable apparatus that is capable of producing a slurry, or mixture of solid particles and liquid, that is 90 wt % solids or greater.

Systems of the invention may include a carbonate precipitation apparatus that employs methods and apparatus discussed further herein to produce a mixture composed of a carbonate compound composition and a supernatant solution from reactants including, but not limited to, carbonates, bicarbonates, carbon dioxide, alkaline brines, sea water, alkaline aqueous solutions, and mixtures thereof. In some embodiments, the systems of the invention may include a refining station. In such embodiments, the refining station may include a carbonate compound refining station, a supernatant solution treatment system or both. The carbonate compound refining station may include apparatus for decreasing or increasing the size of the carbonate compound materials provided by the dewatering systems. The carbonate compound refining station may include a building materials fabrication system that includes systems and apparatus to provide at least one of supplementary cementitious material, pozzolan, aggregate, or cement. The supernatant solution treatment system may include at least one of a pH adjustment system, a reverse osmosis apparatus, a nano-filtration apparatus, a forward osmosis apparatus, a micro-filtration apparatus, a membrane distillation apparatus, an electro-dialysis system, or a salt-recovery apparatus.

As indicated above, the system may be present on land or sea. For example, the system may be a land based system that is in a coastal region, e.g., close to a source of seawater, or even an interior location, where water is piped into the system from a salt water source, e.g., ocean. Alternatively, the system may be a water-based system, i.e., a system that is present on or in water. Such a system may be present on a boat, ocean based platform etc., as desired. In certain embodiments, the system may be co-located with an industrial plant at any convenient location. The precipitation plant may be a land-based plant that is co-located with the land-based industrial plant, e.g., in a coastal region, such as close to a source of water (e.g., seawater). Also of interest are interior locations, where water is piped into the system directly from a water source (e.g., an industrial plant, a distal lake, a distal ocean). Alternatively, the precipitation plant may be present on water, e.g., on a barge, boat, ocean based platform etc., as desired, for example where real-estate next to a industrial plant is scarce. In certain embodiments, the precipitation plant may be a mobile plant, such that it is readily co-located with an industrial plant.

Systems of the invention that are co-located with an industrial plant, such as a power plant, may be configured to allow for synchronizing the activities of the industrial plant and precipitation plant. In certain instances, the activity of one plant may not be matched to the activity of the other. For example, the precipitation plant may need to reduce or stop its acceptance of the gaseous waste stream but the industrial plant may need to keep operating. Conversely, situations may arise where the industrial plant reduces or ceases operation and the precipitation plant does not. To address situations where either the precipitation plant or industrial plant may need to reduce or stop its activities, design features that provide for continued operation of one of the co-located plants while the other reduces or ceases operation may be employed, as described in detail above. For example, the systems of the invention may include in certain embodiments, blowers, fans, and/or compressors at various points along the connecting line between the industrial plant and the precipitation plant in order to control the occurrence of backpressure in the ducts that connect the industrial plant to the precipitation plant. In certain embodiments, a gas storage facility may be present between the industrial plant and the precipitation plant. Where desired, the precipitation plant may include emissions monitors to evaluate any gaseous emissions produced by the precipitation plant as required by Air Quality Agencies.

Aspects of the invention include the use of a CO₂ containing industrial plant gaseous waste stream, e.g., an industrial plant flue gas, at one or more stages of a process in which a storage-stable CO₂ containing product is precipitated. As such, the CO₂ containing industrial plant gaseous waste stream is employed in a precipitation process. In embodiments of the invention, the gaseous waste stream is employed at one or more steps of the precipitation process, such as in a precipitation step, e.g., where it is employed to charge water with CO₂, or during a precipitate drying step, e.g., where precipitated carbonate compound is dried, etc.

Where desired, the flue gas from the industrial plant can be re-circulated through the precipitation plant until total adsorption of the remnant CO₂ approaches 100%, or a point of diminishing returns is achieved such that the remaining flue gas can be processed using alternative protocols and/or released into the atmosphere.

As reviewed above, precipitation systems of the invention may be co-located with an industrial plant. An example of such a system is illustrated in FIG. 10. In FIG. 10, flue gas outlet 170 from power plant 200 is used in both the precipitation reactor 120 as the source of CO₂ 130 and the dryer 160 and the source of heat. Where desired, backpressure controls are employed to at least reduce, if not eliminate, the occurrence of backpressure which could arise from directing a portion of, if not all of, the industrial plant gaseous waste stream to the precipitation plant 100. Any convenient manner of controlling backpressure occurrence may be employed. In certain embodiments, blowers, fans, and/or compressors are provided at some point along the connecting line between the industrial plant and precipitation plant. In certain embodiments, the blowers are installed to pull the flue gas into ducts that port the flue gas to the precipitation plant. The blowers employed in these embodiments may be electrically or mechanically driven blowers. In these embodiments, if present at all, backpressure is reduced to a level of 5 inches or less, such as one inch or less. In certain embodiments, a gas storage facility may be present between the industrial plant and the precipitation plant. When present, the gas storage facility may be employed as a surge, shutdown and smoothing system so that there is an even flow of flue gases to the precipitation plant.

Aspects of the invention include synchronizing the activities of the industrial plant and precipitation plant. In certain instances, the activity of one plant may not be matched to the activity of the other. For example, the precipitation plant may need to reduce or stop its acceptance of the gaseous waste stream but the industrial plant may need to keep operating. Conversely, situations may arise where the industrial plant reduces or ceases operation and yet the precipitation plant does not. To address such situations, the plants may be configured to provide for continued operation of one of the co-located plants while the other reduces or ceases operation may be employed. For example, to address the situation where the precipitation plant has to reduce or eliminate the amount of gaseous waste stream it accepts from the industrial plant, the system may be configured so that the blowers and ducts conveying waste stream to the precipitation plant shut off in a controlled sequence to minimize pressure swings and the industrial plant flue acts as a bypass stack for discharge of the gaseous waste stream. Similarly, if the industrial plant reduces or eliminates its production of gaseous waste stream, e.g., the industrial plant is dispatched wholly or partially down, or there is curtailment of industrial plant output under some pre-agreed level, the system may be configured to allow the precipitation plant to continue operation, e.g., by providing an alternate source of CO₂, by providing for alternate heating protocols in the dryer, etc.

Where desired, the precipitation plant may include emissions monitors to evaluate any gaseous emissions produced by the precipitation plant and to make required reports to regulatory agencies, both electronic (typically every 15 minutes), daily, weekly, monthly, quarterly, and annually. In certain embodiments, gaseous handling at the precipitation plant is sufficiently closed that exhaust air from the precipitation plant which contains essentially all of the unused flue gas from the industrial plant is directed to a stack so that required Continuous Emissions Monitoring Systems can be installed in accordance with the statutory and regulatory requirements of the Country, province, state city or other political jurisdiction.

In certain embodiments, the gaseous waste stream generated by the industrial plant and conveyed to the precipitation plant has been treated as required by Air Quality Agencies, so the flue gas delivered to the precipitation plan already meets Air Quality requirements. In these embodiments, the precipitation plant may or may not have alternative treatment systems in place in the event of a shutdown of the precipitation plant. However, if the flue gas delivered to has been only partially treated or not treated at all, the precipitation plant may include air pollution control devices to meet regulatory requirements, or seek regulatory authority to emit partially-treated flue gas for short periods of time. In yet other embodiments, the flue gas is delivered to precipitation plant for all processing. In such embodiments, the system may include a safeguard for the situation where the precipitation plant cannot accept the waste stream, e.g., by ensuring that the pollution controls installed in the industrial plant turn on and control emissions as required by the Air Quality Agencies.

The precipitation plant that is co-located with the industrial plant may be present at any convenient location, be that on land or water. For example, the precipitation plant may be a land-based plant that is co-located with the land-based industrial plant, e.g., in a coastal region, such as close to a source of sea water. Also of interest are interior locations, where water is piped into the system directly from a water source (e.g., an industrial plant, a distal lake, a distal ocean). Alternatively, the precipitation plant may be present on water, e.g., on a barge, boat, ocean based platform etc., as desired, for example where real-estate next to a industrial plant is scarce. In certain embodiments, the precipitation plant may be a mobile plant, such that it is readily co-located with a industrial plant.

As indicated above, of interest in certain embodiments are waste streams produced by integrated gasification combined cycle (IGCC) plants. In these types of plants, the initial fuel, e.g., coal, biomass, etc., is first subjected to a gasification process to produce syngas, which may be shifted, generating amounts of CO₂, CO and H₂. The product of the gasification protocol may be conveyed to the precipitation plant to first remove CO₂, with the resultant CO₂ scrubbed product being returned to a power plant for use as fuel. In such embodiments, a line from the gasification unit of a power plant may be present between a power plant and precipitation plant, and a second return line may be present between the precipitation plant and a power plant to convey scrubbed syngas back to a power plant.

In certain embodiments, the co-located industrial plant and precipitation plant (or integrated plant) is operated with additional CO₂ emission reduction approaches. For example, material handling, vehicles and earthmoving equipment, locomotives, may be configured to use biofuels in lieu of fossil fuels. In such embodiments, the site may include fuel tanks to store the biofuels.

In addition to sequestering CO₂, embodiments of the invention also sequester other components of industrial plant generated gaseous waste streams. For example, embodiments of the invention results in sequestration of at least a portion of one or more of NOx, SOx, VOC, Mercury and particulates that may be present in the waste stream, such that one or more of these products are fixed in the solid precipitate product.

In FIG. 10, precipitation system 100 is co-located with industrial plant 200. However, precipitation system 100 is not integrated with the industrial plant 200. Of further interest in certain embodiments therefore is an integrated facility, which, in addition to an industrial plant, includes power generation, water treatment (seawater desalinization or mineral rich freshwater treatment) and precipitation components' as described in U.S. Patent Application Publication No. 2009/0001020, published 1 Jan. 2009, which is incorporated herein by reference in its entirety. The water source for the precipitation plant may be derived from the waste streams of the water treatment plant. The resultant mother liquor from the carbonate precipitation plant may be used as the feedstock for the water treatment plant. The resultant integrated facility essentially uses fuel, minerals and untreated water as inputs, and outputs energy, a processed industrial product, e.g., cement, clean water, clean air and carbon-sequestering building materials.

### Compositions

Compositions of the invention may be solutions, solids, or multiphasic materials (e.g., slurries) comprising carbonates, bicarbonates, or carbonates and bicarbonates, optionally of divalent cations such as Ca²⁺, Mg²⁺, or combination thereof. The amount of carbon in such compositions (e.g., storage-stable carbon dioxide sequestering products such as precipitation material) produced by methods of the invention may vary. In some embodiments, compositions comprise an amount of carbon (as determined by using protocols described in greater detail below, such as isotopic analysis, e.g., ¹³C isotopic analysis) ranging from 1% to 15% (w/w), such as 5 to 15% (w/w), including 5 to 14% (w/w), 5 to 13% (w/w), 6 to 14% (w/w), 6 to 12% (w/w), and 7 to 12% (w/w), wherein a substantial amount of the carbon may be carbon that originated (as determined by protocols described in greater detail below) in the source of CO₂. In such embodiments, 10 to 100%, such as 50 to 100%, including 90 to 100% of the carbon present in composition (e.g., storage-stable carbon dioxide sequestering products such as precipitation material) is from the source of CO₂ (e.g., industrial waste gas stream comprising carbon dioxide). In some instances, the amount of carbon present in the composition that is traceable to the carbon dioxide source is 50% or more, 60% or more, 70% or more, 80% or more, 90% or more, 95% or more, 99% or more, including 100%.

Compositions of the invention (e.g., precipitation material comprising carbonates, bicarbonates, or carbonates and bicarbonates) may store 50 tons or more of CO₂, such as 100 tons or more of CO₂, including 150 tons or more of CO₂, for instance 200 tons or more of CO₂, such as 250 tons or more of CO₂, including 300 tons or more of CO₂, such as 350 tons or more of CO₂, including 400 tons or more of CO₂, for instance 450 tons or more of CO₂, such as 500 tons or more of CO₂, including 550 tons or more of CO₂, such as 600 tons or more of CO₂, including 650 tons or more of CO₂, for instance 700 tons or more of CO₂, for every 1000 tons of the composition. Thus, in some embodiments, the compositions of the invention (e.g., precipitation material comprising carbonates, bicarbonates, or carbonates and bicarbonates) comprise 5% or more of CO₂, such as 10% or more of CO₂, including 25% or more of CO₂, for instance 50% or more of CO₂, such as 75% or more of CO₂, including 90% or more of CO₂. Such compositions, particularly precipitation material of the invention may be used in the built environment. In some embodiments, the composition may be employed as a component of a manufactured item, such as a building material (e.g., component of a cement, aggregate, concrete, or a combination thereof). The composition remains a storage-stable CO₂-sequestering product, as use of the composition in a manufactured item (such as building material) does not result in re-release of sequestered CO₂. In some embodiments, compositions of the invention (e.g., precipitation material comprising carbonates, bicarbonates, or carbonates and bicarbonates), when combined with Portland cement, may dissolve and combine with compounds of the Portland cement without releasing CO₂.

Accelerated Weathering

There are various forms of accelerated weathering testing, including chemical, moisture, and sunlight. This experiment utilizes the effects of sunlight and condensation to model the response of the cement mixes to their environment. In some embodiments a composition is provided that is a mixture of an industrial waste stream and ordinary Portland cement that is subjected to accelerated weathering testing. In some embodiments, the step of creating such a composition is provided. Industrial waste streams include, but are not limited to: flue gases from industrial processes, waste brines, wastes from mining operations, wastes from petrochemical refining and extraction, and waste from magnesium metal extraction from sea water. In some embodiments the industrial waste stream is a flue gas from an industrial process. In some embodiments, the flue gas is the result of burning fossil fuels. In some embodiments the flue gas from burning fossil fuels contains green house gases, including but not limited to carbon dioxide. In some embodiments, the carbon dioxide of the industrial flue gas is sequestered into a product that is used as a cement additive and mixed with ordinary Portland cement. In some embodiments, the carbon dioxide of the industrial flue gas is sequestered into a product that is used as a cement alternative and mixed with ordinary Portland cement. In some embodiments the cement alternative or cement additive is mixed with ordinary Portland cement according to ASTM standard C 305-06. In some embodiments the ratio between cement alternative/cement additive and ordinary Portland cement is 1:4 by weight. In some embodiments the ratio between cement alternative/cement additive and ordinary Portland cement ranges from 5:95 to 2:3. In some embodiments the ratio between cement alternative/cement additive and ordinary Portland cement ranges from 1:9 to 3:7 by weight. In some embodiments the ratio between cement alternative/cement additive and ordinary Portland cement is 1:3 by weight. In some embodiments the ratio between cement alternative/cement additive and ordinary Portland cement is 3:17 by weight.

The QUV/se environmental chamber will simulate the effects of condensation (dew) and sunlight upon the samples and can be programmed according to many ASTM standards. The specifics of timing and cycles are not defined in this standard and are left up to the user; this experiment will consist of cycles of UV light followed by a cooling/condensation cycle. The cooling/condensation cycle is an important step for cement testing as water content and water exposure during the early curing stages can greatly affect the final physical and chemical properties. The light source consists of eight—4 foot UVA 340 bulbs. The UVA 340 denotes a wavelength of 340 nm which is a good simulation of the most damaging aspect of unfiltered daytime sunlight, i.e. outdoor exposure. Sample layout in respect to the water, heating, and light source is shown in FIG. W1. An initial test was done to examine the device and its ease of use: a preliminary run to make sure the sample holders were adequate, to determine how many tests could be taken from a single holder, and to test that the QUV/se apparatus was in working order.

### Material Analysis

Titration Coulometry

Coulometry is a quantitative examination that is a direct account of carbon content in the paste mixes. Through several steps of chemical reactions with phosphoric and perchloric acid, the amount of carbon is isolated and compared to the initial mass of the sample. Coulometric analysis is a comparison of OPC and precipitation material between 0 and 2000 hours as well as the initial unhydrated powders, testing for the presence of carbon and therefore carbon dioxide. The total amount of carbon is tested and represented as a percentage of the total mass, any change in the percentage of carbon in the material can be more directly linked to a loss of CO₂ back into the atmosphere.

X-Ray Diffraction

X-ray diffraction (XRD) will be a qualitative examination of the chemical structure of the phases present in the paste mixture. XRD identifies material through the focusing of an X-ray beam on a powdered sample and varying the angle between 10 to 80 degrees (for this experiment) off of the horizontal. At certain angles, the intensity of the X-ray beam is focused and results in a peak reading. These peaks are compared, examining the graph at the onset to the graphs at the four time exposure intervals. Since the compounds are in metastable phases and each has a particular pattern, any change in the pattern would correspond to a change in the material (i.e., degradation) and could be potentially be linked to a loss of carbon in the material. This method is readily available at Cal Poly but cannot be easily linked to a quantitative loss of carbon dioxide. One sample will be scanned for both the OPC mixture and the precipitation material at each time interval, as well as the unhydrated powders and the initial mixes.

Thermogravimetric Analysis

Thermogravimetric analysis (TGA) is an analysis of the weight change of a sample as it is heated to an elevated temperature. As the material heats up, all water trapped either through absorption or chemical hydration is driven off and the change in weight is measured to determine the total mass off-gassed from the sample. At higher temperatures more thermodynamically stable gases are released from the material, such as carbon dioxide. This technique gives a finite amount of the carbon dioxide contained within a sample and can be determined as in the dissociation of portlandite-containing mortar (OPC, sand, and water) in FIG. W2. However, further testing is still required as OPC continues to convert to carbonate as it is exposed to air and this must be neglected if any change due to weathering alone is to be determined. TGA is often used specifically in determining hydrations of cement in the presence of calcium carbonate [Dweck et al., 1999] [Ramachandran, V. S., 1988].

In some embodiments, the make-up of the composition containing material that is the product of a carbon sequestration process may not be precisely known based upon the starting materials. Also, the make up of the composition containing material that is the product of a carbon sequestration process may change with exposure to the environment in generally and with exposure to simulated environmental conditions. To determine the changes in the composition containing material that is the product of a carbon sequestration process with exposure to simulated environmental conditions, any suitable method may be used to determine elemental, mineral and moisture make-up. Suitable methods include, but are not limited to: thermogravimetric analysis (TGA), X-ray diffraction (XRD), X-ray fluorescence (XRF), coulometry, mass spectrometry, Raman spectroscopy, secondary electron analysis, and Fourier-transform infrared analysis (FT-IR). In some embodiments, a composition containing material that is the product of a carbon sequestration process is defined by the X-ray diffraction (XRD) pattern of the composition. In some embodiments the XRD pattern shows the presence of ettringite for the composition containing material that is the product of a carbon sequestration process when the composition is first formed, but that aspect of the XRD pattern changes after 500 hours of exposure to simulated environmental effects. In some embodiments a composition containing material that is the product of a carbon sequestration process undergoes an atomic restructuring after 500 hours of exposure to simulated environmental effects. In some embodiments, the restructuring is shown by thermogravimetric analysis (TGA). In some embodiments, the restructuring is shown by XRD. In some embodiments, the composition containing material that is the product of a carbon sequestration process shows an increase of carbon content over time as measured using coulometry.

Testing methods and apparatus for determining the change in cement materials with exposure to simulated environmental conditions are provided in some embodiments. Simulated environmental conditions are meant to represent exposure to ordinary day light, rain, fog, other moisture, and ordinary wear and tear. Simulated environmental conditions include, but are not limited to: humidity, condensation, drying, elevated temperature, freezing, compression, tension, shear forces, ultraviolet radiation or any combination thereof. In some embodiments the exposure to simulated environmental conditions is not constant, but is cyclic. In some embodiments samples are exposed to cycling in humidity and condensation. In some embodiments the overall exposure time is as much as 2,000 hours. In some embodiments, the exposure time to simulated environmental conditions is as great as 5,000 hours. In some embodiments, the exposure time to simulated environmental conditions is as great as 10,000 hours. In some embodiments, the samples of cement materials that have been exposed to simulated environmental conditions are characterized before exposure and every 100 hours. In some embodiments sample characterization is every 168 hours. In some embodiments sample characterization is every 200 hours. In some embodiments sample characterization is every 250 hours. In some embodiments sample characterization is every 500 hours. In some embodiments the composition containing material that is the product of a carbon sequestration process is compared to ordinary Portland cement after exposure to simulated environmental conditions. In some embodiments, the composition containing material that is the product of a carbon sequestration process is compared before and after exposure to simulated environmental conditions at various time points. In some embodiments, the composition containing material that is the product of a carbon sequestration process is compared to ordinary Portland cement before and after exposure to simulated environmental conditions at various time points.

An apparatus to expose cement samples to simulated environmental conditions is provided. In some embodiments, the apparatus is capable of exposing multiple samples simultaneously. In some embodiments, the apparatus is capable of imposing multiple environmental conditions, including, but not limited to: humidity, condensation, drying, elevated temperature, freezing, compression, tension, shear forces, ultraviolet radiation or any combination thereof. In some embodiments, the apparatus fluctuates (i.e. cycles) the simulated environmental conditions. In some embodiments the apparatus is capable of imposing physical constraints on samples to place them in tension, compression, or shear. Any suitable means may be used to achieve constraint, including, but not limited to: clamps, vises, presses or any combination thereof.

Conditions employed to convert CO₂ into carbonates, bicarbonates, or carbonates and bicarbonates may result in one or more additional components and/or co-products (i.e., products produced from the one or more additional components) thereof, wherein such additional components include sulfur oxides (SOx); nitrogen oxides (NOx); carbon monoxide (CO); metals such as antimony (Sb), arsenic (As), barium (Ba), beryllium (Be), boron (B), cadmium (Cd), chromium (Cr), cobalt (Co), copper (Cu), lead (Pb), manganese (Mn), mercury (Hg), molybdenum (Mo), nickel (Ni), radium (R^{a}), selenium (Se), silver (Ag), strontium (Sr), thallium (Tl), vanadium (V), and zinc (Zn); particulate matter; halides; organics; toxic substances; radioactive isotopes, and the like. In some embodiments, such one or more additional components and/or co-products may be part of a solution comprising carbonates, bicarbonates, or carbonates and bicarbonates. In some embodiments, such one or more additional components and/or co-products may be part of precipitation material of the invention by precipitating the one or more additional components and/or co-products along with carbonates, bicarbonates, or carbonates and bicarbonates, by trapping the one or more additional components and/or co-products in precipitation material comprising carbonates, bicarbonates, or carbonates and bicarbonates, or by some combination thereof. In some embodiments, such one or more additional components and/or co-products may be part of a slurry comprising any combination of the foregoing solutions with precipitation material.

Compositions of the invention may comprise sulfates, sulfites, or the like in addition to carbonate and/or bicarbonates. In some embodiments, compositions comprise 70-99.9% carbonates and/or bicarbonates along with 0.05-30% sulfates and/or sulfites. For example, compositions may comprise at least 50%, 55%, 60%, 65%, 70%, 75%, 80%, 85%, 90%, 95%, or 99.9% carbonates and/or bicarbonates. Such compositions may further comprise at least 0.05%, 0.1%, 0.5%, 1.0%, 5.0%, 10%, 15%, 20%, 25%, or 30% sulfates and/or sulfites. In some embodiments, compositions of the invention comprise sulfur-based compounds of calcium, magnesium, or combinations thereof, optionally precipitated or trapped in precipitation material produced from waste gas streams comprising SOx (e.g., SO₂, SO₃, etc.). For example, magnesium and calcium may react to form MgSO₄ and CaSO₄, respectively, as well as other magnesium- and calcium-containing compounds (e.g., sulfites), effectively removing sulfur from the waste gas stream (e.g., flue gas stream) without a desulfurization step such as flue gas desulfurization (“FGD”). In addition, compositions comprising CaSO₄, MgSO₄, and related compounds may be formed without additional release of CO₂. In instances where high levels of sulfur-based compounds (e.g., sulfate) are present, the aqueous solution may be enriched with calcium and/or magnesium so that calcium and/or magnesium are available to form carbonate compounds before, during, or after formation of CaSO₄, MgSO₄, and/or related compounds. In some embodiments, multiple reaction products (e.g., MgCO₃, CaCO₃, CaSO₄, mixtures of the foregoing, and the like) are collected at different stages, while in other embodiments a single reaction product (e.g., precipitation material comprising carbonates, sulfates, etc.) is collected.

Compositions of the invention may comprise nitrates, nitrites, and/or the like. In some embodiments, compositions of the invention comprise such nitrogen-based compounds of calcium, magnesium, or combinations thereof, optionally precipitated or trapped in precipitation material produced from waste gas streams comprising NOx (e.g., NO₂, NO₃, etc.). For example, magnesium and calcium may react to form Mg(NO₃)₂ and Ca(NO₃)₂, respectively, as well as other magnesium- and calcium-containing compounds (e.g., nitrates), effectively removing nitrogen from the waste gas stream (e.g., flue gas stream) without a selective catalytic reduction (“SCR”) step or non-selective catalytic reduction (“NSCR”) step. In addition, compositions comprising Ca(NO₃)₂, Mg(NO₃)₂, and related compounds may be formed without additional release of CO₂. Compositions of the invention may further comprise other components, such as trace metals (e.g., mercury). Using mercury as a non-limiting example of a trace metal, compositions of the invention may comprise elemental mercury)(Hg⁰), mercury salts comprising Hg²⁺ (e.g., HgCl₂, HgCO₃, etc.), mercury salts comprising Hg⁺ (e.g., Hg₂Cl₂, Hg₂CO₃, etc.), mercury compounds comprising Hg²⁺ (e.g., HgO, organomercury compounds, etc.), mercury compounds comprising He (e.g., Hg₂O, organomercury compounds, etc.), particulate mercury (Hg(p)), and the like. In some embodiments, compositions of the invention comprise such mercury-based compounds, optionally precipitated or trapped in precipitation material produced from waste gas streams comprising trace metals such as mercury. In some embodiments, compositions comprise mercury (or another metal) in a concentration of at least 0.1, 0.5, 1, 5, 10, 50, 100, 500, 1,000, 5,000, 10,000 ppb. Mercury may react to form HgCO₃ or Hg₂CO₃ as well as other mercury-containing compounds (e.g., chlorides, oxides), effectively removing mercury from the waste gas stream (e.g., flue gas stream) without a specific or non-specific mercury removal technology. In addition, compositions comprising mercury and/or other trace metals may be formed without additional release of CO₂.

Precipitation material of the invention may comprise several carbonates and/or several carbonate mineral phases resulting from co-precipitation, wherein the precipitation material may comprise, for example, calcium carbonate (e.g., calcite) together with magnesium carbonate (e.g., nesquehonite). Precipitation material may also comprise a single carbonate in a single mineral phase including, but not limited to, calcium carbonate (e.g., calcite), magnesium carbonate (e.g., nesquehonite), calcium magnesium carbonate (e.g., dolomite), or a ferro-carbo-aluminosilicate. As different carbonates may be precipitated in sequence, the precipitation material may be, depending upon the conditions under which it was obtained, relatively rich (e.g., 90% to 95%) or substantially rich (e.g., 95%-99.9%) in one carbonate and/or one mineral phase, or the precipitation material may comprise an amount of other carbonates and/or other mineral phase (or phases), wherein the desired mineral phase is 50-90% of the precipitation material. It will be appreciated that, in some embodiments, the precipitation material may comprise one or more hydroxides (e.g., Ca(OH)₂, Mg(OH)₂) in addition to the carbonates. It will also be appreciated that any of the carbonates or hydroxides present in the precipitation material may be wholly or partially amorphous. In some embodiments, the carbonates and/or hydroxides are wholly amorphous. It will also be appreciated that any of the carbonates or hydroxides present in the precipitation material may be wholly or partially crystalline. In some embodiments, the carbonates and/or hydroxides are wholly crystalline.

While many different carbonate-containing salts and compounds are possible due to variability of starting materials, precipitation material comprising magnesium carbonate, calcium carbonate, or combinations thereof is particularly useful. Precipitation material may comprise two or more different carbonate compounds, three or more different carbonate compounds, four or more different carbonate compounds, five or more different carbonate compounds, etc., including non-distinct, amorphous carbonate compounds. Precipitation material of the invention may comprise compounds having a molecular formulation Xₘ(CO₃)ₙ, wherein X is any element or combination of elements that can chemically bond with a carbonate group or its multiple and m and n are stoichiometric positive integers. In some embodiments, X may be an alkaline earth metal (elements found in column IIA of the periodic table of elements) or an alkali metal (elements found in column IA of the periodic table of elements), or some combination thereof. In some embodiments, the precipitation material comprises dolomite (CaMg(CO₃)₂), protodolomite, huntite (CaMg₃(CO₃)₄), and/or sergeevite (Ca₂Mg₁₁(CO₃)₁₃.H₂O), which are carbonate minerals comprising both calcium and magnesium. In some embodiments, the precipitation material comprises calcium carbonate in one or more phases selected from calcite, aragonite, vaterite, or a combination thereof. In some embodiments, the precipitation material comprises hydrated forms of calcium carbonate (e.g., Ca(CO₃).nH₂O) where there are one or more structural waters in the Molecular formula.) selected from ikaite (CaCO₃.6H₂O), amorphous calcium carbonate (CaCO₃.nH₂O), monohydrocalcite (CaCO₃.H₂O), or combinations thereof. In some embodiments, the precipitation material comprises anhydrous amorphous calcium carbonate. In some embodiments, the precipitation material comprises magnesium carbonate, wherein the magnesium carbonate does not have any waters of hydration. In some embodiments, the precipitation material comprises magnesium carbonate, wherein the magnesium carbonate may have any of a number of different waters of hydration (e.g., Mg(CO₃).nH₂O) selected from 1, 2, 3, 4, or more than 4 waters of hydration. In some embodiments, the precipitation material comprises 1, 2, 3, 4, or more than 4 different magnesium carbonate phases, wherein the magnesium carbonate phases differ in the number of waters of hydration. For example, precipitation material may comprise magnesite (MgCO₃), barringtonite (MgCO₃.2H₂O), nesquehonite (MgCO₃.3H₂O), lansfordite (MgCO₃.5H₂O), and amorphous magnesium carbonate. In some embodiments, precipitation material comprises magnesium carbonates that include hydroxide and waters of hydration such as artinite (MgCO₃.Mg(OH)₂.3H₂O), hydromagnesite (Mg₃(CO₃)₄(OH)₂.3H₂O), or combinations thereof. As such, precipitation material may comprise carbonates of calcium, magnesium, or combinations thereof in all or some of the various states of hydration listed herein. Precipitation rate may also influence the nature of the precipitation material with the most rapid precipitation rate achieved by seeding the solution with a desired phase. Without seeding, rapid precipitation may be achieved by, for example, rapidly increasing the pH of the precipitation reaction mixture, which results in more amorphous constituents. Furthermore, the higher the pH, the more rapid the precipitation, which precipitation results in a more amorphous precipitation material.

In some instances, the amount by weight of calcium carbonate compounds in the precipitation material may exceed the amount by weight of magnesium carbonate compounds in the precipitation material. For example, the amount by weight of calcium carbonate compounds in the precipitation material may exceed the amount by weight magnesium carbonate compounds in the precipitation material by 5% or more, such as 10% or more, 15% or more, 20% or more, 25% or more, 30% or more. In some instances, the weight ratio of calcium carbonate compounds to magnesium carbonate compounds in the precipitation material ranges from 1.5-5 to 1, such as 2-4 to 1, including 2-3 to 1. In some instances, the amount by weight of magnesium carbonate compounds in the precipitation material may exceed the amount by weight of calcium carbonate compounds in the precipitation material. For example, the amount by weight of magnesium carbonate compounds in the precipitation material may exceed the amount by weight calcium carbonate compounds in the precipitation material by 5% or more, such as 10% or more, 15% or more, 20% or more, 25% or more, 30% or more. In some instances, the weight ratio of magnesium carbonate compounds to calcium carbonate compounds in the precipitation material ranges from 1.5-5 to 1, such as 2-4 to 1, including 2-3 to 1.

Precipitation material produced by methods of the invention may comprise carbonate compounds that, upon combination with fresh water, dissolve the initial precipitation material to produce a fresh water precipitation material comprising carbonate compounds that are more stable in the fresh water than the carbonate compounds of the initial precipitation material. (Although the carbonate compounds of the initial precipitation material may dissolve upon combination with fresh water, a new composition is produced. Thus, CO₂ gas is not liberated in significant amounts, or in some cases, at all, in any such reaction.) The carbonate compounds of the initial precipitation material may be compounds that are more stable in salt water than they are in fresh water, such that the carbonate compounds may be viewed as metastable in salt water. The amount of carbonate in precipitation material, as determined by coulometric titration, may be 40% or higher, such as 70% or higher, including 80% or higher.

Adjusting major ion ratios during precipitation may influence the nature of the precipitation material. Major ion ratios have considerable influence on polymorph formation. For example, as the magnesium:calcium ratio in the water increases, aragonite becomes the major polymorph of calcium carbonate in the precipitation material over low-magnesium calcite. At low magnesium:calcium ratios, low-magnesium calcite becomes the major polymorph. In some embodiments, where Ca²⁺ and Mg²⁺ are both present, the ratio of Ca²⁺ to Mg²⁺ (i.e., Ca²⁺:Mg²⁺) in the precipitation material is between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, in some embodiments, the ratio of Ca²⁺ to Mg²⁺ in the precipitation material is between 1:1 and 1:10; 1:5 and 1:25; 1:10 and 1:50; 1:25 and 1:100; 1:50 and 1:500; or 1:100 and 1:1000. In some embodiments, the ratio of Mg²⁺ to Ca²⁺ (i.e., Mg²⁺:Ca^{2÷}) in the precipitation material is between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, in some embodiments, the ratio of Mg²⁺ to Ca²⁺ in the precipitation material is between 1:1 and 1:10; 1:5 and 1:25; 1:10 and 1:50; 1:25 and 1:100; 1:50 and 1:500; or 1:100 and 1:1000.

Due to variability of starting materials, carbonate-containing salts and compounds comprising counterions other than calcium or magnesium are possible. For example, in some embodiments, compositions of the invention (e.g., precipitation material) comprise calcium carbonate in the form of aragonite. In such embodiments, calcium may be replaced by a number of different metals including, but not limited to strontium, lead, and zinc, each of which, in one form or another, may be found in one or more starting materials (e.g., waste gas stream, source of proton-removing agents, source of divalent cations, etc.) of the invention. Compositions may comprise, for example, mossottite, which is aragonite rich in strontium, or compositions may comprise a mixture of aragonite and strontianite (e.g., (Ca,Sr)CO₃). Compositions may comprise, for example, tarnowitzite, which is aragonite rich in lead, or compositions may comprise a mixture of aragonite and cerussite (e.g., (Ca,Pb)CO₃). Compositions may comprise, for example, nicholsonite, which is aragonite rich in Zn, or compositions may comprise a mixture of aragonite and smithsonite (e.g., (Ca,Zn)CO₃). In view of the foregoing exemplary embodiments, compositions (e.g., precipitation material) may comprise carbonates, bicarbonates, or carbonates and bicarbonates of As, Ag, Ba, Be, Cd, Co, Cr, Cu, Hg, Mo, Ni, Pb, Se, Sb, Ti, V, or Zn. By way of example, compositions of the invention may comprise carbonates of Ag, Ba, Be, Cd, Co, Cu, Ni, Pb, Tl, Zn, or combinations thereof. Carbonates, bicarbonates, or carbonates and bicarbonates of the foregoing metals may be independently formed (e.g., strontianite) or exist in a magnesium and/or calcium matrix (e.g., mossottite). Metals such as As, Ag, Ba, Be, Cd, Co, Cr, Cu, Hg, Mo, Ni, Pb, Se, Sb, Tl, V, and Zn may be provided by a waste gas stream, a source of proton-removing agents, a source of divalent cations, or a combination thereof. Metals and other components found in such source (e.g., waste gas streams, sources of proton-removing agents, sources of divalent cations) that do not form carbonates, bicarbonates, or carbonates and bicarbonates may be trapped in or adsorbed on precipitation material.

A composition of the invention might contain, in one form or another, metals such as As, Ag, Ba, Be, Cd, Co, Cr, Cu, Hg, Mo, Ni, Pb, Se, Sb, Tl, V, Zn, or combinations thereof, as well as other chemical species that might be considered contaminants if released into the environment. Potential for release of such contaminants into the environment may be tested by mixing the composition with an extraction solution and then agitating the resultant mixture. Compositions of the invention may be tested using any of a variety of tests as different tests have been developed to simulate different environmental conditions. Such tests include, but are not limited to, Toxicity Characteristic Leaching Procedure (TCLP; US EPA Method 1311), Extraction Procedure Toxicity Test (EP-Tox; US EPA Method 1310), Synthetic Precipitation Leaching Procedure (SPLP; US EPA Method 1312), California Waste Extraction Test (WET; California Code of Regulations), Soluble Threshold Limit Concentration (STLC; California Code of Regulations), American Society for Testing and Materials Extraction Test (ASTM D 3987-85), and Multiple Extraction Procedure (MEP; US EPA Method 1320), as well as regulatory water extraction test conditions as defined by waste control regulations in, for example, the United Kingdom, Thailand, Japan, Switzerland, Germany, Sweden, the Netherlands. Such tests may differ in, for example, extraction solutions, liquid to solid (L/S) ratios, and/or number and duration of extractions. Regarding extract solutions, such tests commonly use aqueous acetic acid, aqueous citric acid, distilled water, synthetic rainwater, or carbonated water.

The Code of Federal Regulations (see 40 C.F.R. §261.24) contains a list of contaminants and their associated maximum allowable concentrations in a TCLP extract from a solid or multiphasic material (e.g., slurry) such as a composition of the invention. If a contaminant (e.g., mercury) exceeds its maximum allowable concentration in a TCLP (Method 1311 in “Test Methods for Evaluating Solid Waste, Physical/Chemical Methods,” EPA Publication SW-846, which is incorporated herein by reference in its entirety) extract of a material, then the material may be considered hazardous due to the characteristic of toxicity. For instance, material containing certain leachable heavy metals may be classified as hazardous material if TCLP extracts have concentrations above threshold values for those heavy metals, which threshold values range from 0.2 mg/L (or ppm) for Hg and 100 mg/L for Ba. For example, if a TCLP analysis provides more than 0.2 mg/L mercury in an extract, then the material may be classified as hazardous material with respect to mercury. Likewise, if a TCLP analysis provides more than 100 mg/L barium in an extract, then the material may be classified as hazardous material with respect to barium. The 40 C.F.R. §261.24 includes, but is not limited to, As, Cd, Cr, Hg, and Pb, each of which might be found in waste gas streams resulting from combustion of fossil fuels (e.g., coal), and each of which, in one form or another, might be incorporated in compositions of the invention. The list also includes a number of contaminants that might be present in industrial waste sources of divalent cations and/or proton-removing agents, which contaminants, in one form or another, might be incorporated in compositions of the invention. For example, fly ash, which may be a source of divalent cations and/or proton-removing agents, might contain As, Ba, Cd, Cr, Se, and/or Hg, each of which is found on the list, and each of which, in one form or another, might be incorporated in compositions of the invention. In another non-limiting example, red mud, which may be a source of divalent cations and/or proton-removing agents, might contain Cr, Ba, Pb, and/or Zn, each of which is found on the list in 40 C.F.R. §261.24, and each of which, in one form or another, might be incorporated in compositions of the invention.

As such, in some embodiments, a composition of the invention comprises contaminants predicted not to leach into the environment by one or more tests selected from the group consisting of Toxicity Characteristic Leaching Procedure, Extraction Procedure Toxicity Test, Synthetic Precipitation Leaching Procedure, California Waste Extraction Test, Soluble Threshold Limit Concentration, American Society for Testing and Materials Extraction Test, and Multiple Extraction Procedure. Tests and combinations of tests may be chosen depending upon likely contaminants and storage conditions of the composition. For example, in some embodiments, the composition may comprise As, Cd, Cr, Hg, and Pb (or products thereof), each of which might be found in a waste gas stream of a coal-fired power plant. Since TCLP tests for As, Ba, Cd, Cr, Pb, Hg, Se, and Ag, TCLP may be an appropriate test for solid and multiphasic compositions stored in the environment (e.g., built environment). In some embodiments, a composition of the invention comprises As, wherein the composition is predicted not to leach As into the environment. For example, a TCLP extract of the composition may provide less than 5.0 mg/L As indicating that the composition is not hazardous with respect to As. In some embodiments, a composition of the invention comprises Cd, wherein the composition is predicted not to leach Cd into the environment. For example, a TCLP extract of the composition may provide less than 1.0 mg/L Cd indicating that the composition is not hazardous with respect to Cd. In some embodiments, a composition of the invention comprises Cr, wherein the composition is predicted not to leach Cr into the environment. For example, a TCLP extract of the composition may provide less than 5.0 mg/L Cr indicating that the composition is not hazardous with respect to Cr. In some embodiments, a composition of the invention comprises Hg, wherein the composition is predicted not to leach Hg into the environment. For example, a TCLP extract of the composition may provide less than 0.2 mg/L Hg indicating that the composition is not hazardous with respect to Hg. In some embodiments, a composition of the invention comprises Pb, wherein the composition is predicted not to leach Pb into the environment. For example, a TCLP extract of the composition may provide less than 5.0 mg/L Pb indicating that the composition is not hazardous with respect to Pb. In some embodiments, a composition of the invention may be non-hazardous with respect to a combination of different contaminants in a given test. For example, the composition may be non-hazardous with respect to all metal contaminants in a given test. A TCLP extract of a composition, for instance, may be less than 5.0 mg/L in As, 100.0 mg/L in Ba, 1.0 mg/L in Cd, 5.0 mg/mL in Cr, 5.0 mg/L in Pb, 0.2 mg/L in Hg, 1.0 mg/L in Se, and 5.0 mg/L in Ag. Indeed, a majority if not all of the metals tested in a TCLP analysis on a composition of the invention may be below detection limits. In some embodiments, a composition of the invention may be non-hazardous with respect to all (e.g., inorganic, organic, etc.) contaminants in a given test. In some embodiments, a composition of the invention may be non-hazardous with respect to all contaminants in any combination of tests selected from the group consisting of Toxicity Characteristic Leaching Procedure, Extraction Procedure Toxicity Test, Synthetic Precipitation Leaching Procedure, California Waste Extraction Test, Soluble Threshold Limit Concentration, American Society for Testing and Materials Extraction Test, and Multiple Extraction Procedure. As such, compositions of the invention may effectively sequester CO₂ (e.g., as carbonates, bicarbonates, or a combinations thereof) along with various chemical species (or co-products thereof) from waste gas streams, industrial waste sources of divalent cations, industrial waste sources of proton-removing agents, or combinations thereof that might be considered contaminants if released into the environment. Compositions of the invention incorporate environmental contaminants (e.g., metals and co-products of metals such as Hg, Ag, As, Ba, Be, Cd, Co, Cr, Cu, Mn, Mo, Ni, Pb, Sb, Se, Tl, V, Zn, or combinations thereof) in a non-leachable form.

In some embodiments, the invention provides a method of treating a waste gas stream comprising carbon dioxide and, optionally, any of a number of solid, liquid, or multiphasic waste streams, to produce a composition that provides a leachate in compliance with the TCLP protocol. In such embodiments, the composition provides less than 0.05 mg/L, 0.50 mg/L, 5.0 mg/L, 50 mg/L, or 500 mg/L As in the leachate provided by the TCLP procedure. Alternatively, or in addition, the composition provides less than 1.00 mg/L, 10.0 mg/L, 100 mg/L, 1,000 mg/L, or 10,000 mg/L Ba in the leachate provided by the TCLP procedure. Alternatively, or in addition, the composition provides less than 0.01 mg/L, 0.10 mg/L, 1.0 mg/L, 10 mg/L, or 100 mg/L Cd in the leachate provided by the TCLP procedure. Alternatively, or in addition, the composition provides less than 0.05 mg/L, 0.50 mg/L, 5.0 mg/L, 50 mg/L, or 500 mg/L Pb in the leachate provided by the TCLP procedure. Alternatively, or in addition, the composition provides less than 0.002 mg/L, 0.02 mg/L, 0.20 mg/L, 2.0 mg/L, or 20 mg/L Hg in the leachate provided by the TCLP procedure. Alternatively, or in addition, the composition provides less than 0.01 mg/L, 0.10 mg/L, 1.0 mg/L, 10 mg/L, or 100 mg/L Se in the leachate provided by the TCLP procedure. Alternatively, or in addition, the composition provides less than 0.05 mg/L, 0.50 mg/L, 5.0 mg/L, 50 mg/L, or 500 mg/L Ag in the leachate provided by the TCLP procedure. Such compositions of the invention, as described herein, are suitable for building products and the like.

Precipitation material, which comprises one or more synthetic carbonates derived from industrial CO₂, reflects the relative carbon isotope compdsition (δ¹³C) of the fossil fuel (e.g., coal, oil, natural gas, or flue gas) from which the industrial CO₂ (from combustion of the fossil fuel) was derived. The relative carbon isotope composition (δ¹³C) value with units of ‰ (per mille) is a measure of the ratio of the concentration of two stable isotopes of carbon, namely ¹²C and ¹³C, relative to a standard of fossilized belemnite (the PDB standard).

δ¹³C‰=[(¹³C/¹²C sample−¹³C/¹²C_{PDB standard})/(¹³C/¹²C_{PDB standard})]×1000

As such, the δ¹³C value of the synthetic carbonate-containing precipitation material serves as a fingerprint for a CO₂ gas source. The δ¹³C value may vary from source to source (i.e., fossil fuel source), but the δ¹³C value for composition of the invention generally, but not necessarily, ranges between −9‰ to −35‰. In some embodiments, the δ13C value for the synthetic carbonate-containing precipitation material is between −1‰ and −50‰, between −5‰ and −40‰, between −5‰ and −35‰, between −7‰ and −40‰, between −7‰ and −35‰, between −9‰ and −40‰, or between −9‰ and −35‰. In some embodiments, the δ¹³C value for the synthetic carbonate-containing precipitation material is less than (i.e., more negative than) −3‰, −5‰, −6‰, −7‰, −8‰, −9‰, −10‰, −11‰, −12‰, −13‰, −14‰, −15‰, −16‰, −17‰, −18‰, −19‰, −20‰, −21‰, −22‰, −23‰, −24‰, −25‰, −26‰, −27‰, −28‰, −29‰, −30‰, −31‰, −32‰, −33‰, −34‰, −35‰, −36‰, −37‰, −38‰, −39‰, −40‰, −41‰, −42‰, −43‰, −44‰, or −45‰, wherein the more negative the δ¹³C value, the more rich the synthetic carbonate-containing composition is in ¹²C. Any suitable method may be used for measuring the δ¹³C value, methods including, but no limited to, mass spectrometry or off-axis integrated-cavity output spectroscopy (off-axis ICOS).

In addition to magnesium- and calcium-containing products of the precipitation reaction, compounds and materials comprising silicon, aluminum, iron, and others may also be prepared and incorporated within precipitation material with methods and systems of the invention. Precipitation of such compounds in precipitation material may be desired to alter the reactivity of cements comprising the precipitation material resulting from the process, or to change the properties of cured cements and concretes made from them. Material comprising metal silicates may be added to the precipitation reaction mixture as one source of these components, to produce carbonate-containing precipitation material which contains one or more components, such as amorphous silica, amorphous aluminosilicates, crystalline silica, calcium silicates, calcium alumina silicates, etc. In some embodiments, the precipitation material comprises carbonates (e.g., calcium carbonate, magnesium carbonate) and silica in a carbonate:silica ratio between 1:1 and 1:1.5; 1:1.5 and 1:2; 1:2 and 1:2.5; 1:2.5 and 1:3; 1:3 and 1:3.5; 1:3.5 and 1:4; 1:4 and 1:4.5; 1:4.5 and 1:5; 1:5 and 1:7.5; 1:7.5 and 1:10; 1:10 and 1:15; 1:15 and 1:20, or a range thereof. For example, in some embodiments, the precipitation material comprises carbonates and silica in a carbonate:silica ratio between 1:1 and 1:5, 1:5 and 1:10, or 1:5 and 1:20. In some embodiments, the precipitation material comprises silica and carbonates (e.g., calcium carbonate, magnesium carbonate) in a silica:carbonate ratio between 1:1 and 1:1.5; 1:1.5 and 1:2; 1:2 and 1:2.5; 1:2.5 and 1:3; 1:3 and 1:3.5; 1:3.5 and 1:4; 1:4 and 1:4.5; 1:4.5 and 1:5; 1:5 and 1:7.5; 1:7.5 and 1:10; 1:10 and 1:15; 1:15 and 1:20, or a range thereof. For example, in some embodiments, the precipitation material comprises silica and carbonates in a silica:carbonate ratio between 1:1 and 1:5, 1:5 and 1:10, or 1:5 and 1:20. In general, precipitation material produced by methods of the invention comprises mixtures of silicon-based material and at least one carbonate phase. In general, the more rapid the reaction rate, the more silica is incorporated with the carbonate-containing precipitation material, provided silica is present in the precipitation reaction mixture (i.e., provided silica was not removed after digestion of material comprising metal silicates).

Precipitation material may be in a storage-stable form (which may simply be air-dried precipitation material), and may be stored above ground under exposed conditions (i.e., open to the atmosphere) without significant, if any, degradation (or loss of CO₂) for extended durations. In some embodiments, the precipitation material may be stable under exposed conditions for 1 year or longer, 5 years or longer, 10 years or longer, 25 years or longer, 50 years or longer, 100 years or longer, 250 years or longer, 1000 years or longer, 10,000 years or longer, 1,000,000 years or longer, or even 100,000,000 years or longer. A storage-stable form of the precipitation material may be stable under a variety of different environment conditions, for example, from temperatures ranging from −100° C. to 600° C. and humidity ranging from 0 to 100%, where the conditions may be calm, windy, or stormy. As the storage-stable form of the precipitation material undergoes little if any degradation while stored above ground under normal rainwater pH, the amount of degradation, if any, as measured in terms of CO₂ gas release from the product, does not exceed 5% per year, and in certain embodiments will not exceed 1% per year or 0.001% per year. Indeed, precipitation material provided by the invention does not release more than 1%, 5%, or 10% of its total CO₂ when exposed to normal conditions of temperature and moisture, including rainfall of normal pH for at least 1, 2, 5, 10, or 20 years, or for more than 20 years, for example, for more than 100 years. In some embodiments, the precipitation material does not release more than 1% of its total CO₂ when exposed to normal conditions of temperature and moisture, including rainfall of normal pH for at least 1 year. In some embodiments, the precipitation material does not release more than 5% of its total CO₂ when exposed to normal conditions of temperature and moisture, including rainfall of normal pH for at least 1 year. In some embodiments, the precipitation material does not release more than 10% of its total CO₂ when exposed to normal conditions of temperature and moisture, including rainfall of normal pH for at least 1 year. In some embodiments, the precipitation material does not release more than 1% of its total CO₂ when exposed to normal conditions of temperature and moisture, including rainfall of normal pH for at least 10 years. In some embodiments, the precipitation material does not release more than 1% of its total CO₂ when exposed to normal conditions of temperature and moisture including rainfall of normal pH for at least 100 years. In some embodiments, the precipitation material does not release more than 1% of its total CO₂ when exposed to normal conditions of temperature and moisture, including rainfall of normal pH for at least 1000 years.

Any suitable surrogate marker or test that is reasonably able to predict such stability may be used. For example, an accelerated test comprising conditions of elevated temperature and/or moderate to more extreme pH conditions is reasonably able to indicate stability over extended periods of time. For example, depending on the intended use and environment of the precipitation material, a sample of the precipitation material may be exposed to 50, 75, 90, 100, 120, or 150° C. for 1, 2, 5, 25, 50, 100, 200, or 500 days at between 10% and 50% relative humidity, and a loss less than 1%, 2%, 3%, 4%, 5%, 10%, 20%, 30%, or 50% of its carbon may be considered sufficient evidence of stability of precipitation material of the invention for a given period (e.g., 1, 10, 100, 1000, or more than 1000 years).

Any of a number of suitable methods may be used to test the stability of the precipitation material including physical test methods and chemical test methods, wherein the methods are suitable for determining that the compounds in the precipitation material are similar to or the same as naturally occurring compounds known to have the above specified stability (e.g., limestone). CO₂ content of the precipitation material may be monitored by any suitable method, one such non-limiting example being coulometry. Other conditions may be adjusted as appropriate, including pH, pressure, UV radiation, and the like, again depending on the intended or likely environment. It will be appreciated that any suitable conditions may be used that one of skill in the art would reasonably conclude indicate the requisite stability over the indicated time period. In addition, if accepted chemical knowledge indicates that the precipitation material would have the requisite stability for the indicated period this may be used as well, in addition to or in place of actual measurements. For example, some carbonate compounds that may be part of a precipitation material of the invention (e.g., in a given polymorphic form) may be well-known geologically and known to have withstood normal weather for decades, centuries, or even millennia, without appreciable breakdown, and so have the requisite stability.

The carbonate-containing precipitation material, which serves to sequester CO₂ in a form that is stable over extended periods of time (e.g., geologic time scales), may be stored for extended durations, as described above. The precipitation material, if needed to achieve a certain ratio of carbonates to silica, may also be mixed with silicon-based material (e.g., from separated silicon-based material after material comprising metal silicates digestion; commercially available SiO₂; etc.) to form pozzolanic material. Pozzolanic materials of the invention are siliceous or aluminosiliceous materials which, when combined with an alkali such as calcium hydroxide (Ca(OH)₂), exhibit cementitious properties by forming calcium silicates and other cementitious materials. SiO₂-containing materials such as volcanic ash, fly ash, silica fume, high reactivity metakaolin, and ground granulated blast furnace slag, and the like may be used to fortify compositions of the invention producing pozzolanic materials. In some embodiments, pozzolanic materials of the invention are fortified with 0.5% to 1.0%, 1.0% to 2.0%; 2.0% to 4.0%, 4.0% to 6.0%, 6.0% to 8.0%, 8.0% to 10.0%, 10.0% to 15.0%, 15.0% to 20.0%, 20.0% to 30.0%, 30.0% to 40.0%, 40.0% to 50.0%, or an overlapping range thereof, an SiO₂-containing material. Such SiO₂-containing material may be obtained from, for example, an electrostatic precipitator or fabric filter of the invention.

As indicated above, in some embodiments, precipitation material comprises metastable carbonate compounds that are more stable in salt water than in fresh water, such that upon contact with fresh water of any pH they dissolve and re-precipitate into other fresh water stable minerals. In certain embodiments, the carbonate compounds are present as small particles, for example, with particle sizes ranging from 0.1 μm to 100 μm, 1 to 100 μm, 10 to 100 μm, 50 to 100 μm as determined by scanning electron microscopy (SEM). In some embodiments, particle sizes of the carbonate compounds range from 0.5 to 10 μm as determined by SEM. In some embodiments, the particles size exhibit a single modal distribution. In some embodiments, the particle sizes exhibit a bimodal or multi-modal distribution. In certain embodiments, the particles have a high surface are ranging from, for example, 0.5 to 100 m²/gm, 0.5 to 50 m²/gm, or 0.5 to 2.0 m²/gm as determined by Brauner, Emmit, & Teller (BET) Surface Area Analysis. In some embodiments, precipitation material may comprise rod-shaped crystals and/or amorphous solids. The rod-shaped crystals may vary in structure, and in certain embodiments have a length to diameter ratio ranging from 500 to 1, 250 to 1, or 10 to 1. In certain embodiments, the length of the crystals ranges from 0.5 μm to 500 μm, 1 μm to 250 μm, or 5 μm to 100 μm. In yet other embodiments, substantially completely amorphous solids are produced.

Spray-dried material (e.g., precipitation material, silicon-based material, pozzolanic material, etc.), by virtue of being spray dried, may have a consistent particle size (i.e., the spray-dried material may have a relatively narrow particle size distribution). As such, in some embodiments, at least 50%, 60%, 70%, 80%, 90%, 95%, 97%, or 99% of the spray-dried material falls within ±10 microns, ±20 microns, ±30 microns, ±40 microns, ±50 microns, ±75 microns, ±100 microns, or ±250 microns of a given mean particle diameter. In some embodiments, the given mean particle diameter is between 5 and 500 microns. In some embodiments, the given mean particle is between 5 and 250 microns. In some embodiments, the given mean particle diameter is between 5 and 100 microns. In some embodiments, the given mean particle diameter is between 5 and 50 microns. In some embodiments, the given mean particle diameter is between 5 and 25 microns. For example, in some embodiments, at least 70% of the spray-dried material falls within ±50 microns of a given mean particle diameter, wherein the given mean particle diameter is between 50 and 500 microns, such as between 50 and 250 microns, or between 100 and 200 microns. Such spray-dried material may be used to manufacture cement, fine aggregate, mortar, coarse aggregate, concrete, and/or pozzolans of the invention; however, one of skill in the art will recognize that manufacture of cement, fine aggregate, mortar, coarse aggregate, concrete, and/or pozzolans does not require spray-dried precipitation material. Air-dried precipitation material, for example, may also be used to manufacture cement, fine aggregate, mortar, coarse aggregate, concrete, and/or pozzolans of the invention.

Generally, pozzolanic material has lower cementitious properties than ordinary Portland cement, but in the presence of a lime-rich media like calcium hydroxide, it shows better cementitious properties towards later day strength (>28 days). The pozzolanic reaction may be slower than the rest of the reactions which occur during cement hydration, and thus the short-term strength of concretes that include pozzolanic material of the invention may not be as high as concrete made with purely cementitious materials. The mechanism for this display of strength is the reaction of silicates with lime to form secondary cementitious phases (calcium silicate hydrates with a lower C/S ratio), which display gradual strengthening properties usually after 7 days. The extent of the strength development ultimately depends upon the chemical composition of the pozzolanic material. Increasing the composition of silicon-based material (optionally with added silica and/or alumina), especially amorphous silicon-based material, generally produces better pozzolanic reactions and strengths. Highly reactive pozzolans, such as silica fume and high reactivity metakaolin may produce “high early strength” concrete that increases the rate at which concrete comprising precipitation material of the invention gains strength.

Precipitation material comprising silicates and aluminosilicates may be readily employed in the cement and concrete industry as pozzolanic material by virtue of the presence of the finely divided siliceous and/or alumino-siliceous material (e.g., silicon-based material). The siliceous and/or altuninosiliceous precipitation material may be blended with Portland cement, or added as a direct mineral admixture in a concrete mixture. In some embodiments, pozzolanic material comprises calcium and magnesium in a ratio (as above) that perfects setting time, stiffening, and long-term stability of resultant hydration products (e.g., concrete). Crystallinity of carbonates, concentration of chlorides, sulfates, alkalis, etc. in the precipitation material may be controlled to better interact with Portland cement. In some embodiments, precipitation material comprises silica in which 10-20%, 20-30%, 30-40%, 40-50%, 50-60%, 60-70%, 70-80%, 80-90%, 90-95%, 95-98%, 98-99%, 99-99.9% of the silica has a particle size less than 45 microns (e.g., in the longest dimension). In some embodiments, siliceous precipitation material comprises aluminosilica in which 10-20%, 20-30%, 30-40%, 40-50%, 50-60%, 60-70%, 70-80%, 80-90%, 90-95%, 95-98%, 98-99%, 99-99.9% of the aluminosilica has a particle size less than 45 microns. In some embodiments, siliceous precipitation material comprises a mixture of silica and aluminosilica in which 10-20%, 20-30%, 30-40%, 40-50%, 50-60%, 60-70%, 70-80%, 80-90%, 90-95%, 95-98%, 98-99%, 99-99.9% of the mixture has a particle size less than 45 microns (e.g., in the biggest dimension).

Pozzolanic material produced by the methods disclosed herein may be employed as a construction material, which material may be processed for use as a construction material or processed for use in an existing construction material for buildings (e.g., commercial, residential, etc.) and/or infrastructure (e.g., pavements, roads, bridges, overpasses, walls, levees, dams, etc.). The construction material may be incorporated into any structure, the structures further including foundations, parking structures, houses, office buildings, commercial offices, governmental buildings, and support structures (e.g., footings for gates, fences and poles) is considered a part of the built environment. The construction material may be a constituent of a structural or nonstructural component of such structure. An additional benefit of using pozzolanic material as a construction material or in a construction material is that CO₂ employed in the process (e.g., CO₂ obtained from a waste gas stream) is effectively sequestered in the built environment.

In some embodiments, pozzolanic material of the invention is employed as a component of a hydraulic cement (e.g., ordinary Portland cement), which sets and hardens after combining with water. Setting and hardening of the product produced by combining the precipitation material with cement and water results from the production of hydrates that are formed from the cement upon reaction with water, wherein the hydrates are essentially insoluble in water. Such hydraulic cements, methods for their manufacture and use are described in co-pending U.S. patent application Ser. No. 12/126,776, filed on 23 May 2008, the disclosure of which application is incorporated herein by reference. In some embodiments, pozzolanic material blended with cement is between 0.5% and 1.0%, 1.0% and 2.0%, 2.0% and 4.0%, 4.0% and 6.0%, 6.0% and 8.0%, 8.0% and 10.0%, 10.0% and 15.0%, 15.0% and 20.0%, 20.0% and 30.0%, 30.0% and 40.0%, 40.0% and 50.0%, 50% and 60%, or a range thereof, pozzolanic material by weight. For example, in some embodiments, pozzolanic material blended with cement is between 0.5% and 2.0%, 1.0% and 4.0%, 2.0% and 8.0%, 4.0% and 15.0%, 8.0% and 30.0%, or 15.0% and 60.0% pozzolanic material by weight.

In some embodiments, pozzolanic material is blended with other cementitious materials or mixed into cements as an admixture or aggregate. Mortars of the invention find use in binding construction blocks (e.g., bricks) together and filling gaps between construction blocks. Mortars of the invention may also be used to fix existing structure (e.g., to replace sections where the original mortar has become compromised or eroded), among other uses.

In some embodiments, the pozzolanic material may be utilized to produce aggregates. In some embodiments, aggregate is produced from the precipitation material by pressing and subsequent crushing. In some embodiments, aggregate is produced from the precipitation material by extrusion and breaking resultant extruded material. Such aggregates, methods for their manufacture and use are described in co-pending U.S. patent application Ser. No. 12/475,378, filed on 29 May 2009, the disclosure of which is incorporated herein by reference in it entirety.

### EXAMPLES

In combination with the above description, the following examples provide those of ordinary skill in the art with a complete disclosure and description of how to make and use the invention. The examples are presented to provide what is believed to be the most useful and readily understood procedural and conceptual description of certain embodiments of the invention. As such, the examples are not intended to limit the scope of what the inventors regard as their invention, nor do the examples represent all of the experiments or the only experiments performed. Efforts have been made to ensure accuracy with respect to numbers used (e.g., amounts, temperature, etc.), but some experimental errors and deviations should be accounted for. Unless indicated otherwise, parts are parts by weight, molecular weight is weight average molecular weight, temperature is in degrees Centigrade, and pressure is at or near atmospheric.

### Example IA

### Precipitation

In this example, absorption of carbon dioxide on the industrial-scale is described. A 1000-gallon reaction vessel was filled with 900 gallons (3400 L) of seawater, which was stirred throughout the entire process. The first step was to load the solution with 3.3 kg Mg(OH)₂, which increases both the pH and the magnesium content. Next, 10% by volume CO₂ was sparged and the pH of 7.9 was maintained by a continuous addition of NaOH up to 30 kg. The total duration of these steps was 5-6 hours. A final charge of 38 kg NaOH was added to increase the pH so that carbonates would form and precipitate. The duration of this step was 10-20 minutes. The solution was stirred for 1 hour more to allow further precipitation. The reaction mixture was allowed to settle overnight. The solution was decanted and the solid product was recovered by either filter press or vacuum filtration. Additionally, the solution could be rinsed after the decant process; whereby water was added and the sample was filter pressed. Alternatively, water was added after initial vacuum filtration, stirred, and filtered again. Finally, the product was spray dried. The overall yield was 5-7 g/L of the original solution.

### Example IB

### Liquid-Solid Separation

A. Process 1

In this prophetic example, separation of precipitation product from precipitation reaction mixture is described. Precipitation reaction mixture is prepared as described above for Example IA.

Slurry comprising the precipitation product is produced in a reaction vessel (see Example IA), which, for the purpose of this example, is referred to as a precipitation station. Following formation of precipitation product slurry (e.g., precipitation reaction mixture), the slurry is provided to a liquid-solid separation apparatus as precipitation station effluent. A precipitation station effluent pipe is used to provide the slurry to the liquid-solid separation apparatus and to direct slurry flow against a baffle, by which precipitation station effluent flow is deflected. Heavier precipitation product particles continue their path of motion down (i.e., in the direction of gravity) the precipitation station effluent pipe to a collector while supernatant deflects, separates from precipitation product particles, and exits through the upper portion of the liquid-solid separation apparatus. The resulting precipitation product is removed from the collector and dried to yield of calcium carbonate and magnesium carbonate hydrates.

B. Process 2

In this prophetic example, separation of precipitation product from precipitation station mixture is described. Precipitation product slurry is prepared as described above for Example IA.

Slurry comprising the precipitation product is produced in a reaction vessel (see Example IA), which, for the purpose of this example, is referred to as a precipitation station. Following formation of precipitation product slurry (e.g., precipitation reaction mixture), the slurry is provided as precipitation station effluent to a liquid-solid separation apparatus, wherein the slurry is made to flow in a spiral channel. At the end of the spiral channel, a parallel array of outlets collects separated particles of precipitation product. The resulting precipitation product is removed from the collector and dried to yield calcium carbonate and magnesium carbonate hydrates.

### Example IIX

### Weathering Testing

Experimental Methods

Paste samples of precipitation material were mixed according to ASTM standard C 305-06, standard practice for mixing of hydraulic pastes and mortars. The first mix was of entirely OPC with a water to cement ratio of 0.55 by weight. The second mix was 80% OPC and 20% precipitation material which, due to the consistency after mixing with a W/C ratio of 0.55, required a greater water to cement ratio of 0.70, see Table 2. After mixing, the pastes were poured onto metal slides to create slabs and then allowed to cure for 3 days in a curing chamber with a relative humidity of 98%. There were 5 slides total, each with a sample of 100% OPC mix and the 80/20 OPC-precipitation material mix. The slides were then put into the QUV/se weathering chamber with the material facing inward to be exposed to the UV radiation and to provide the condensation surface (see apparatus of FIG. W1). The standard used for this experiment was ASTM Standard G154-06, Standard Practice for Operating Fluorescent Light Apparatus for UV Exposure of Nonmetallic Materials. The specific cycling of this standard is open ended, leaving the hours of exposure to be tailored to the total length of the experimental run and to the material being tested.

TABLE 2
Paste Mix Proportions

| W/C | OPC | Precipitation | Water |
|---|---|---|---|
| (%) | Mass (g) | Material Mass (g) | Mass (g) |
| 55 | 170 | — | 93.5 |
| 70 | 136 | 34 | 119 |

The device was cycled for 2000 total hours of exposure in intervals of 8 hours of UV followed by 4 hours of heat and vapor/condensation exposure, see Table 3. After every 100 hours of exposure the samples were rotated through the different positions in the machine to ensure an even irradiance was applied to each sample. The irradiance of the device was set to 0.78 W/m² from each of the bulbs, but often fluctuated down to 0.55 W/m² and required constant recalibration. Temperature was controlled through a heating element in the water tank which cycled between 20° C. and 40° C. to create the vapor and condensation during the heating and cooling phase. Samples were removed from the device at 500 hour intervals through a total exposure of 2000 hours (i.e., 500, 1000, 1500, and 2000 hours) and compared to a baseline at 0 hours of exposure. The chamber was not sealed to the environment, letting in atmospheric air at standard pressure. Once the time intervals were reached, the material was tested through the analytical techniques (coulometry, thermogravimetric analysis, and X-ray diffraction) according to the testing schedule in FIG. W3.

TABLE 3
Test Conditions

| | Time | Exposure |
|---|---|---|
| Step 1 | 8 hours | 20° C., 340 nm UV radiation |
| Step 2 | 4 hours | 40° C., evaporation/condensation |

### Titration Coulometry

Coulometry is a quantitative examination of the carbon content in the paste mixes. From the weathered slabs, material was removed from the surface and ground into a powder using a mortar and pestle. The powder was placed into a CM5230 Acidification Module (UIC, Inc.), where it was reacted in a series with perchloric and phosphoric acid. The resulting gas was isolated in N₂ where it was analyzed and outputted as % carbon by volume.

XRD

X-ray diffraction (XRD) was done using a Rigaku Miniflex Diffractometer and analyzed using the software and databases associated with Jade 9 software, in addition to the database complied by Calera Corporation. Material samples were prepared in the same way as in coulometry, using a mortar and pestle to create a powder from the surface of the weathered paste slabs. Aluminum sample dishes were then carefully prepared by filling with the powder and then leveled using a clean glass slide. Additional care was taken to create a random orientation of the powder grains by “chopping” the mounded powder before compacting to a level surface. This reduced the possibility of false intensity readings due to alignment of the powder grains.

TGA

Weight loss due to the off gassing of material during heating was measured using thermogravimetric analysis. The device used in this analysis was a SDT Q600 TGA and the sample was measured as it was heated from room temperature to 1000° C. at a linear ramp rate of 20° C./minute. Samples weighing between 10-20 mg were weighed and placed into the device. All of the above analytical techniques (TGA, XRD, coulometry) were done using devices available at Calera Corporation in Los Gatos, California.

### Results and Discussion

Carbon Coulometry

Using titration coulometry, a carbonation profile was created by mapping carbon content, and therefore carbon dioxide content, over the weathering exposure incurred during this study, see FIG. W4. Carbonation is a well documented process in cement and concrete as CO₂ from the air is absorbed and reacts to form stable magnesium and calcium carbonate compounds over a gradient from the exposed surface, as seen in Eq. Weathering 1.

Ca(OH)₂+Mg(OH)₂+CO₂ [symbol] CaCO₃+MgCO₃ [Eq. Weathering 1]

Both the carbonation profile for the 100% OPC mixture and the 80% OPC/20% precipitation material increase throughout the study, following a very similar trend line that starts to level off by the time 2000 hours of exposure is reached. This is not to say that the capacity of the material to absorb and react with atmospheric CO₂ has been reached, as the depth of the powder samples taken from the slabs remained constant at approximately 1-2 mm. It is also shown in FIG. W4 that the amount of carbon does not start to decrease after leveling off, indicating that this secondary sequestration is stable within the range of this experiments exposure. A lower rate (shallower slope) of carbon accumulation in the 80/20 mixture in comparison to the 100% OPC mixture could be explained as an increase in carbon from the environment while a simultaneous decrease occurred from the carbon sequestered through the manufacturing process. This trend was not observed and could be concluded that the initial sequestration is permanent given the aging criteria set forth in the project scope.

Thermogravimetric Analysis and X-ray Diffraction

During the curing process of cement between the twenty days of weathering exposure after mixing, a formation was observed in both analysis through thermogravimetric analysis and X-ray diffraction. Portlandite, a phase of calcium hydroxide, Ca(OH)₂, initially formed but changed into a different phase/contributed to phases already present in the material. The TGA peak shown in FIG. W5 at 450° C. is indicative of the water driven off from this phase, which is shown to increase for the paste mixture with precipitation material between 0 hours and 500 hours of exposure. The presence then decreased between 500 hours and 1000 hours and then disappeared completely after 1000 hours. This formation also occurred in the 100% OPC paste mixture but changed more quickly, disappearing after only 500 hours.

The trend of peaks disappearing was further evidenced through analysis using X-ray diffraction. The peak appearance and disappearance highlighted in red in FIG. W6 and FIG. W7 were identified as portlandite, a hydrated phase of calcium. Portlandite was created from the hydration process when water reacted with the abundant amount of CaO (a main ingredient in Portland cement), shown in [Eq. Weathering 2].

H₂O+CaO [symbol] Ca(OH)₂ [Eq. 2]

After the initial hydration and curing (which formed the portlandite) the phase then reacted to form the carbonate and disappeared from both the TGA and XRD scans. The time of exposure when the peaks disappeared was the same for both XRD and TGA; before 500 hours for the 100% OPC mixture and approximately close to 1000 hours for the mixture containing precipitation material.

While the invention has been described in terms of various embodiments, and while these embodiments have been described in considerable detail, it is not the intention of the inventors to restrict or in any way limit the scope of the invention to such detail. It should be apparent to those of ordinary skill in the art that various adaptations and modifications of the invention may be accomplished without departing from the spirit and the scope of the invention. The foregoing are merely examples of variations that may be employed, and additional advantages and modifications will readily appear to those of ordinary skill in the art. Thus, the invention in its broader aspects is therefore not limited to the specific details, representative embodiments, and illustrative examples shown and described. Accordingly, departures may be made from such details without departing from the spirit or scope of the general inventive concept. Accordingly, it is to be understood that the detailed description and the accompanying drawings as set forth herein are not intended to limit the breadth of the invention, which should be inferred only from the following claims and their appropriately construed legal equivalents.

All publications and patents cited in this specification are herein incorporated by reference as if each individual publication or patent were specifically and individually indicated to be incorporated by reference. The citation of any publication is for its disclosure prior to the filing date and should not be construed as an admission that the invention is not entitled to antedate such publication by virtue of prior invention. Further, the dates of publication provided herein may be different from the actual publication dates and need to be independently confirmed.

Any element in a claim that does not explicitly state a “means” or a “step” for performing a specified function, should not be interpreted as a “means” or a “step” clause as specified in 35 U.S.C. §112, unless to sustain the validity of the claim.

While preferred embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method comprising:
i) obtaining a slurry comprising a precipitated CO₂-sequestering carbonate and/or bicarbonate compound composition and a supernatant solution from which the carbonate compound composition was precipitated, wherein the carbonate and/or bicarbonate compound composition has a δ¹³C value less than −10‰ and comprises aragonite, vaterite, amorphous calcium carbonate, or a combination thereof;
ii) separating the CO₂-sequestering carbonate compound composition from the supernatant solution utilizing at least one of the following techniques:
a. gravity separation;
b. mechanical separation; or
c. thermal evaporation;
to provide a dewatered slurry comprising the CO₂-sequestering carbonate compound composition at a concentration of solids of at least 20 wt % and a first portion of the supernatant solution, and an effluent solution comprising a second portion of the supernatant solution; and
iii) processing the effluent solution in a first process and the CO₂-sequestering carbonate compound composition in a second process.

2. The method of claim 1, wherein processing the CO₂-sequestering carbonate compound composition comprises particle size refining.

3. The method of claim 1, wherein processing the CO₂-sequestering carbonate compound composition comprises making at least one of: a hydraulic cement, aggregate, supplementary cementitious material, or concrete comprising the CO₂-sequestering carbonate compound composition.

4. The method of claim 3, wherein the hydraulic cement, aggregate, supplementary cementitious material, or concrete comprises the CO₂-sequestering carbonate compound composition in an amount of at least 25 wt %.

5. The method of claim 1, wherein processing the effluent solution comprises adjusting the pH and/or chemical composition of the effluent solution so that it is suitable for release into an ocean, sea, river, other body of surface water, or a subterranean repository.

6. The method of claim 1, wherein processing the effluent solution comprises subjecting the effluent solution to a process comprising at least one type of the following protocols:
a reverse osmosis protocol;
a forward osmosis protocol;
a nano-filtration protocol;
a micro-filtration protocol;
a pH adjusting protocol;
a salt recovery protocol;
a cation recovery protocol; or
a membrane distillation protocol.

7. An apparatus for dewatering a mixture comprising a carbonate and/or bicarbonate compound composition, the apparatus comprising:
a) an inlet for a mixture comprising a carbonate and/or bicarbonate compound composition that conveys the solution into a gravity separation compartment, said compartment comprising at least one of:
i) a decanting baffle;
ii) a Lamella clarifier/thickener;
iii) a filter;
iv) a clarifier;
v) a sludge bed clarifier;
vi) a centrifuge;
vii) a hydrocyclone;
iix) a flocculant introduction system;
ix) a filtering aid introduction system;
x) a coagulant introduction system; or
xi) a crystallization accelerant introduction system; and
b) a mechanical separation section, said section operably connected to said gravity separation compartment by a conduit, conveyor belt, or other convenient means, said mechanical separation section comprising at least one of:
i) a filter press;
ii) a belt press;
iii) a vacuum drum;
iv) a separating conveyor belt;
v) a vertical press;
vi) a spray drying apparatus; or
vii) a spraying system
wherein the apparatus is constructed of corrosion and abrasion resistant materials such that the apparatus may be used continuously for at least 2 months at a pH of 8 or higher with carbonate and/or bicarbonate compound compositions.

8. The apparatus according to claim 7, further comprising a rinsing system comprising a slurrying tank that combines an aqueous solution lacking chlorides with the mixture comprising a carbonate and/or bicarbonate compound composition, a freshwater spray system, or a combination thereof.

9. The apparatus according to claim 7, wherein the centrifuge is a continuous type centrifuge.

10. The apparatus according to claim 9, wherein the centrifuge is a nozzle disk type centrifuge.

11. The apparatus according to claim 9, wherein the centrifuge is a scroll type centrifuge.

12. The apparatus according to claim 7, wherein the coagulant introduction system comprises inorganic chemicals.

13. The apparatus according to claim 7, wherein the spraying system comprises nozzles.

14. The apparatus according to claim 7, wherein the spraying system is configured to operate at ambient temperature and relative humidity of the surrounding atmosphere.

15. The apparatus of claim 14, wherein the spraying system is configured to remove unwanted minerals from the carbonate and/or bicarbonate compound composition without the need of rinsing the carbonate and/or bicarbonate compound composition.

16. The apparatus of claim 15, wherein the unwanted minerals comprise sodium chloride, potassium chloride, calcium chloride, ammonia chloride, or any combination thereof.

17. The apparatus according to claim 7, wherein the spray drying apparatus comprises an inlet for gas at a temperature above ambient temperature.

18. The apparatus according to claim 17, wherein the spray drying apparatus comprises an inlet for industrial waste gas at a temperature above ambient temperature.

19. The apparatus according to claim 7, wherein the mechanical separation system comprises additional energy input comprising vibration, sound waves, radio waves, or a combination thereof.

20. The apparatus according to claim 7, wherein the hydrocyclone is a filter hydrocyclone.

21. The apparatus according to claim 7, wherein the gravity separation compartment comprises temperature controls, mixing controls, or both types of controls.

22. An apparatus for dewatering a mixture comprising a solid particulate composition and a supernatant solution, said apparatus comprising:
a first connection from a flue gas source that provides hot flue gas comprising CO₂ to a contacting conduit comprising a screw conveyor within the contacting conduit that is configured to move the mixture within the apparatus, wherein the connection is configured to contact the flue gas with the mixture to produce a dewatered mixture and a cooled flue gas comprising CO₂; and
a second connection from the contacting conduit that provides the cooled flue gas comprising CO₂ to an apparatus for further processing of the flue gas.

23. The apparatus of claim 22, wherein the apparatus for further processing of the flue gas comprises a CO₂-sequestering apparatus that reduces the amount of CO₂ in the flue gas.

24. The apparatus of claim 22, wherein the apparatus for further processing of the flue gas provides the mixture comprising a solid particulate composition and a supernatant solution.

25. The apparatus of claim 22, further comprising a solids removal conduit that transports the dewatered mixture comprising the solid particulate composition to a refining station.

26. The apparatus according to claim 25, wherein the refining station comprises a particulate grinding system, a particulate compaction system, a washing station, or any combination thereof.

27. The apparatus according to claim 22, wherein the flue gas source is the flue gas stack of a power plant.

28. The apparatus according to claim 27, wherein the power plant is a coal fired power plant.

29. The apparatus according to claim 22, wherein the flue gas enters the first connection at a temperature greater than 100° F.

30. The apparatus according to claim 22 or claim 29, wherein the flue gas enters the second connection at a temperature at least 10° F. less than the temperature at which the flue gas entered the first connection.

31. The apparatus according to claim 30, wherein the flue gas enters the second connection at a temperature at least 20° F. less than the temperature at which the flue gas entered the first connection.

32. The apparatus according to claim 22, wherein the dewatered mixture is at least 35% solids.

33. The apparatus according to claim 32, wherein the dewatered mixture is at least 45% solids.

34. The apparatus according to claim 33, wherein the dewatered mixture is greater than 90% solids.

35. The apparatus according to claim 22, wherein the dewatered mixture is at least 5% more solids than the mixture before entering the apparatus.

36. The apparatus according to claim 22, wherein the dewatered mixture is at least 10% more solids than the mixture before entering the apparatus.

37. A system comprising:
a carbonate precipitation apparatus comprising an inlet for a source of at least one of carbonate, bicarbonate, carbon dioxide, or a mixture thereof, wherein the carbonate precipitation apparatus produces mixture comprising a carbonate and/or bicarbonate compound composition and a supernatant solution; and
at least one of:
i) a primary dewatering station;
ii) a secondary dewatering station; and
iii) a final dewatering station,
wherein the primary dewatering station separates the carbonate and/or bicarbonate compound composition from the supernatant solution to form a first slurry that comprises up to 30 wt % solids;
wherein the secondary dewatering station separates the carbonate and/or bicarbonate compound composition from the supernatant solution to from a second slurry that comprises greater than 30 wt % solids but less than 90 wt % solids;
wherein the final dewatering station further separates the carbonate and/or bicarbonate compound composition from the supernatant solution to obtain a dewatered composition comprising greater than 90 wt % solids wherein the solids comprise the carbonate and/or bicarbonate compound composition;
wherein the mixture of the carbonate and/or bicarbonate compound composition and the supernatant solution is provided from the carbonate precipitation apparatus to at least one of the primary, secondary, and final dewatering stations by a conduit, conveyor belt, or other convenient apparatus; and
wherein the dewatering stations in the systems comprise a conduit, conveyor belt, or other convenient apparatus to remove slurry or dewatered compositions from the stations.

38. The system according to claim 37, wherein the carbonate precipitation apparatus comprises an inlet for a gaseous source of carbon dioxide.

39. The system according to claim 37, wherein the gaseous source of carbon dioxide comprises an industrial waste gas.

40. The system according to claim 39, wherein the industrial waste gas comprises the flue gas from a fossil fuel burning power plant.

41. The system according to claim 40, wherein the industrial waste gas comprises the flue gas from a coal burning power plant.

42. The system according to claim 37, wherein the carbonate precipitation apparatus comprises an inlet for a solution comprising carbonate and/or bicarbonate ions.

43. The system according to claim 42, wherein the solution comprising carbonate and/or bicarbonate ions comprises an alkaline brine.

44. The system according to claim 37, wherein the precipitation apparatus further comprises a pH adjusting system that comprises an inlet for pH adjusting agents.

45. The system according to claim 44, wherein the pH adjusting system is operably connected to an electrochemical system for proton removal, an electrochemical system that produces a pH adjusting agent, or both.

46. The system according to claim 37, further comprising a refining station operably connected to the primary dewatering station, the second dewatering station, the final dewatering station, or any combination thereof.

47. The system according to claim 46, wherein the refining station comprises a carbonate and/or bicarbonate compound composition refining system, a supernatant solution treatment system, or both.

48. The system according to claim 47, wherein the carbonate and/or bicarbonate composition refining system comprises a building materials fabrication system.

49. The system according to claim 47, wherein the supernatant solution treatment system comprises at least one of: a pH adjustment system, a reverse osmosis apparatus, a nano-filtration apparatus, a forward osmosis apparatus, a micro-filtration apparatus, a membrane distillation apparatus, or a salt-recovery apparatus.

50. The system according to any of claims 37-49, wherein the primary dewatering station comprises at least one of:
i) a decanting baffle;
ii) a Lamella clarifier/thickener;
iii) a filter;
iv) a clarifier;
v) a sludge bed clarifier;
vi) a centrifuge;
vii) a hydrocyclone;
iix) a flocculation system;
ix) a filtering aid introduction system;
x) a coagulation system; or
xi) a crystallization acceleration system;
further wherein the secondary dewatering station comprises at least one of:
i) a filter press;
ii) a belt press;
iii) a vacuum drum;
iv) a separating conveyor belt;
v) a vertical press;
vi) a spray drying apparatus;
vii) a vacuum filter; or
iix) a gas-pressure filter;
further wherein the final dewatering station comprises at least one of:
i) one or more evaporation ponds;
ii) a spray drying apparatus;
iii) an oven;
iv) a furnace;
v) a solar concentrator;
vi) a heat exchanger in contact with industrial waste gas at a temperature above ambient atmospheric temperature;
vii) a heat exchanger in contact with a geological brine at a temperature above ambient atmospheric temperature; or
iix) a conveyance apparatus that allows direct exposure of the carbonate compound composition and supernatant solution mixture to industrial waste gas at a temperature above ambient atmospheric temperature.
